(19) United States
(12) Patent Application Publication
(10) Pub. No.: US 2025/0284237 A1
(43) Pub. Date: Sep. 11, 2025

(54) IMAGE FORMING APPARATUS AND PROCESS CARTRIDGE

(71) Applicant: CANON KABUSHIKI KAISHA, Tokyo (JP)

(72) Inventors: SHUJI SAITO, Shizuoka (JP); YUSUKE JINKOMA, Aichi (JP); SHUNTARO WATANABE, Kanagawa (JP)

(21) Appl. No.: 19/219,573

(22) Filed: May 27, 2025

Related U.S. Application Data
(63) Continuation of application No. PCT/JP2023/037382, filed on Oct. 16, 2023.

(30) Foreign Application Priority Data
Dec. 9, 2022 (JP) 2022-197127
Dec. 9, 2022 (JP) 2022-197144

(51) Int. Cl. G03G 15/00; G03G 15/16; G03G 21/18

(52) U.S. Cl. CPC G03G 15/751; G03G 15/1615; G03G 21/1814

(57) ABSTRACT

Provided is an image forming apparatus including a photosensitive drum and an intermediate transfer member, in which when an area of particles on a surface of the photosensitive drum is denoted by S1 and an area other than the particles is denoted by S2, S1/(S1+S2) is at least 0.70 and not more than 1.00, and in a particle size distribution of the particles, when a particle size of a peak top having a larger particle size value between a first peak having the maximum frequency and a second peak having the second highest frequency among peaks having a particle size of 20 nm or more at a peak top is denoted by DA and an arithmetic mean curvature of peak points in a surface roughness shape of the intermediate transfer member is denoted by Spc, 80 nm≤DA≤2×(1/Spc) is satisfied.

### CROSS-REFERENCE TO RELATED APPLICATIONS

This application is a Continuation of International Patent Application No. PCT/JP2023/037382, filed Oct. 16, 2023, which claims the benefit of Japanese Patent Application No. 2022-197127, filed Dec. 9, 2022, and, Japanese Patent Application No. 2022-197144, filed Dec. 9, 2022, which are hereby incorporated by reference herein in their entirety.

### BACKGROUND OF THE INVENTION

### Field of the Invention

The present invention relates to an image forming apparatus and a process cartridge.

### Description of the Related Art

As an electrophotographic image forming apparatus such as a copying machine or a printer that forms a color image on a transfer material, a method using an intermediate transfer system is known. The intermediate transfer system forms an image by primarily transferring toners of a plurality of colors from an electrophotographic photosensitive member to an intermediate transfer member and secondarily transferring a toner image from the intermediate transfer member to a transfer material. In addition, in order to efficiently transfer toner, a speed difference (peripheral speed difference) between the electrophotographic photosensitive member and the intermediate transfer member may be provided particularly in a primary transfer part.

In the intermediate transfer system as described above, when the frictional force between the electrophotographic photosensitive member and the intermediate transfer member is high and the lubricity is poor, the peripheral speed of the electrophotographic photosensitive member or the intermediate transfer member becomes unstable, and image blurring may occur in the primary transfer part. As one of means for reducing the frictional force, a method of forming a protruding shape by including particles on the surface of an electrophotographic photosensitive member has been proposed.

PTL 1 (Japanese Patent Application Publication No. 2019-045862) describes a technique for reducing frictional force using an electrophotographic photosensitive member having a surface layer obtained by curing a coating film containing organic resin particles, which are at least one of acrylic resin particles and melamine resin particles, and a hole transporting compound having a polymerizable functional group.

PTL 2 (Japanese Patent Application Publication No. 2020-071423) describes a technique of including an inorganic filler in an outermost layer of an electrophotographic photosensitive member to form a protruding shape.

In an image forming apparatus using an electrophotographic system, a photosensitive drum containing an organic photoconductive substance serving as a charge generating material is widely used as a photosensitive drum serving as a toner image carrier. In recent years, for the purpose of prolonging the lifespan of a photosensitive drum and improving the image quality during repeated use, it has been required to improve the mechanical durability of the photosensitive drum, that is, the wear resistance, and maintain the surface properties.

As a method of transferring a toner image on a photosensitive drum to a recording material, there is an image forming apparatus using an intermediate transfer system. In the image forming apparatus using the intermediate transfer system, a toner image formed on a photosensitive drum is primarily transferred to an intermediate transfer member, and then the toner image on the intermediate transfer member is secondarily transferred onto a recording material. As the intermediate transfer member, an intermediate transfer belt formed of an endless belt is widely used. In the primary transfer process, it is common to transfer the toner image on the photosensitive drum onto the intermediate transfer belt by electrostatic force by forming a potential difference between the surface of the drum and the intermediate transfer belt using a high-voltage power supply. Recently, in an image forming apparatus, downsizing of an apparatus and a process cartridge and an increase in the number of printable sheets have been required, and there has been an increasing need for a technique for transferring toner with high efficiency and without waste. As a method of enhancing transfer efficiency, a configuration in which a protruding shape is imparted to the surface of the photosensitive drum to reduce the contact area with the toner, thereby reducing adhesion is conceived.

Means for imparting a protruding shape to the surface of a photosensitive drum has been conventionally proposed, and PTL 3 (Japanese Patent No. 6361958) proposes a configuration in which a protruding shape having a height of 20 nm or more is formed on the surface of the photosensitive drum made of a curable resin by addition of a filler to prevent filming of an external additive on the surface of the photosensitive drum.

In recent years, there has been an increasing demand for prolonging the lifespan of image forming apparatus. However, in the conventional techniques, when the lifespan is prolonged, it may be difficult to maintain a protruding shape in the latter half of the lifespan due to abrasion or falling off of particles added to the surface of the electrophotographic photosensitive member. As a result, the effect of reducing the frictional force cannot be obtained in the latter half of the lifespan, and image blurring may occur.

An object of the present invention is to curb occurrence of image defects by curbing an increase in frictional force between an electrophotographic photosensitive member and an intermediate transfer member of an image forming apparatus.

When a protruding shape is formed by adding a filler, depending on the amount of filler particles added, the particle size, and the exposed state, the adhesion with the toner may not decrease, and the transfer efficiency may not be improved. In addition, the added filler is detached by friction with the intermediate transfer belt, and high transfer efficiency may not be maintained throughout the product lifespan.

The present invention has been made in view of the above problems, and an object of the present invention is to achieve both improvement of transfer efficiency and curbing of shape change in the surface of a photosensitive drum through long-term use.

Further features of the present invention will become apparent from the following description of exemplary embodiments with reference to the attached drawings.

### CITATION LIST

### Patent Literature

PTL 1: Japanese Patent Application Publication No. 2019-045862

PTL 2: Japanese Patent Application Publication No. 2020-071423

PTL 3: Japanese Patent No. 6361958

### SUMMARY OF THE INVENTION

The present invention adopts the following configuration. That is,
an image forming apparatus includes
   a photosensitive drum; and
an intermediate transfer member configured to have a surface onto which a toner on the photosensitive drum is transferred at a contact portion in contact with the photosensitive drum, and convey the toner to transfer the toner to a transfer material, wherein
the photosensitive drum has a surface layer containing a particle and a binder resin,
wherein S1/(S1+S2) is at least 0.70 and not more than 1.00 when an area occupied by the particle is denoted by S1 and an area occupied by other than the particle is denoted by S2 on a surface of the surface layer,
there are a plurality of peaks in a particle size distribution based on the number of particles contained in the surface layer,
among peaks having particle sizes of 20 nm or more at peak tops in the particle size distribution among the plurality of peaks, a peak having the maximum frequency of peak tops is defined as a first peak, and a peak having the second highest frequency of peak tops is defined as a second peak, and
when a particle size of a peak top having a larger particle size value of the peak top in comparison between the first peak and the second peak is denoted by DA, and
an arithmetic mean curvature of peak points in a surface roughness shape of a surface of the intermediate transfer member facing the photosensitive drum in the contact portion is denoted by Spc,

80 nm≤DA≤2×(1/Spc)
is satisfied.

The present invention also employs the following configuration. That is,
an image forming apparatus includes
an photosensitive drum; and
an intermediate transfer member configured to have a surface onto which a toner on the photosensitive drum is transferred at a contact portion in contact with the photosensitive drum, and convey the toner to transfer the toner to a transfer material, wherein
the photosensitive drum has a surface layer containing a particle and a binder resin,
there are a plurality of peaks in a particle size distribution based on the number of particles contained in the surface layer,
wherein, among peaks having peak sizes of 20 nm or more at peak tops in the particle size distribution among the plurality of peaks, a peak having the maximum peak top frequency is defined as a first peak and a peak having the second highest peak top frequency is defined as a second peak,
when a particle size of a peak top having a larger particle size value of the peak top in comparison between the first peak and the second peak is denoted by DA,
the surface layer has an average value of distances between centers of gravity of protrusions derived from particles having the particle size in the range of DA±20 nm is at least 150 nm and not more than 500 nm when viewed from above,
the standard deviation of the distance between centers of gravity of the protrusions is 250 nm or less,
an arithmetic mean curvature of peak points in a surface roughness shape of a surface of the intermediate transfer member facing the photosensitive drum in the contact portion is denoted by Spc,

80 nm≤DA≤2×(1/Spc)
is satisfied.

The present invention also employs the following configuration. That is,
a process cartridge attachable to an image forming apparatus having an intermediate transfer member includes:
a photosensitive drum having a surface layer containing a particle and a binder resin,
wherein S1/(S1+S2) is at least 0.70 and not more than 1.00 when an area occupied by the particle is denoted by S1 and an area occupied by other than the particle is denoted by S2 on a surface of the surface layer,
there are a plurality of peaks in a particle size distribution based on the number of particles contained in the surface layer,
a peak having the maximum frequency of peak tops among peaks having a particle size of 20 nm or more at peak tops in the particle size distribution among the plurality of peaks is defined as a first peak, and a peak having a second frequency of peak tops is defined as a second peak, and
when a particle size of a peak top having a larger particle size value of the peak top in comparison between the first peak and the second peak is denoted by DA,

80 nm≤DA
is satisfied,
the intermediate transfer member of the image forming apparatus is an intermediate transfer member configured to have a surface onto which a toner on the photosensitive drum is transferred at a contact portion in contact with the photosensitive drum, and convey the toner to transfer the toner to a transfer material,
when an arithmetic mean curvature of peak points in a surface roughness shape of a surface of the intermediate transfer member facing the photosensitive drum in the contact portion is denoted by Spc,

DA≤2×(1/Spc)
is satisfied.

The present invention also employs the following configuration. That is,
a process cartridge attachable to an image forming apparatus having an intermediate transfer member includes:
a photosensitive drum having a surface layer containing a particle and a binder resin,
there are a plurality of peaks in a particle size distribution based on the number of particles contained in the surface layer,
among peaks having a particle size of 20 nm or more at peak tops in the particle size distribution among the plurality of peaks, a peak having the maximum frequency of peak tops is defined as a first peak, and a peak having the second highest frequency of peak tops is defined as a second peak, and
when a particle size of a peak top having a larger particle size value of the peak top in comparison between the first peak and the second peak is denoted by DA,

80 nm≤DA
is satisfied,
an average value of distances between centers of gravity of protruded portions derived from particles having the particle size in the range of DA±20 nm is at least 150 nm and not more than 500 nm when the surface layer is viewed from above,
a standard deviation of the distances between the centers of gravity of the protruded portion is 250 nm or less,
the intermediate transfer member of the image forming apparatus is an intermediate transfer member configured to have a surface onto which a toner on the photosensitive drum is transferred at a contact portion in contact with the photosensitive drum, and convey the toner to transfer the toner to a transfer material,
when an arithmetic mean curvature of peak points in a surface roughness shape of a surface of the intermediate transfer member facing the photosensitive drum in the contact portion is denoted by Spc,

DA≤2×(1/Spc)
is satisfied.

The present invention employs the following configuration. That is,
an image forming apparatus includes: an endless transfer belt that is stretched by a plurality of stretching rollers; and a transfer member that is disposed on an inner circumferential side of the transfer belt, wherein a process cartridge is attachable to the image forming apparatus,
wherein a width of the transfer member in an axial direction of the plurality of stretching rollers is less than a width of at least one of the plurality of stretching rollers,
the process cartridge has a photosensitive drum having a surface layer carrying a toner image,
the photosensitive drum contains a particle partially exposed from the surface layer of the photosensitive drum,
a volume-average particle size of the particle is more than 37 nm and less than 550 nm,
80 number % or more of particles contained in a cross section of the surface layer are partially exposed from the surface layer, and a total volume of the exposed portion is at least 30 vol % and not more than 80 vol % with respect to a total volume of the contained particles, and
a width of the surface layer of the photosensitive drum is formed in a region wider than the width of the transfer member in the axial direction.

The present invention also employs the following configuration. That is,

A process cartridge is attachable to an image forming apparatus having an endless transfer belt stretched by a plurality of stretching rollers and a transfer member disposed on an inner circumferential side of the transfer belt, wherein, in the image forming apparatus, a width of the transfer member in an axial direction of the plurality of stretching rollers is less than a width of at least one of the plurality of stretching rollers,
wherein the process cartridge has a photosensitive drum having a surface layer carrying a toner image,
wherein the photosensitive drum has a particle partially exposed from the surface layer,
wherein a volume-average particle size of the particle is more than 37 nm and less than 550 nm,
80 number % or more of particles contained in a cross section of the surface layer are partially exposed from the surface layer, and a total volume of the exposed portion is at least 30 vol % and not more than 80 vol % with respect to a total volume of the contained particles, and
a width of the surface layer of the photosensitive drum is formed in a region wider than the width of the transfer member in the axial direction.

### BRIEF DESCRIPTION OF THE DRAWINGS

FIG. 1 is a schematic cross-sectional view of an image forming apparatus.

FIG. 2 is an example of a layer configuration of an electrophotographic photosensitive member.

FIG. 3 is another example of a layer configuration of the electrophotographic photosensitive member.

FIG. 4 is a cross-sectional view of an intermediate transfer member.

FIGS. 5A and 5B are schematic diagrams in a case where the intermediate transfer member is subjected to surface treatment.

FIGS. 6A and 6B are schematic cross-sectional views showing a relationship between an electrophotographic photosensitive member and an intermediate transfer member.

FIG. 7 is a schematic diagram of the surface of the electrophotographic photosensitive member as observed from above.

FIGS. 8A and 8B are diagrams illustrating particle size distributions of particles in a surface layer.

FIG. 9 is a schematic cross-sectional view showing a schematic configuration of an image forming apparatus.

FIGS. 10A, 10B, and 10C are conceptual diagrams of layer configurations in cross sections of photosensitive drums.

FIG. 11 is a conceptual diagram illustrating an exposed volume of particles in a surface layer of a photosensitive drum.

FIGS. 12A, 12B, and 12C are diagrams showing a deformed state at an end of a stretching roller of a first image forming apparatus.

FIGS. 13A, 13B, and 13C are diagrams showing a deformed state at an end of a stretching roller of a second image forming apparatus.

FIGS. 14A, 14B, and 14C are diagrams showing a deformed state at an end of a stretching roller of a third image forming apparatus.

### DESCRIPTION OF THE EMBODIMENTS

Hereinafter, preferred examples of the present invention will be exemplarily described in detail with reference to the drawings.

However, the dimensions, materials, shapes, relative arrangements, and the like of the components described in the following examples should be appropriately changed according to the configuration of an apparatus to which the present invention is applied and various conditions.

Therefore, the scope of the present invention is not limited unless otherwise specified. Although a plurality of features are described in the examples, all of the plurality of features are not necessarily essential to the invention, and the plurality of features may be arbitrarily combined.

### <Description of Image Forming Apparatus>

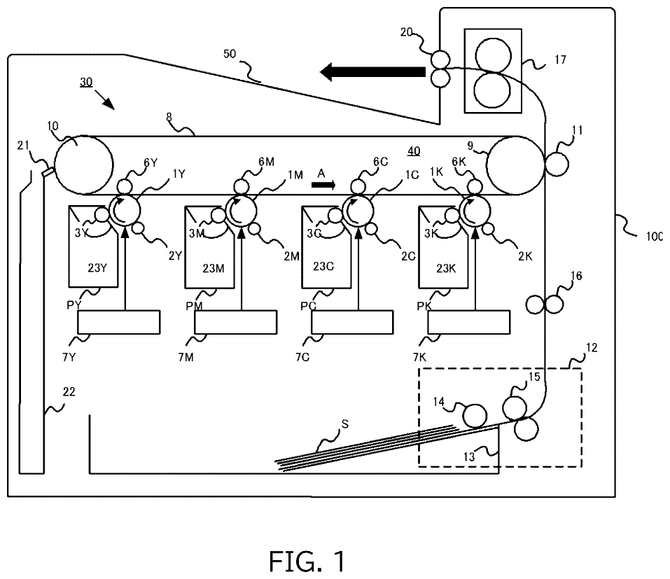

FIG. 1 is a schematic cross-sectional view of a color image forming apparatus 100 according to the present example. The image forming unit 30 forms toner images of a plurality of colors, here, overlapping toner images of four colors of yellow (Y), magenta (M), cyan (C), and black (K) on a moving intermediate transfer member 8. Therefore, the image forming unit 30 includes four process cartridges P (PY, PM, PC, and PK) as developing means that can be attached to the main body of the image forming apparatus 100. Further, the image forming unit 30 includes an intermediate transfer unit 40 using the intermediate transfer member 8. The four process cartridges PY, PM, PC, and PK have the same structure. The difference is that an image is formed by toners of colors contained in the process cartridges P, that is, yellow (Y), magenta (M), cyan (C), and black (K). Note that the letters Y, M, C, and K at the end of the reference numerals indicate the toner colors, and will be omitted when matters common to the respective colors are described below.

The process cartridge P includes a toner container 23, an electrophotographic photosensitive member 1 as an image carrier, a charging roller 2, and a developing roller 3. A laser unit 7 is disposed below the process cartridge P and performs exposure based on an image signal on the electrophotographic photosensitive member 1. The electrophotographic photosensitive member 1 is rotationally driven at a predetermined peripheral speed in a clockwise direction indicated by the arrow. Then, the electrophotographic photosensitive member 1 is charged to a predetermined negative potential by applying a predetermined negative voltage to the charging roller 2, and then an electrostatic latent image is formed by scanning exposure using the laser unit 7. The electrostatic latent image is reversely developed by applying a predetermined negative voltage to the developing roller 3, and a toner image (negative polarity) is formed on the electrophotographic photosensitive member 1. The above process is referred to as a developing process.

The intermediate transfer unit 40 includes an intermediate transfer member 8 which is an endless belt body having flexibility, a driving roller 9 suspending and stretching the intermediate transfer member 8, and a driven roller 10. Further, a primary transfer roller 6 is disposed inside of the intermediate transfer member 8 to face the electrophotographic photosensitive member 1 and is in contact with the corresponding electrophotographic photosensitive member 1 via the intermediate transfer member 8. A contact portion between the electrophotographic photosensitive member 1 and the intermediate transfer member 8 is a primary transfer nip portion. A transfer voltage is applied to the primary transfer roller 6 by a voltage applying means (not illustrated).

The intermediate transfer member 8 rotates (moves) at a constant peripheral speed in the counterclockwise direction indicated by the arrow A by rotational driving of the driving roller 9. A negative toner image formed on the electrophotographic photosensitive member 1 is primarily transferred onto the intermediate transfer member 8 at the primary transfer nip portion by applying a positive voltage to the primary transfer roller 6. On the intermediate transfer member 8, toner images of four colors of Y, M, C, and K are formed in an overlapping manner in this order. The above process is referred to as a primary transfer process. Subsequently, the intermediate transfer member 8 rotates (moves) and is conveyed to a secondary transfer nip portion which is a contact portion between the intermediate transfer member 8 and a secondary transfer roller 11.

A feeding and conveying device 12 includes a feeding roller 14 that feeds a transfer material S from a transfer material cassette 13 in which the transfer material S in the form of sheet is loaded and stored, and a pair of conveying rollers 15 that conveys the fed transfer material S. The transfer material S conveyed from the feeding and conveying device 12 is introduced into the secondary transfer nip portion at a predetermined control timing by a pair of registration rollers 16, and is nipped and conveyed at the secondary transfer nip portion. A positive voltage is applied to the secondary transfer roller 11. As a result, the four color overlapping toner images on the side of the intermediate transfer member 8 are secondarily transferred to the transfer material S sequentially or collectively with respect to the transfer material S nipped and conveyed at the secondary transfer nip portion. The above process is referred to as a secondary transfer process.

The transfer material S on which the toner images have been formed by secondary transfer as described above is introduced into a fixing device 17 as a fixing unit. The transfer material S subjected to heating and fixing of the toner images by the fixing device 17 is discharged onto a discharge tray 50 by a pair of discharge rollers 20.

In the process cartridge P, the toner (primary transfer residual toner) remaining on the surface of the electrophotographic photosensitive member after primary transfer of the toner images from the electrophotographic photosensitive member 1 to the intermediate transfer member 8 is charged to a negative polarity which is a normal charging polarity when passing through the charging roller 2. Thereafter, the primary transfer residual toner is collected by the developing roller 3 and reused according to the potential difference between the electrophotographic photosensitive member 1 and the developing roller 3. That is, in the present example, a so-called drum cleaner-less system without a primary transfer residual toner cleaning means is used.

The toner remaining on the surface of the intermediate transfer member 8 after secondary transfer of the toner images from the intermediate transfer member 8 to the transfer material S is removed by a cleaning blade 21 in counter contact with the intermediate transfer member 8. The removed toner is collected in a waste toner collection container 22.

The electrophotographic photosensitive member 1 is rotationally driven by a driving device (not illustrated), and the intermediate transfer member 8 is rotated by rotational driving of the driving roller 9. Therefore, if a rotational speed difference between the driving device and the driving roller 9 is provided, a peripheral speed difference can be provided between the peripheral speeds of the electrophotographic photosensitive member 1 and the intermediate transfer member 8. It is known that when there is a peripheral speed difference between the peripheral speeds of the electrophotographic photosensitive member 1 and the intermediate transfer member 8, primary transferability is improved by the effect of rolling the toner at the primary transfer nip portion.

### <Description of Image Blurring>

When the frictional force between the electrophotographic photosensitive member 1 and the intermediate transfer member 8 is large, the peripheral speed of the electrophotographic photosensitive member 1 is likely to fluctuate. When the electrophotographic photosensitive member 1 and the intermediate transfer member 8 are in direct contact with each other, the frictional force is large, but when the toner enters the primary transfer nip portion, the frictional force decreases due to the toner interposed between the electrophotographic photosensitive member 1 and the intermediate transfer member 8, and the peripheral speed of the electrophotographic photosensitive member 1 instantaneously fluctuates. At that time, an electrostatic latent image formed by exposure of the laser unit 7 is distorted, and thus image blurring (exposure blurring) occurs. In addition, the toner of the primary transfer portion may be shifted to cause image blurring (primary transfer blurring). As a countermeasure, a method of making the frictional resistance constant in both a case where the toner is present at the primary transfer nip portion and a case where the toner is not present at the primary transfer nip portion, that is, a method of reducing the frictional force in a case where the toner is not present at the primary transfer nip portion (in a case where the electrophotographic photosensitive member 1 and the intermediate transfer member 8 are in direct contact with each other) is effective.

Therefore, by using the electrophotographic photosensitive member 1 and the intermediate transfer member 8 described below, the frictional force can be reduced and image blurring can be curbed even when the electrophotographic photosensitive member 1 and the intermediate transfer member 8 are in contact with each other.

### <Description of Electrophotographic Photosensitive Member>

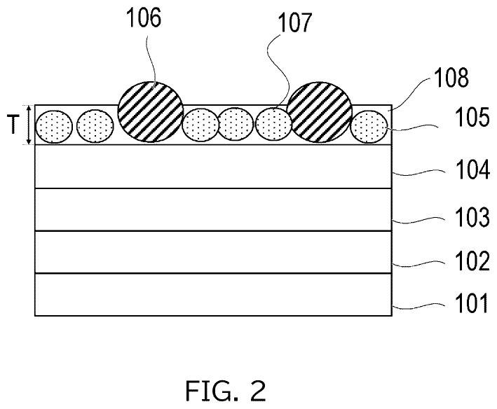

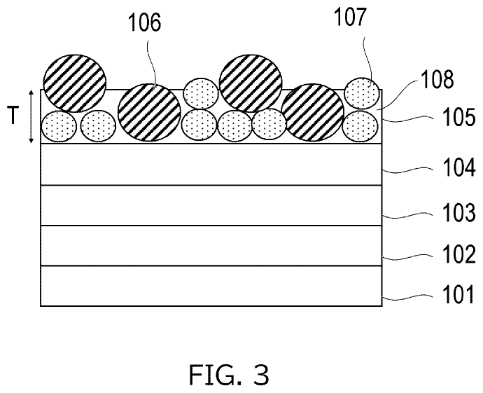

The electrophotographic photosensitive member 1 of the present invention includes a surface layer which will be described later. FIGS. 2 and 3 show an example of a layer configuration of the electrophotographic photosensitive member. In FIGS. 2 and 3, reference numeral 101 denotes a support, reference numeral 102 denotes an undercoat layer, reference numeral 103 denotes a charge generation layer, and reference numeral 104 denotes a charge transport layer. Reference numeral 105 denotes a surface layer according to the present invention, reference numerals 106 and 107 denote particles contained in the surface layer 105, and the size of the particle (first particle) denoted by reference numeral 106 is larger than that of the particle (second particle) denoted by reference numeral 107. Reference numeral 108 denotes a binder resin.

Examples of a method of manufacturing the electrophotographic photosensitive member of the present invention include a method of preparing a coating liquid for each layer which will be described later, coating the coating liquid in order of desired layers, and drying the same. At this time, examples of a method of coating the coating liquid include dip coating, spray coating, inkjet coating, roll coating, die coating, blade coating, curtain coating, wire bar coating, ring coating, dispense coating, and the like. Among them, dip coating is preferable from the viewpoint of efficiency and productivity.

Each layer will be described below.

### <Surface Layer>

The electrophotographic photosensitive member 1 of the present invention is an electrophotographic photosensitive member 1 having a surface layer 105 containing particles 106 and 107 and a binder resin 108, and has a plurality of peaks in a particle size distribution based on the number of particles. Among the plurality of peaks, a peak having a peak top of 20 nm or more and having the maximum peak top frequency is defined as a first peak. Furthermore, a peak having the second peak top frequency is defined as a second peak. The first peak and the second peak are compared, and a peak having a larger value of the particle size of the peak top is defined as a peak PEA. In the present invention, the particle size DA of the peak top of the peak PEA needs to be 80 nm or more, and needs to be within a range determined from a relationship with the arithmetic mean curvature Spc of the peak point obtained from surface roughness measurement of the intermediate transfer member 8. Details of the relationship with the intermediate transfer member 8 will be described later.

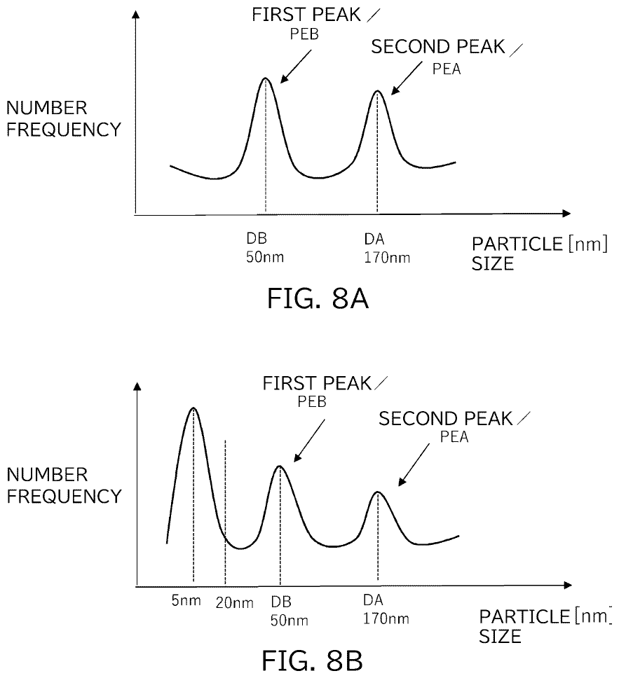

FIG. 8A shows an example of a particle size distribution based on the number of particles, in which the first peak is present at a particle size of 50 nm and the second peak is present at a particle size of 170 nm. In this case, the second peak having a large particle size is the peak PEA, and the particle size DA is 170 nm. Therefore, the condition of 80 nm≤DA is satisfied. In addition, since the particle size of the first peak is 50 nm, the condition that the particle size at the peak top is 20 nm or more is satisfied.

FIG. 8B shows another example of a particle size distribution. There is a peak at a particle size of 5 nm, but since the particle size at the peak top is less than 20 nm, this peak is not included in the first peak and the second peak. Therefore, as in the case of FIG. 8A, the peak having the particle size of 50 nm is the first peak, and the peak having the particle size 170 nm is the second peak. The reason why peaks are selected in this way will be described. Here, even with the electrophotographic photosensitive member 1 in which a large number of very small particles are contained in the surface layer 105, it is possible to obtain the effects of the present invention as described later. Therefore, as described in FIG. 8, by selecting the first peak and the second peak from peaks having particle sizes of 20 nm or more, the effects of the present invention can be stably obtained.

In such a configuration of the surface layer 105, the particle size DA of the peak top of the peak PEA represents the particle size of the particle having the maximum frequency of the particle size or the particle having the second highest frequency in the surface layer, excluding particles of less than 20 nm. According to study of the present inventors, when the particle size DA was 80 nm or more, an effect of reducing the frictional force between the electrophotographic photosensitive member 1 and the intermediate transfer member 8 was obtained. When the particle size DA is less than 80 nm, protruded portions derived from smaller particles contained in the surface layer of the intermediate transfer member 8 and the electrophotographic photosensitive member 1 contribute to contact between the electrophotographic photosensitive member 1 and the intermediate transfer member 8, and the number of contact points increases and the frictional force increases.

Next, on the surface of the surface layer of the electrophotographic photosensitive member 1 of the present invention, when an area occupied by the particle is denoted by S1 and an area occupied by other than the particle is denoted by S2, S1/(S1+S2) is preferably at least 0.70 and not more than 1.00.

On the other hand, when S1/(S1+S2) is less than 0.70, a portion without particles cannot form a protruded portion, and thus the contact area between the electrophotographic photosensitive member 1 and the intermediate transfer member 8 increases, and the frictional force is hardly reduced. In addition, since the proportion of particles is high and the tightness increases, detachment of the particles when the particles are impacted in the tangential direction of the surface of the electrophotographic photosensitive member is curbed. This is because not only binding by the binder resin between particles but also the effect of keeping the movement of particles by other particles is exhibited. Theoretically, the upper limit of S1/(S1+S2) is 1.00. S1/(S1+S2) is more preferably at least 0.80 and not more than 1.00, and still more preferably at least 0.85 and not more than 0.95.

In addition, when particles having particle sizes in the range of DA±20 nm are referred to as particles PAA, protruded portions derived from the particles PAA are referred to as CA, and the surface layer of the electrophotographic photosensitive member 1 is viewed from above, it is preferable that the average value of distances between the centers of gravity of the protruded portions CA be at least 150 nm and not more than 500 nm, and the standard deviation of the distances between the centers of gravity be 250 nm or less.

When the number of protruded portions CA derived from the particles of the surface layer 105 is small, the distance between the centers of gravity of the protruded portions CA is large, the contact area between the electrophotographic photosensitive member 1 and the intermediate transfer member 8 increases, and the frictional force cannot be reduced. When the distance between the centers of gravity of the protruded portions CA in the surface layer is excessively small, the surface layer is filled with the protruded portions CA, and as a result, the number of contact points between the surface layer 105 and the intermediate transfer member 8 increases. The distance between the centers of gravity in the present invention is more preferably at least 150 nm and not more than 450 nm, and further preferably at least 150 nm and not more than 400 nm.

On the other hand, when the standard deviation of the distances between the centers of gravity of the protruded portions CA exceeds 250 nm, the distribution of the protruded portions CA in the surface layer 105 varies, the frictional force between the electrophotographic photosensitive member 1 and the intermediate transfer member 8 becomes uneven, and the peripheral speed of the electrophotographic photosensitive member 1 or the intermediate transfer member 8 becomes uneven. When the peripheral speed becomes uneven, image blurring is likely to occur. In addition, as long as the distance between the centers of gravity falls within the range of the average value and the standard deviation, the particles are densely present, and the durability against detachment of the particles is high.

In order to improve the durability of the electrophotographic photosensitive member 1 and maintain the frictional force reducing effect even in the latter half of the lifespan of the image forming apparatus 100, either “S1/(S1+S2) is at least 0.70 and not more than 1.00” or “the average value of the distances between the centers of gravity of the protruded portions CA is at least 150 nm and not more than 500 nm, and the standard deviation of the distances between the centers of gravity is 250 nm or less” is a necessary condition. It is more preferable that S1/(S1+S2) is at least 0.70 and not more than 1.00, the average value of the distances between the centers of gravity of the protruded portions CA is at least 150 nm and not more than 500 nm, and the standard deviation of the distances between the centers of gravity is 250 nm or less.

In the cross section of the surface layer 105 in the electrophotographic photosensitive member 1 of the present invention, when the average film thickness of the surface layer at a portion that does not contain the particles PAA is T, it is preferable that

DA>T
is satisfied. When DA is equal to or less than the average film thickness T, it becomes difficult to form protruded portions, and thus there is a high possibility that the effect of reducing the frictional force between the electrophotographic photosensitive member 1 and the intermediate transfer member 8 cannot be obtained. The average film thickness T is preferably 50 nm to 500 nm in a state in which the particles are laminated as shown in FIGS. 2 and 3 to satisfy the above formula. The average film thickness is more preferably 70 nm to 450 nm, still more preferably 80 nm to 400 nm.

Further, when the first peak and the second peak are compared, and a peak having a smaller value of the particle size of the peak top is defined as a peak PEB, it is preferable that a particle size DB of the peak top of the peak PEB satisfies

DB<T

When particles having particle sizes in the range of DB±20 nm among all the particles contained in the surface layer 105 are defined as particles PAB, by making DB equal to or less than the average film thickness T, the closeness of the particles PAA forming the protruded portions CA and the particles PAB arranged between the protruded portions CA is enhanced, and detachment of the particles is curbed. When DB is equal to or greater than the average film thickness T, the particles PAB are easily exposed to the surface, and detachment of the particles easily proceeds.

Furthermore, it is preferable that DA and DB satisfies

DB/DA>1/10

It is possible to curb detachment of particles with respect to sliding in the tangential direction in the surface layer of the electrophotographic photosensitive member 1 while maintaining the heights of protruded portions CA sufficiently.

Next, it is preferable that the proportion of the number of the protruded portions CA to the number of protruded portions present on the surface of the surface layer 105 in the electrophotographic photosensitive member 1 of the present invention be 90 number % or more. Protruded portions other than the protruded portions CA are not derived from the particles PAA and refer to portions having heights greater than the average film thickness T. Protruded portions other than the protruded portions CA are generated by the particles PAB smaller than the particles PAA or film thickness unevenness of the binder resin. Such protruded portions have low mechanical strength, and the protruded portions are easily worn with respect to sliding in the tangential direction of the electrophotographic photosensitive member. When the proportion of the number of protruded portions CA is less than 90 number %, the number of protruded portions to be worn increases, and it becomes difficult to maintain the frictional force in a favorable state for long-term use.

The half-value width of the peak PEA is preferably 50 nm or less. Since the heights of the protruded portions CA are controlled by the size of the particle size, the half-value width of the peak PEA is preferably in a constant range as much as possible. When the half-value width of the peak PEA exceeds 50 nm, variation in the heights of the protruded portions CA also increases, and the contact state between the electrophotographic photosensitive member 1 and the intermediate transfer member 8 is likely to vary.

The circularity of the particles PAA is preferably 0.950 or more. When the circularity of the particles PAA is less than 0.950, the contact area between the electrophotographic photosensitive member 1 and the intermediate transfer member 8 increases. The average circularity of the particles was obtained as follows using a scanning electron microscope. The particles to be measured were observed using a scanning electron microscope (“JSM7800F”, manufactured by JEOL Ltd.), and the particle size of each of 100 particles was measured from an image obtained by observation. For each particle, the longest side a and the shortest side b of the primary particle were measured, and the circularity was defined as b/a. The circularities of 100 particles were averaged to calculate the average circularity.

The surface layer 105 of the electrophotographic photosensitive member 1 of the present invention contains at least the particles PAA and the particles PAB as described above. Examples of the particles PAA used in the present invention include organic resin particles such as acrylic resin particles, inorganic particles such as silica, and organic-inorganic hybrid particles. The particle PAA and the particle PAB may be the same material or different materials.

Acrylic particles contain a polymer of an acrylic acid ester or a methacrylic acid ester. Among them, styrene acrylic particles are more preferable. The polymerization degree of the acrylic resin and the styrene acrylic resin and whether the resin is thermoplastic or thermosetting are not particularly limited. Examples of organic resin particles include crosslinked polystyrene, crosslinked acrylic resin, phenol resin, melamine resin, polyethylene, polypropylene, acrylic particles, polytetrafluoroethylene particles, and silicone particles.

Examples of inorganic particles include silica particles, metal oxide particles, and metal particles. Among them, silica particles are preferable. Since silica particles have a lower elastic modulus and a larger average circularity than other insulating particles, an effect of promoting point contact between the intermediate transfer member 8 and the photosensitive member 1 to reduce adhesion is expected.

Known silica fine particles can be used as the silica particles, and any of dry silica fine particles and wet silica fine particles may be used. Fine particles of wet silica obtained by a sol-gel method (hereinafter, also referred to as sol-gel silica) are preferable.

The sol-gel silica used for the particles contained in the surface layer 105 of the electrophotographic photosensitive member 1 of the present invention may be hydrophilic or may have a hydrophobized surface.

Examples of the method for hydrophobizing treatment include a method of removing a solvent from a silica sol suspension, drying the silica sol suspension, and then treating the same with a hydrophobizing agent, and a method of directly adding a hydrophobizing agent to the silica sol suspension, and treating the silica sol suspension simultaneously with drying, in the sol-gel method. From the viewpoint of controlling the half-value width of the particle size distribution and controlling the saturated moisture adsorption amount, the method of directly adding a hydrophobizing agent to a silica sol suspension is preferable.

Examples of the hydrophobizing agent include the following.

Chlorosilanes such as methyltrichlorosilane, dimethyldichlorosilane, trimethylchlorosilane, phenyltrichlorosilane, diphenyldichlorosilane, t-butyldimethylchlorosilane, and vinyltrichlorosilane;
alkoxysilanes such as tetramethoxy silane, methyltrimethoxy silane, dimethyldimethoxy silane, phenyltrimethoxy silane, diphenyldimethoxy silane, o-methylphenyltrimethoxy silane, p-methylphenyltrimethoxy silane, n-butyltrimethoxy silane, i-butyltrimethoxy silane, hexyltrimethoxy silane, octyl trimethoxy silane, decyltrimethoxy silane, dodecyl trimethoxy silane, tetraethoxy silane, methyltriethoxy silane, dimethyldiethoxysilane, phenyltriethoxysilane, diphenyldiethoxysilane, i-butyltriethoxysilane, decyltriethoxysilane, vinyltriethoxy silane, γ-methacryloxypropyltrimethoxy silane, γ-glycidoxypropyltrimethoxy silane, γ-glycidoxypropylmethyldimethoxy silane, γ-mercaptopropyltrimethoxy silane, γ-chloropropyltrimethoxy silane, γ-aminopropyltrimethoxy silane, γ-aminopropyltriethoxy silane, γ-(2-aminoethyl)aminopropyltrimethoxy silane, and γ-(2-aminoethyl)aminopropylmethyldimethoxysilane;
silazanes such as hexamethyldisilazanes, hexaethyldisilazanes, hexapypropyldisilazanes, hexabutyldisilazanes, hexopentyldisilazanes, hexahexyldisilazanes, hexacyclohexyldisilazanes, hexaphenyldisilazanes, divinyltetramethyldisilazane, and dimethyltetravinyldisilazane;
silicon oils such as dimethyl silicone oil, methyl hydrogen silicone oil, methylphenyl silicone oil, alkyl-modified silicone oil, chloroalkyl-modified silicone oil, a chlorophenyl-modified silicone oil, a fatty acid-modified silicone oil, a polyether-modified silicone oil, an alkoxy-modified silicone oil, carbinol-modified silicone oil, amino-modified silicone oil, fluorine-modified silicone oil, and end-reactive silicone oil;
siloxanes such as hexamethylcyclotrisiloxane, octamethylcyclotetrasiloxane, decamethylcyclopentasiloxane, hexamethyldisiloxane, and octamethyltrisiloxane;

Fatty acids and metal salts thereof include undecylic acid, lauric acid, tridecylic acid, dodecyl acid, myristic acid, palmitic acid, pentadecylic acid, stearic acid, heptadecylic acid, long chain fatty acids such as arachidonic acid, montanic acid, oleic acid, linolic acid, arachidonic acid, and the like, the fatty acids and zinc, iron, magnesium, aluminum, calcium, salts with metals, such as sodium, lithium.

Among them, alkoxysilanes, silazanes, and silicone oils are preferably used because they are easy to perform hydrophobizing treatment. These hydrophobizing agents may be used singly or in combination of two or more kinds thereof.

The surface layer 105 in the present invention may contain additives such as an antioxidant, an ultraviolet absorber, a plasticizer, a leveling agent, a slipperiness imparting agent, and an abrasion resistance improver. Specific examples thereof include a hindered phenol compound, a hindered amine compound, a sulfur compound, a phosphorus compound, a benzophenone compound, a siloxane-modified resin, silicone oil, and the like.

The surface layer 105 of the present invention can be formed by preparing a surface layer coating liquid containing each of the above-described materials and a solvent, forming a coating film, and drying and/or curing the coating film. Examples of the solvent used in the coating liquid include an alcohol-based solvent, a ketone-based solvent, an ether-based solvent, a sulfoxide-based solvent, an ester-based solvent, and an aromatic hydrocarbon-based solvent.

In the surface layer 105 of the present invention, the proportion of the volume of the particles to the total volume of the surface layer 105 is preferably 40 vol % to 90 vol %. Furthermore, the ratio is more preferably 45 vol % to 85 vol %, and still more preferably 50 vol % to 80 vol %. Within this range, formation of the protruded portions of the surface layer as described above can be reliably achieved. When the ratio is 30 vol % or less, since the heights of the protruded portions are reduced, the frictional force cannot be reduced. When the ratio exceeds more than 90 vol %, the particles are easily detached, and the effect of reducing the frictional force cannot be maintained when a durability test is performed.

In addition, for the purpose of improving the charge transporting ability of the surface layer 105, a charge transporting material may be added to the surface layer coating liquid. In addition, additives can be added for the purpose of improving various functions. Examples of additives include conductive particles, an antioxidant, an ultraviolet absorber, a plasticizer, and a leveling agent.

Examples of the binder resin 108 according to the present invention include the following forms. Here, the surface layer 105 preferably contains a charge transporting material. Examples of the binder resin include a polyester resin, an acrylic resin, a phenoxy resin, a polycarbonate resin, a polystyrene resin, a phenol resin, a melamine resin, an epoxy resin, and the like. Among them, a polycarbonate resin, a polyester resin, and an acrylic resin are preferable.

The surface layer 105 of the present invention may be formed as a cured film by polymerizing a composition containing a monomer having a polymerizable functional group. Examples of the reaction at that time include a thermal polymerization reaction, a photopolymerization reaction, a radiation polymerization reaction, and the like. Examples of the polymerizable functional group of the monomer having a polymerizable functional group include an acrylic group, a methacrylic group, and the like. As the monomer having a polymerizable functional group, a material having charge transporting ability may be used.

The compound having a polymerizable functional group may have a charge transport structure at the same time as the chain polymerizable functional group. As the charge transport structure, a triarylamine structure is preferable from the viewpoint of charge transport. The chain polymerizable functional group is preferably an acryloyl group or a methacryloyl group. The number of functional groups may be one or more. Among them, forming a cured film containing a compound having a plurality of functional groups and a compound having one functional group is particularly preferable because strain generated due to polymerization of the plurality of functional groups is easily eliminated.

Examples of the compound having one functional group are shown in (2-1) to (2-6).

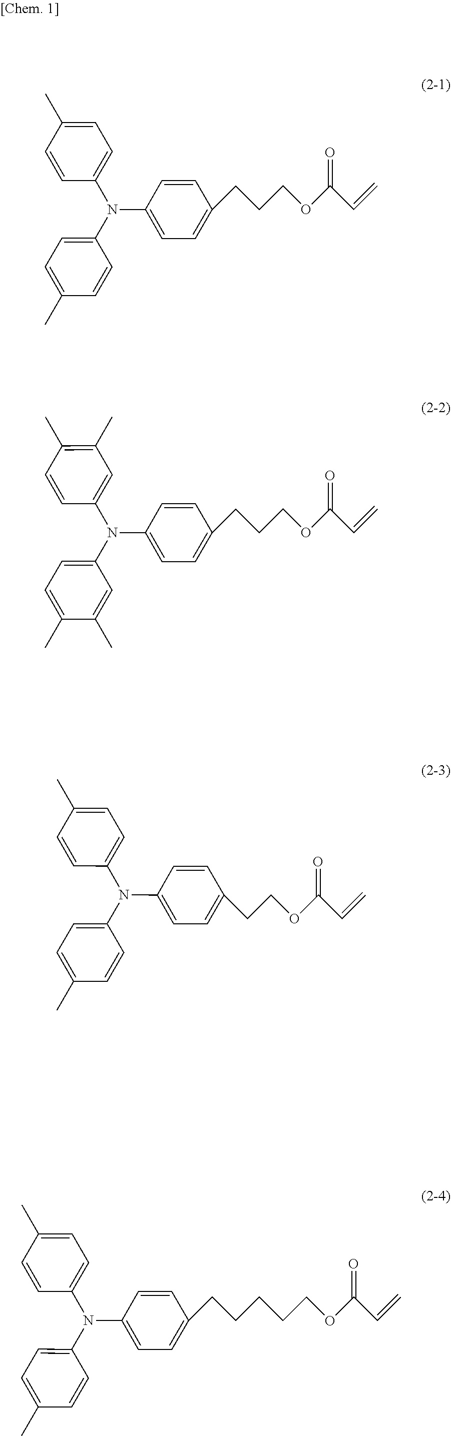

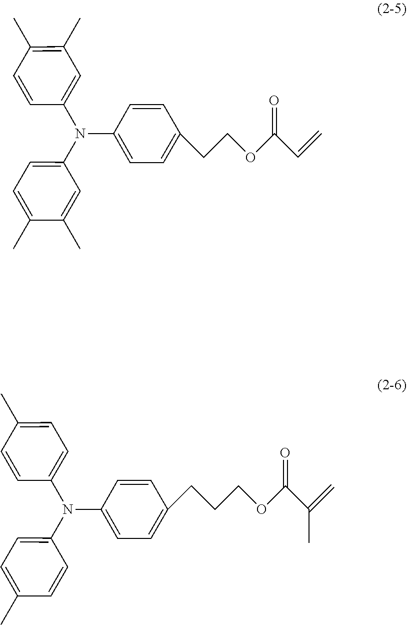

Examples of the compound having a plurality of functional groups described above are shown in (3-1) to (3-6).

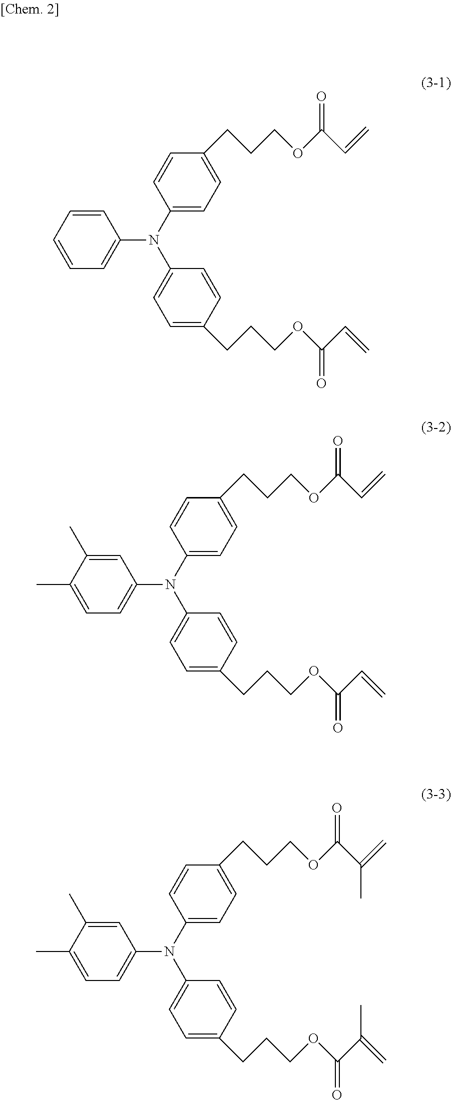

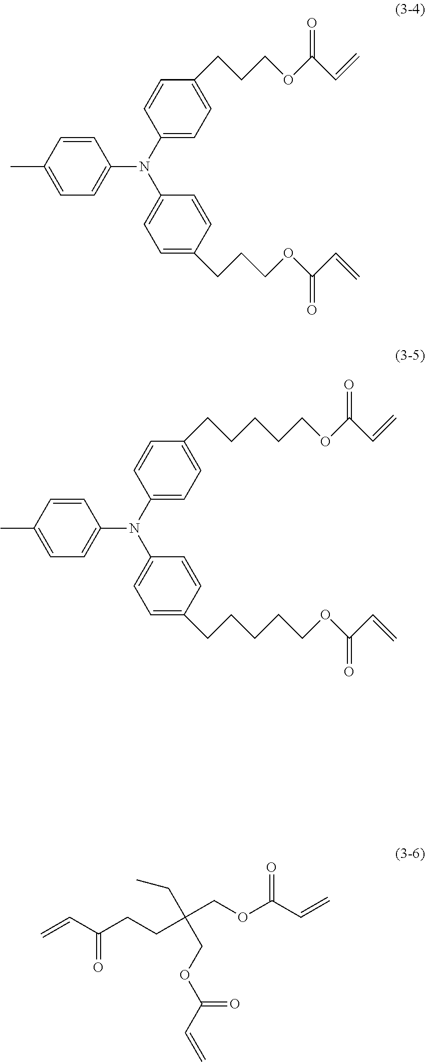

### <Support>

In the present invention, the electrophotographic photosensitive member 1 preferably includes a support. In the present invention, the support is preferably a conductive support having conductivity. Examples of the shape of the support include a cylindrical shape, a belt shape, a sheet shape, and the like. Among them, a cylindrical support is preferable. The surface of the support may be subjected to electrochemical treatment such as anodization, blast treatment, cutting treatment, and the like.

The material of the support is preferably metal, resin, glass, or the like. Examples of the metal include aluminum, iron, nickel, copper, gold, stainless steel, alloys thereof, and the like. Among them, an aluminum support using aluminum is preferable.

In addition, conductivity may be imparted to the resin or glass by treatment such as mixing or coating with a conductive material.

### <Conductive Layer>

In the present invention, a conductive layer may be provided on the support. By providing the conductive layer, scratches and unevenness on the surface of the support can be concealed, and reflection of light on the surface of the support can be controlled. The conductive layer preferably contains conductive particles and a resin.

Examples of the material of the conductive particles include metal oxides, metals, carbon black, and the like.

Examples of the metal oxides include zinc oxide, aluminum oxide, indium oxide, silicon oxide, zirconium oxide, tin oxide, titanium oxide, magnesium oxide, antimony oxide, bismuth oxide, and the like. Metals include aluminum, nickel, iron, nichrome, copper, zinc, silver, and the like.

Among them, it is preferable to use a metal oxide as the conductive particles, and in particular, it is more preferable to use titanium oxide, tin oxide, or zinc oxide.

When a metal oxide is used as the conductive particles, the surface of the metal oxide may be treated with a silane coupling agent or the like, or the metal oxide may be doped with an element such as phosphorus or aluminum or an oxide thereof.

In addition, the conductive particles may have a laminated configuration in which uncoated particles such as titanium oxide, barium sulfate, and zinc oxide and the particles are coated with a metal oxide having a composition different from that of the uncoated particles. Examples of coating include metal oxides such as tin oxide.

When a metal oxide is used as the conductive particles, the average primary particle size is preferably at least 1 nm and not more than 500 nm or less, and more preferably at least 3 nm and not more than 400 nm.

Examples of the resin include a polyester resin, a polycarbonate resin, a polyvinyl acetal resin, an acrylic resin, a silicone resin, an epoxy resin, a melamine resin, a polyurethane resin, a phenol resin, an alkyd resin, and the like.

The conductive layer may further contain a masking agent such as silicone oil, resin particles, or titanium oxide.

The average film thickness of the conductive layer is preferably at least 1 μm and not more than 50 μm or less, and particularly preferably at least 3 μm and not more than 40 μm.

The conductive layer can be formed by preparing a conductive layer coating liquid containing each of the above-described materials and a solvent, forming a coating film, and drying the coating film. Examples of the solvent used in the coating liquid include an alcohol-based solvent, a sulfoxide-based solvent, a ketone-based solvent, an ether-based solvent, an ester-based solvent, an aromatic hydrocarbon-based solvent, and the like. Examples of a dispersion method for dispersing the conductive particles in the conductive layer coating liquid include methods using a paint shaker, a Sandoz mill, a ball mill, and a liquid collision type high-speed disperser.

### <Undercoat Layer>

In the present invention, an undercoat layer may be provided on the support or the conductive layer.

The average film thickness of the undercoat layer is preferably at least 0.1 μm and not more than 50 μm, more preferably at least 0.2 μm and not more than 40 μm or less, and particularly preferably at least 0.3 μm and not more than 30 μm.

Examples of the resin of the undercoat layer include a polyacrylic acid resin, a polyvinyl alcohol resin, a polyvinyl acetal resin, a polyethylene oxide resin, a polypropylene oxide resin, an ethyl cellulose resin, a methyl cellulose resin, a polyamide resin, a polyamide acid resin, a polyurethane resin, a polyimide resin, a polyamideimide resin, a polyvinyl phenol resin, a melamine resin, a phenol resin, an epoxy resin, and an alkyd resin.

The resin may have a structure in which a resin having a polymerizable functional group and a monomer having a polymerizable functional group are crosslinked.

In addition, the undercoat layer may contain an inorganic compound or an organic compound in addition to the resin.

Examples of the inorganic compound include metals, oxides, and salts.

Examples of the metal include gold, silver, aluminum, and the like. Examples of the oxide include zinc oxide, white lead, aluminum oxide, indium oxide, silicon oxide, zirconium oxide, tin oxide, titanium oxide, magnesium oxide, antimony oxide, bismuth oxide, indium oxide, tin oxide, zirconium oxide, and the like. Examples of the salt include barium sulfate and strontium titanate.

These inorganic compounds may be present in the film in a particulate state.

The number-average particle size of the particles is preferably at least 1 nm and not more than 500 nm, and more preferably at least 3 nm and not more than 400 nm.

These inorganic compounds may have a laminated configuration including core particles and a coating layer coating the particles.

The surfaces of these inorganic compounds may be treated with silicone oil, a silane compound, a silane coupling agent, other organic silicon compounds, an organic titanium compound, or the like. In addition, elements such as tin, phosphorus, aluminum, and niobium may be doped.

Examples of the organic compound include electron transport compounds and conductive polymers.

Examples of conductive polymers include polythiophene, polyaniline, polyacetylene, polyphenylene, and polyethylene dioxythiophene.

Examples of the electron transporting material include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound.

The electron transporting material has a polymerizable functional group, and may be crosslinked with a resin having a functional group capable of reacting with the functional group. Examples of the polymerizable functional group include a hydroxy group, a thiol group, an amino group, a carboxyl group, a vinyl group, an acryloyl group, a methacryloyl group, an epoxy group, and the like.

These organic compounds may be present in the film in a particulate state, or the surface thereof may be treated.

Various additives such as a leveling agent such as silicone oil, a plasticizer, and a thickener may be added to the undercoat layer.

The undercoat layer is obtained by preparing an undercoat layer coating liquid containing the above materials, then coating the coating liquid onto the support or the conductive layer, and then drying or curing the coating film.

Examples of the solvent in preparing the coating liquid include an alcohol-based solvent, a ketone-based solvent, an ether-based solvent, an ester-based solvent, an aromatic hydrocarbon-based solvent, and the like.

Examples of a dispersion method for dispersing the particles in the coating liquid include methods using a paint shaker, a Sandoz mill, a ball mill, and a liquid collision type high-speed disperser.

### <Photosensitive Layer>

A photosensitive layer of the electrophotographic photosensitive member 1 is mainly classified into (1) a laminated photosensitive layer and (2) a monolayer type photosensitive layer. (1) The laminated photosensitive layer is a photosensitive layer including a charge generation layer containing a charge generating material and a charge transport layer containing a charge transporting material. (2) The monolayer type photosensitive layer is a photosensitive layer containing both a charge generating material and a charge transporting material.

### (1) Laminated Photosensitive Layer

The laminated photosensitive layer includes a charge generation layer and a charge transport layer.

### (1-1) Charge Generation Layer

The charge generation layer preferably contains a charge generating material and a resin.

Examples of the charge generating material include azo pigments, perylene pigments, polycyclic quinone pigments, indigo pigments, phthalocyanine pigments, and the like. Among them, azo pigments and phthalocyanine pigments are preferable. Among the phthalocyanine pigments, oxytitanium phthalocyanine pigments, chlorogallium phthalocyanine pigments, and hydroxygallium phthalocyanine pigments are preferable.

The content of the charge generating material in the charge generation layer is preferably at least 40 mass % and not more than 85 mass %, and more preferably at least 60 mass % and not more than 80 mass % with respect to the total mass of the charge generation layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, a polyvinyl chloride resin, and the like. Among them, the polyvinyl butyral resin is more preferable.

Further, the charge generation layer may further contain additives such as an antioxidant and an ultraviolet absorber. Specific examples thereof include a hindered phenol compound, a hindered amine compound, a sulfur compound, a phosphorus compound, a benzophenone compound, and the like.

The charge generation layer can be formed by preparing a charge generation layer coating liquid containing each of the above-described materials and a solvent, forming a coating film on the undercoat layer, and drying the coating film. Examples of the solvent used in the coating liquid include an alcohol-based solvent, a sulfoxide-based solvent, a ketone-based solvent, an ether-based solvent, an ester-based solvent, an aromatic hydrocarbon-based solvent, and the like.

The film thickness of the charge generation layer is preferably at least 0.1 μm and not more than 1.5 μm, and more preferably at least 0.15 μm and not more than 1.0 μm.

### (1-2) Charge Transport Layer

The charge transport layer preferably contains a charge transporting material and a resin.

Examples of the charge transporting material include a polycyclic aromatic compound, a heterocyclic compound, a hydrazone compound, a styryl compound, an enamine compound, a benzidine compound, a triarylamine compound, a resin having a group derived from these materials, and the like. Among them, a triarylamine compound and a benzidine compound are preferable.

The content of the charge transporting material in the charge transport layer is preferably at least 25 mass % and not more than 70 mass %, and more preferably at least 30 mass % and not more than 55 mass % with respect to the total mass of the charge transport layer.

Examples of the resin include a polyester resin, a polycarbonate resin, an acrylic resin, a polystyrene resin, and the like. Among them, a polycarbonate resin and a polyester resin are preferable. The polyester resin is particularly preferably a polyarylate resin.

The content ratio (mass ratio) of the charge transporting material to the resin is 4:10 to 20:10 is preferable, 5:10 to 12:10 is more preferable.

In addition, the charge transport layer may contain additives such as an antioxidant, an ultraviolet absorber, a plasticizer, a leveling agent, a slipperiness imparting agent, and an abrasion resistance improver. Specific examples thereof include a hindered phenol compound, a hindered amine compound, a sulfur compound, a phosphorus compound, a benzophenone compound, a siloxane-modified resin, silicone oil, fluororesin particles, polystyrene resin particles, polyethylene resin particles, silica particles, alumina particles, boron nitride particles, and the like.

The charge transport layer can be formed by preparing a charge transport layer coating liquid containing each of the above-described materials and a solvent, forming a coating film on the charge generation layer, and drying the coating film. Examples of the solvent used in the coating liquid include an alcohol-based solvent, a ketone-based solvent, an ether-based solvent, an ester-based solvent, and an aromatic hydrocarbon-based solvent. Among these solvents, an ether-based solvent or an aromatic hydrocarbon-based solvent is preferable.

The film thickness of the charge transport layer is preferably at least 3 μm and not more than 50 μm, more preferably at least 5 μm and not more than 40 μm, and particularly preferably at least 10 μm and not more than 30 μm.

### (2) Monolayer Type Photosensitive Layer

The monolayer type photosensitive layer can be formed by preparing a photosensitive layer coating liquid containing a charge generating material, a charge transporting material, a resin, and a solvent, forming a coating film on the undercoat layer, and drying the coating film. Examples of the charge generating material, the charge transporting material, and the resin are the same as those in the above “(1) Laminated Photosensitive Layer”.

The film thickness of the monolayer type photosensitive layer is preferably at least 10 μm and not more than 45 μm, and more preferably at least 25 μm and not more than 35 μm.

### <Description of Intermediate Transfer Member>

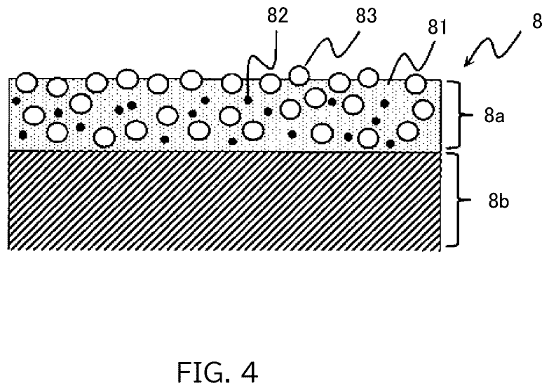

FIG. 4 is a schematic cross-sectional view illustrating a configuration of the intermediate transfer member 8 in the present example. The intermediate transfer member 8 includes a surface layer 8a and a base layer 8b. The surface layer 8a is provided on the outer peripheral surface side of the intermediate transfer member 8 with respect to the base layer 8b and has a surface that carries (holds) the toner transferred from the electrophotographic photosensitive member 1. The intermediate transfer member 8 preferably has an endless belt shape, and preferably has a thickness of at least 10 μm and not more than 500 μm and particularly preferably at least 40 μm and not more than 100 μm.

Examples of the material constituting the base layer 8b include thermoplastic resins such as polycarbonate, polyvinylidene fluoride (PVDF), polyethylene, polypropylene, poly (4 methylpentene)-1, polystyrene, polyamide, polysulfone, polyarylate, polyethylene terephthalate, polybutylene terephthalate, polyethylene naphthalate, polybutylene naphthalate, polyphenylene sulfide, polyether sulfone, polyether nitrile, thermoplastic polyimide, polyether ether ketone, thermotropic liquid crystal polymer, and polyamic acid. Two or more of these can be used in combination.

The intermediate transfer member 8 having an endless belt shape can be obtained by melt-kneading a conductive material or the like in such thermoplastic resins and then molding the base layer 8b by appropriately selecting and using a molding method such as inflation molding, cylindrical extrusion molding, or injection stretch blow molding.

Materials constituting the surface layer 8a includes, as a binding material, a curable resin 81 that is cured by heat or radiation of an energy ray such as light (ultraviolet ray or the like) or an electron beam. As the curable resin 81, an acrylic resin obtained by curing an unsaturated double bond-containing acrylic copolymer is preferable, and for example, an acrylic ultraviolet curable resin (trade name: Opster Z7501) manufactured by JSR Corporation can be used. The surface layer 8a contains an acrylic resin as a main component of a binding material. Here, the main component means 50 mass % or more with respect to the binding material constituting the surface layer 8a.

A conductive material 82 for adjusting electric resistance is added to the surface layer 8a. As the conductive material 82, a conductive filler made of an electron conductive material or an ion conductive material, an electric resistance regulator, or the like can be used. Examples of the electron conductive material include particulate, fibrous, or flaky carbon-based conductive fillers such as carbon black, PAN-based carbon fiber, and expanded graphite pulverized product. Examples of the electron conductive material include particulate, fibrous, or flaky metal-based conductive fillers such as silver, nickel, copper, zinc, aluminum, stainless steel, and iron. Further, examples of the electron conductive material include particulate metal oxide-based conductive fillers such as zinc antimonate, antimony-doped tin oxide, antimony-doped zinc oxide, tin-doped indium oxide, and aluminum-doped zinc oxide. Examples of the ion conductive material include an ionic liquid, a conductive oligomer, and an electrical resistance regulator such as a quaternary ammonium salt. As the conductive material 82, one or more of the above materials can be appropriately selected and used, and an electron conductive material and an ion conductive material may be mixed and used. Among these, a particulate (preferably submicron or less particles) metal oxide-based conductive filler is preferable as the conductive material 82 from the viewpoint that the amount added is small.

Surface layer particles 83 may be added to the surface layer 8a for the purpose of improving transfer efficiency and reducing frictional force with respect to the cleaning blade 21 for a belt. The surface layer particles 83 are preferably solid lubricants, and are usually insulating particles. Examples of the surface layer particles 83 include fluorine-containing particles such as polytetrafluoroethylene (PTFE) resin powder, ethylene trifluoride chloride resin powder, ethylene tetrafluoride hexafluoropropylene resin powder, vinyl fluoride resin powder, vinylidene fluoride resin powder, ethylene dichloride difluoride resin powder, and graphite fluoride, and copolymers thereof. One kind or two or more kinds of surface layer particles 83 can be appropriately selected and used. Further, the surface layer particles 83 may be a solid lubricant such as silicone resin particles, silica particles, or molybdenum disulfide powder. Among these, polytetrafluoroethylene (PTFE) resin particles (emulsion polymerization type PTFE resin particles or the like) are preferable in that the friction coefficient of the surface of the particles is low, and abrasion of another member in contact with the surface of the intermediate transfer member 8, for example, the cleaning blade 21 for a belt can be reduced.

The surface layer 8a is preferably formed uniformly on the base layer 8b in order to satisfy the relationship between the electrophotographic photosensitive member 1 and the intermediate transfer member 8 which will be described later. As a specific method, a method of irradiating the entire area of the surface of the base layer 8b by spray coating for a certain period of time, a method of coating an acrylic resin from a ring-shaped nozzle to the entire area of the surface of the base layer 8b of the cylindrical intermediate transfer member 8, or the like can be used.

The volume resistivity of the intermediate transfer member 8 is preferably in a range of at least 1×10⁹ Ω·cm and not more than 1×10¹² Ω·cm from the viewpoint of performing satisfactory image formation. The volume resistivity can be measured under an environment of a temperature of 25° C. and a humidity of 60% RH using a general-purpose measuring instrument Hiresta UPMCP-HT450 (manufactured by Mitsubishi Chemical Corporation).

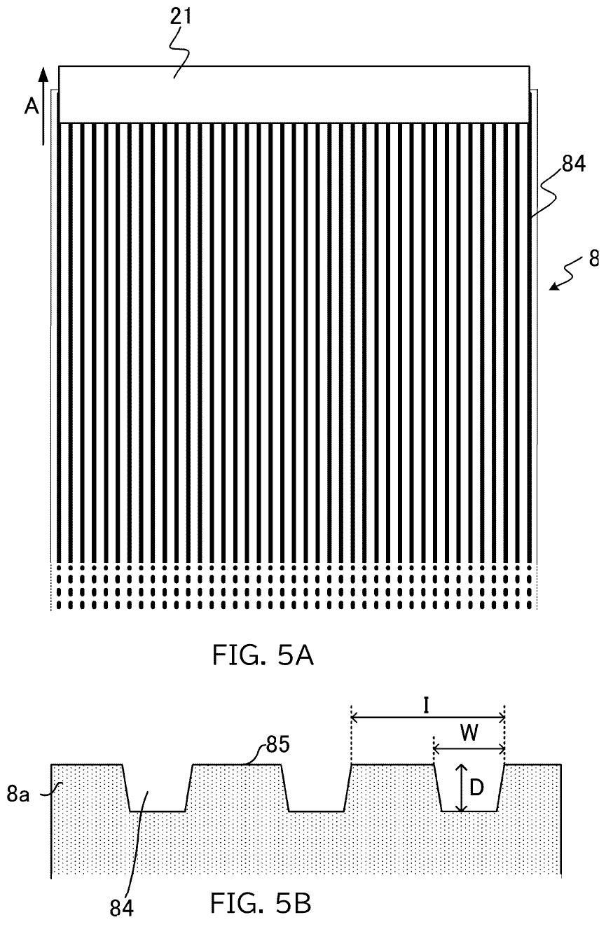

The surface layer 8a may be subjected to surface treatment. FIG. 5A is a schematic diagram of the surface of the intermediate transfer member 8 when surface treatment has been performed, as viewed from above, and FIG. 5B is a schematic diagram of a cross section of the intermediate transfer member 8. Grooves 84 are formed in parallel to an arrow A indicating a rotation direction (movement direction) of the intermediate transfer member 8.

As the surface treatment, the grooves 84 can be formed by using imprinting in which a mold having a shape is brought into contact with the surface layer 8a of the rotating intermediate transfer member 8. By forming the grooves 84, the frictional force between the intermediate transfer member 8 and the cleaning blade 21 is reduced, and the cleaning blade 21 can be prevented from being turned up.

In the case of performing surface treatment in the present example, the groove width W of the grooves 84 was 1.5 μm, the groove depth D was 1.0 μm, and the groove interval I was 4.0 μm. However, the groove width W, the groove depth D, and the groove interval I are not limited thereto. The groove width W is preferably equal to or less than the average particle size of the toner such that the toner does not pass through the contact portion of the cleaning blade 21, and the groove depth D is preferably less than the thickness of the surface layer 8a and in a range in which the grooves do not disappear even if the surface layer 8a is scraped. The groove interval I is preferably appropriately set within a range in which turning up of the cleaning blade 21 can be curbed.

The method of surface treatment is not limited to imprinting, and a method of bringing a wrapping film into contact with the intermediate transfer member 8 may be used. It is sufficient that the grooves 84 can be formed such that the frictional force between the intermediate transfer member 8 and the cleaning blade 21 can be reduced and turning up can be prevented.

### <Relationship Between Electrophotographic Photosensitive Member and Intermediate Transfer Member>

In the present invention, the arithmetic mean curvature Spc (ISO25178) of peak points calculated from the roughness of the surface on the surface of the intermediate transfer member 8 facing the electrophotographic photosensitive member 1 needs to satisfy the relationship between the particle size DA in the surface layer 105 of the electrophotographic photosensitive member 1 and the following formula (1).

80 nm≤DA≤2×(1/Spc) (1)

The arithmetic mean curvature Spc of peak points is the mean of principal curvatures of peak points of the surface and is expressed by the reciprocal of the radius of curvature. Therefore, when Spc is small, it indicates that the peak points are rounded and have a wide protruding shape, and when Spc is large, it indicates that the peak points have a narrow sharp protruding shape.

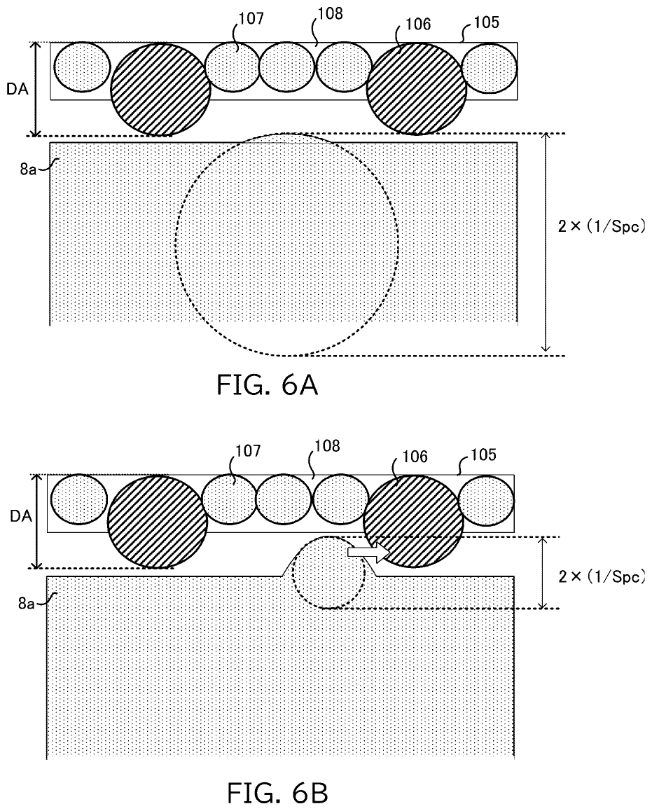

FIG. 6 is a schematic cross-sectional view showing the relationship between the surface of the intermediate transfer member 8 and the surface of the electrophotographic photosensitive member 1. “2×(1/Spc)” described in the formula (1) is a value corresponding to a particle size when a peak portion of roughness on the surface of the intermediate transfer member 8 is regarded as a particle. The relationship of the formula (1) is synonymous with the fact that the radius of curvature of the particle size DA of the electrophotographic photosensitive member 1 is less than the radius of curvature of the surface of the intermediate transfer member 8. When the formula (1) is satisfied as illustrated in FIG. 6A, the intermediate transfer member 8 can be regarded as being substantially smooth for the electrophotographic photosensitive member 1. Therefore, rubbing against the particles 106 in the surface layer 105 of the electrophotographic photosensitive member 1 by the intermediate transfer member 8 can be reduced, and the frictional force can be reduced over a long period of time.

On the other hand, as illustrated in FIG. 6B,

when DA>2×(1/Spc),
it is difficult to maintain the shape of the surface layer 105 of the electrophotographic photosensitive member 1 throughout the life. When a peak portion on the surface of the intermediate transfer member 8 applies stress to the particles 106 in the surface layer 105 of the electrophotographic photosensitive member 1 from the side surface of the particles 106 as indicated by the arrow in FIG. 6B, detachment of the particles 106 is likely to occur. As the particles 106 are detached more and more with use, the contact area between the electrophotographic photosensitive member 1 and the intermediate transfer member 8 increases, and the frictional force increases. As described above, when the particle size DA is 80 nm or more, the frictional force reducing effect can be obtained.

For the above reason, in the present invention, it is necessary to satisfy the formula (1) in order to maintain the effect of reducing the frictional force between the electrophotographic photosensitive member 1 and the intermediate transfer member 8 even in the latter half of the lifespan of the image forming apparatus 100.

When the grooves along the movement direction of the intermediate transfer member 8 are formed in the surface layer 8a as illustrated in FIG. 5, it is necessary that at least the arithmetic mean curvature Spc of portions 85 without the grooves satisfies the formula (1). This is because the portions 85 of the surface layer 8a without the grooves come into contact with the electrophotographic photosensitive member 1 and contributes to frictional force and durability.

### EXAMPLES

Hereinafter, a method of measuring each physical property of the electrophotographic photosensitive member 1 and the intermediate transfer member 8 according to the present invention, manufacturing examples, and experimental examples will be described.

### <Measurement of Physical Properties of Electrophotographic Photosensitive Member>

### <Method of Observing Laminated State of Particles Contained in Surface Layer of Electrophotographic Photosensitive Member and Measuring Particle Size Distribution>

The cross section of the electrophotographic photosensitive member 1 created in examples was observed. Whether the particles were laminated in a monolayer in the surface layer as shown in FIG. 2 or whether the particles were laminated in multilayers as shown in FIG. 3 was determined. Note that samples for which cross-section observation was performed was obtained by dividing the photosensitive member 1 into four equal parts in the longitudinal direction, and taking the samples at positions of ¼, ½, and ¾ of the length from the end by shifting the samples 120° in the circumferential direction. A sample piece of 5 mm square was cut out from the photosensitive member, and the surface layer was three-dimensionalized to 2 μm×2 μm×2 μm by Slice & View of FIB-SEM.

Slice & View conditions were as follows.

Analytical sample processing: FIB method

Processing and observation device: NVision40 from SII/Zeiss

Slice interval: 10 nm

### (Observation Conditions)

Acceleration voltage: 1.0 kV

Sample tilt: 54° WD: 5 mm

Detector: BSE detector

Aperture: 60 μm, high current

ABC: ON

Image resolution: 1.25 nm/pixel

The measurement environment is a temperature of 23° C. and a pressure of 1×10\hat{ }-4 Pa. As a processing and observation device, Strata400S (sample tilt: 52°) manufactured by FEI can also be used.

The analysis region is 2 μm long×2 μm wide, and information for each cross section is integrated to obtain the volume V per 2 μm long×2 μm wide×2 μm thick (8 μm3) on the surface of the surface layer. Further, image analysis for each cross section was performed using image processing software: Image-Pro Plus manufactured by Media Cybernetics.

The content of particles in the total volume of the surface layer was calculated from the difference in contrast of Slice & View of the FIB-SEM. In addition, the volume V of the particles of the present invention in a volume of 2 μm×2 μm×2 μm (unit volume: 8 μm3) was obtained in each of four sample pieces on the basis of the information obtained from image analysis, and the content [volume %] (=V μm3/8 μm3×100) of conductive particles was calculated. The average value of the contents of particles in each sample piece was taken as the content [volume %] of each particle of the present invention in the surface layer with respect to the total volume of the surface layer. The composition of the particles was determined using the SEM-EDX function.

In a particle size distribution in which the horizontal axis represents the particle size of the particles contained in the surface of the surface layer and the vertical axis represents the number-based frequency of each particle size, it is checked whether a plurality of peaks are present. In the particle size distribution, the particle size DA of the peak top of the peak PEA described above is calculated. Similarly, the particle size DB of the peak top of the peak PEB is calculated.

When particles having different compositions were present, the particles were discriminated using a mapping image by EDS. In addition, 100 points of protruded portions were measured, and the proportion of the protruded portions CA derived from the particle PAA was calculated. Furthermore, in the cross-sectional image of the surface layer, the average film thickness T of the surface layer was measured as shown in FIGS. 2 and 3.

### <Method of Measuring Average Value and Standard Deviation of Distances Between Centers of Gravity of Particles in Surface Layer of Electrophotographic Photosensitive Member>

In the electrophotographic photosensitive member 1 of the present invention, when the surface layer 105 is viewed from above, the average value and the standard deviation of the distances between the centers of gravity of the protruded portions CA derived from the particles PAA can be calculated as follows.

The surface of the surface layer 105 of the electrophotographic photosensitive member 1 was photographed at an acceleration voltage of 10 kV using a scanning electron microscope (SEM) (“S-4800” manufactured by JEOL Ltd.). A 30,000× magnification photographic image of the surface layer 105 of the electrophotographic photosensitive member 1 of the present invention was captured by a scanner at a total of 12 locations, including 50 mm from each end and three locations in the center portion in the longitudinal direction, and four locations at 90 degrees each in the circumferential direction. The particles PAA of the photographic image are binarized using an image processing analyzer (“LUZEX AP” manufactured by Nireco Corporation).

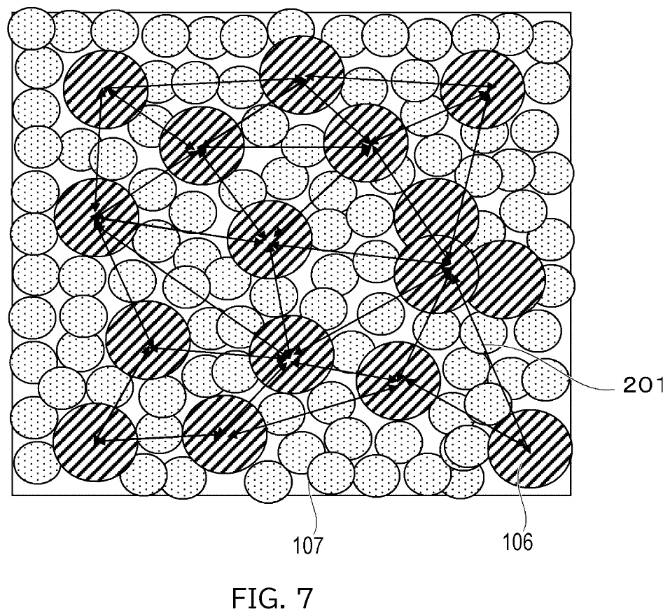

In the mode of the distance between the adjacent centers of gravity of the particles PAA, as illustrated in FIG. 7, the distances 201 between the centers of gravity of adjacent particles PAA is measured, and the average value of the distances between the centers of gravity is calculated. At this time, the distances between the centers of gravity are calculated by Voronoi division from the centers of gravity of the particles PAA. The distances between the centers of gravity and the standard deviation are calculated for a total of 10 fields of view, and the average value and the standard deviation of the obtained distances between the centers of gravity are defined as the average value and the standard deviation of the distances between the centers of gravity of particles in the surface layer of the photosensitive member.

### <Method of Measuring Coverage Ratio S1/(S1+S2) of Particles in Surface Layer of Electrophotographic Photosensitive Member>

In the electrophotographic photosensitive member 1 of the present invention, when the surface layer 105 is viewed from above, the coverage ratio S1/(S1+S2) can be calculated as follows, where the area of the particles PAA is S1 and the total area other than the particles PAA is S2.

The surface of the surface layer 105 of the electrophotographic photosensitive member 1 was photographed at an acceleration voltage of 10 kV using a scanning electron microscope (SEM) (“S-4800” manufactured by JEOL Ltd.). A 30,000× magnification photographic image of the surface layer 105 of the electrophotographic photosensitive member 1 of the present invention was captured by a scanner at a total of 12 locations, including 50 mm from each end and three locations in the center in the longitudinal direction, and four locations at 90 degrees each in the circumferential direction. The particles PAA of the photographic image are binarized using an image processing analyzer (“LUZEX AP” manufactured by Nireco Corporation).

The coverage ratio S1/(S1+S2) (%) is calculated with the area of the particles PAA as S1 and the total area other than the particles PAA as S2. The above-described coverage ratio is calculated for a total of 10 fields of view, and the average value of the obtained coverage ratios is taken as the coverage ratio of the particles in the surface layer 105 of the photosensitive member 1.

### <Method of Measuring Circularity of Particles PAA of Particles in Surface Layer of Electrophotographic Photosensitive Member>

The surface of the surface layer 105 of the electrophotographic photosensitive member 1 was photographed at an acceleration voltage of 10 kV using a scanning electron microscope (SEM) (“S-4800” manufactured by JEOL Ltd.). A 30,000× magnification photographic image of the surface layer 105 of the electrophotographic photosensitive member 1 of the present invention was captured by a scanner at a total of 12 locations, including 50 mm from each end and three locations in the center in the longitudinal direction, and four locations at 90 degrees each in the circumferential direction. Further, image processing is performed on the particles PAA of the photographic image using an image processing analyzer (“LUZEX AP” manufactured by Nireco Corporation), and the average value of circularities is calculated for a total of 10 fields of view to obtain the circularity of the particles PAA.

### <Measurement of Film Thickness of Each Layer>

The film thickness of each layer of the electrophotographic photosensitive members 1 of examples and comparative examples was obtained by a method using an eddy current type film thickness meter (Fischerscope, manufactured by Fischer Instruments) or a method of converting the specific gravity from the mass per unit area, except for the charge generation layer. The film thickness of the charge generation layer was measured by converting a Macbeth concentration value of the photosensitive member using a Macbeth concentration value measured by pressing a spectral densitometer (trade name: X-Rite504/508, manufactured by X-Rite) against the surface of the photosensitive member and a calibration curve previously acquired from a film thickness measurement value by cross-sectional SEM image observation.

### <Measurement of Arithmetic Mean Curvature Spc of Peak Point of Surface of Intermediate Transfer Member>

Specifically, the arithmetic mean curvature Spc of the peak point of the surface of the intermediate transfer member 8 can be measured as follows.

The surface of the intermediate transfer member 8 was measured using a laser microscope VK-X250 (manufactured by KEYENCE) in shape measurement mode at an objective lens magnification of 150 times. The intermediate transfer member of the present invention was measured at a total of 12 locations, including 50 mm from each end in the width direction (direction perpendicular to the rotation direction of the intermediate transfer member), three locations at the center portion, and four locations at equal intervals in the rotation direction. The measurement range per location is 70 μm×70 μm.

From the measured microscopic image, the arithmetic mean curvature of peak points was calculated in a surface roughness measurement mode using an analysis software (VK-H1XA) attached to the laser microscope VK-X250. The average value of the values at all 12 locations is defined as the arithmetic mean curvature Spc of the peak points on the surface of the intermediate transfer member 8.

In a case where grooves were formed on the surface of the intermediate transfer member 8, for each measurement location, only a location without a groove was analyzed, and the arithmetic mean curvature of the peak points was calculated.

### <Manufacturing of Electrophotographic Photosensitive Member>

A support, a conductive layer, an undercoat layer, a charge generation layer, a charge transport layer, and a surface layer were produced by the following methods.

### <Preparation of Conductive Layer Coating Liquid 1>

Anatase type titanium oxide having an average primary particle size of 200 nm was used as a substrate, and a titanium niobium sulfuric acid solution containing 33.7 parts of titanium in terms of TiO₂ and 2.9 parts of niobium in terms of Nb₂O₅ was prepared. 100 parts of the substrate was dispersed in pure water to form a suspension of 1000 parts, and the suspension was heated to 60° C. The titanium niobium sulfuric acid solution and 10 mol/L sodium hydroxide were added dropwise over 3 hours such that the pH of the suspension became 2 to 3. After the total amount was dropped, the pH was adjusted to near neutral, and a polyacrylamide flocculant was added to precipitate the solid content. The supernatant was removed, filtering and washing, and drying at 110° C. were performed to obtain an intermediate containing 0.1 wt % of an organic substance derived from the flocculant in terms of C. This intermediate was fired at 750° C. for 1 hour in nitrogen, and then fired at 450° C. in the air to produce titanium oxide particles. The obtained particles had an average primary particle size of 220 nm in a particle size measurement method using the scanning electron microscope described above.

Subsequently, 50 parts of a phenol resin (monomer/oligomer of phenol resin) (trade name: Plyophen J-325, manufactured by DIC Corporation, resin solid content: 60%, density after curing: 1.3 g/cm²) as a binding material was dissolved in 35 parts of 1-methoxy-2 propanol as a solvent to obtain a solution.

60 parts of titanium oxide particles 1 were added to this solution, and the resulting mixture was placed in a vertical Sandoz mill using 120 parts of glass beads having a number-average primary particle size of 1.0 mm as a dispersion medium and subjected to dispersion treatment for 4 hours under the conditions of a dispersion temperature of 23±3° C. and a rotation speed of 1500 rpm (peripheral speed of 5.5 m/s) to obtain a dispersion. The glass beads were removed from the dispersion with a mesh. 0.01 parts of silicone oil (trade name: SH28 PAINT ADDITIVE, manufactured by Dow Corning Toray Co., Ltd.) as a leveling agent and 8 parts of silicone resin particles (trade name: KMP-590, manufactured by Shin-Etsu Chemical Co., Ltd., average primary particle size: 2 μm, density: 1.3 g/cm³) as a surface roughness imparting agent were added to the dispersion from which the glass beads had been removed and stirred, and pressure-filtration was performed using a PTFE filter paper (trade name: PF060, Advantec Toyo Kaisha, Ltd.) to prepare a conductive layer coating liquid 1.

### <Preparation of Undercoat Layer Coating Liquid 1>

100 parts of rutile type titanium oxide particles (average primary particle size: 50 nm, manufactured by Tayca Corporation) were stirred and mixed with 500 parts of toluene, 3.5 parts of vinyltrimethoxysilane (trade name: KBM-1003, manufactured by Shin-Etsu Chemical Co., Ltd.) was added thereto, and the mixture was dispersed for 8 hours in a vertical Sandoz mill using glass beads having a diameter of 1.0 mm. After removing the glass beads, toluene was distilled off by distillation under reduced pressure and dried at 120° C. for 3 hours to obtain rutile type titanium oxide particles surface-treated with an organic silicon compound. When the volume of the obtained titanium oxide particles was a and the average primary particle size of the titanium oxide particles was b [μm], a/b=15.6 was obtained. The value of a was obtained from a microscopic image of a cross section of the electrophotographic photosensitive member using a field emission scanning electron microscope (FE-SEM, trade name: S-4800, manufactured by Hitachi High-Technologies Corporation) after production of the electrophotographic photosensitive member.

18.0 parts of the rutile type titanium oxide particles surface-treated with the organic silicon compound, 4.5 parts of N-methoxymethylated nylon (trade name: TORESIN EF-30T, manufactured by Nagase ChemteX Corporation), and 1.5 parts of a copolymerized nylon resin (trade name: Amilan CM8000, manufactured by Toray Industries, Inc.) were added to a mixed solvent of 90 parts of methanol and 60 parts of 1-butanol to prepare a dispersion.

This dispersion was dispersed for 5 hours with a vertical Sandoz mill using glass beads having a diameter of 1.0 mm, and the glass beads were removed to prepare an undercoat layer coating liquid 1.

### <Synthesis of Phthalocyanine Pigment>

### Synthesis Example 1

Under an atmosphere of a nitrogen flow, 100 g of gallium trichloride and 291 g of ortho-phthalonitrile were added to 1000 mL of α-chloronaphthalene, the mixture was reacted at a temperature of 200° C. for 24 hours, and then a product was filtered. The resulting wet cake was heated and stirred at a temperature of 150° C. for 30 minutes using N,N-dimethylformamide, and then filtered. The obtained filtered product was washed with methanol and then dried to obtain a chlorogallium phthalocyanine pigment at a yield of 83%.

20 g of the chlorogallium phthalocyanine pigment obtained by the above method was dissolved in 500 mL of concentrated sulfuric acid, stirred for 2 hours, and then added dropwise to a mixed solution of 1700 mL of ice-cooled distilled water and 660 mL of concentrated ammonia water to reprecipitate the chlorogallium phthalocyanine pigment. This was sufficiently washed with distilled water and dried to obtain a hydroxygallium phthalocyanine pigment.

### <Preparation of Charge Generation Layer Coating Liquid 1>

0.5 parts of the hydroxygallium phthalocyanine pigment obtained in Synthesis Example 1, 7.5 parts of N,N-dimethylformamide (product code: D0722, manufactured by Tokyo Chemical Industry Co., Ltd.), and 29 parts of glass beads having a diameter of 0.9 mm were subjected to milling treatment at a temperature of 25° C. for 24 hours using Sandoz Mill (BSG-20, manufactured by AIMEX corporation). At this time, the disc was rotated 1500 times per minute. The liquid thus treated was filtered through a filter (product number: N-NO. 125T, pore diameter: 133 μm, manufactured by NBC Meshtec Inc.) to remove the glass beads. After 30 parts of N,N-dimethylformamide was added to this liquid, the mixture was filtered, and the filtered product on the filter was sufficiently washed with n-butyl acetate. Then, the washed filtered product was vacuum-dried to obtain 0.45 parts of hydroxygallium phthalocyanine pigment. The obtained pigment contained N,N-dimethylformamide.

Subsequently, 20 parts of the hydroxygallium phthalocyanine pigment obtained through milling treatment, 10 parts of polyvinyl butyral (trade name: S-LEC BX-1, manufactured by Sekisui Chemical Co., Ltd.), 190 parts of cyclohexanone, and 482 parts of glass beads having a diameter of 0.9 mm were dispersed at a cooling water temperature of 18° C. for 4 hours using Sandoz Mill (K-800, manufactured by Igarashi Machinery Co., Ltd. (current Imex Corporation), disk diameter: 70 mm, number of disks: 5). At this time, the disc was rotated 1800 times per minute. The glass beads were removed from the dispersion, and 444 parts of cyclohexanone and 634 parts of ethyl acetate were added to prepare a charge generation layer coating liquid 1.

### <Preparation of Charge Transport Layer Coating Liquid 1>

### Production Example of Charge Transport Layer 1

Next, the following materials were prepared to produce a mixed solvent.
Orthoxylene: 25 parts by mass
Methyl benzoate: 25 parts by mass
Dimethoxymethane: 25 parts by mass

Further, the following materials were dissolved in the mixed solvent to prepare a charge transport layer coating liquid 1.
Charge transporting material (hole transporting material) represented by the following structural formula (C-1): 5 parts by mass
Charge transporting material (hole transporting material) represented by the following structural formula (C-2): 5 parts by mass
Polycarbonate (trade name: Iupilon Z400, manufactured by Mitsubishi Engineering-Plastics Corporation): 10 parts by mass

The charge transport layer coating liquid 1 was dip-coated on the charge generation layer 1 to form a coating film, and the coating film was dried at a drying temperature of 40° C. for 5 minutes to form the charge transport layer 1 having a film thickness of 15 μm.

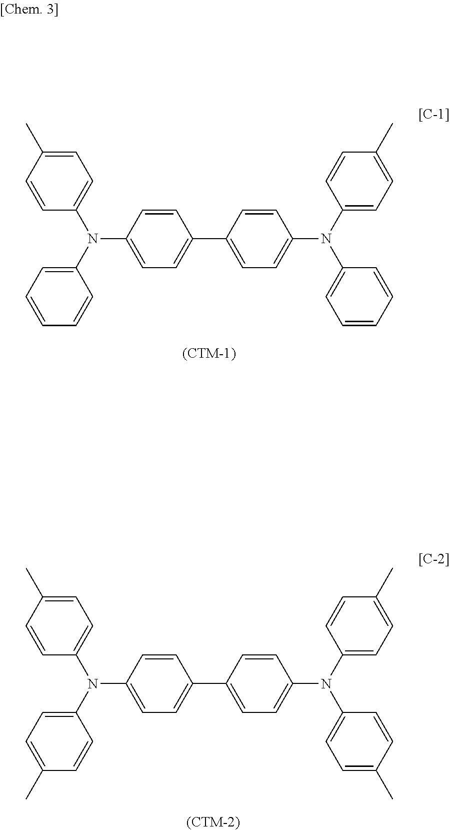

### Production Example 1 of Surface Layer Containing Particles

Materials of Table 1 as PAA particles and PAB particles were prepared.

TABLE 1

| | | | Average |
|---|---|---|---|
| | | | primary |
| | Product | | particle |
| Particle | name | Manufacturer | size [nm] |
| 1 | QSG-170 | Shin-Etsu Chemical Co., Ltd. | 170 |
| 2 | QSG-80 | Shin-Etsu Chemical Co., Ltd. | 80 |
| 3 | QSG-30 | Shin-Etsu Chemical Co., Ltd. | 30 |
| 4 | QSG-100 | Shin-Etsu Chemical Co., Ltd. | 100 |
| 5 | QSG-10 | Shin-Etsu Chemical Co., Ltd. | 10 |
| 6 | KE-P30 | NIPPON SHOKUBAI CO., LTD. | 300 |
| 7 | KE-P50 | NIPPON SHOKUBAI CO., LTD. | 500 |
| 8 | Hydrotalcite | Kyowa Chemical Ind. Co., Ltd. | 250 |

### <Preparation of Surface Layer Coating Liquid 1>

PAA particles: Silica particles (“QSG-170” manufactured by Shin-Etsu Chemical Co., Ltd.): 2.5 parts by mass

PAB particles: Silica particles (“QSG-80” manufactured by Shin-Etsu Chemical Co., Ltd.): 2.5 parts by mass

Monomer 1 having a polymerizable functional group (the structural formula (2-1)): 0.75 parts by mass

Monomer 2 having a polymerizable functional group (the structural formula (3-1)): 0.75 parts by mass

Siloxane-modified acrylic compound (trade name: SYMAC US270, manufactured by Toagosei Co., Ltd.): 0.1 parts by mass 1-propanol: 100.0 parts by mass

Cyclohexane: 100.0 parts by mass
are mixed and stirred for 6 hours in a stirring device to prepare the surface layer coating liquid 1.

### <Preparation of Surface Layer Coating Liquids 2 to 25>

The surface layer coating liquids 2 to 25 were prepared in the same manner as in preparation of the surface layer coating liquid 1 except that the types and amounts of the particles PAA, the particles PAB, and other particles added were changed as shown in Table 2.

TABLE 2

| | Mono- | Mono- | | | | | | | | | |
|---|---|---|---|---|---|---|---|---|---|---|---|
| | mer 1 | mer 2 | Particle PAA | | | Particle PAB | | | Other particles | | |
| Coating | Amount | Amount | Particle | Specific | Amount | Particle | Specific | Amount | Particle | Specific | Amount |
| liquid | added | added | type | gravity | added | type | gravity | added | type | gravity | added |
| 1 | 0.75 | 0.75 | 1 | 1.8 | 2.5 | 2 | 1.8 | 2.5 | — | — | — |
| 2 | 0.75 | 0.75 | 1 | 1.8 | 4.2 | 2 | 1.8 | 0.8 | — | — | — |
| 3 | 0.75 | 0.75 | 1 | 1.8 | 0.8 | 2 | 1.8 | 4.2 | — | — | — |
| 4 | 0.75 | 0.75 | 1 | 1.8 | 1.5 | 2 | 1.8 | 1.5 | — | — | — |
| 6 | 1.25 | 1.25 | 1 | 1.8 | 2.5 | 2 | 1.8 | 2.5 | — | — | — |
| 6 | 0.75 | 0.75 | 1 | 1.8 | 2.5 | 2 | 1.8 | 2.5 | 7 | 1.8 | 0.2 |
| 7 | 0.75 | 0.75 | 8 | 2.0 | 5.0 | 2 | 1.8 | 2.5 | — | — | — |
| 8 | 0.75 | 0.75 | 4 | 1.8 | 2.5 | 3 | 1.8 | 2.5 | — | — | — |
| 9 | 0.75 | 0.75 | 6 | 1.8 | 2.5 | 5 | 1.8 | 2.5 | — | — | — |
| 10 | 0.75 | 0.75 | 1 | 1.8 | 2.5 | 2 | 1.8 | 2.5 | — | — | — |
| 11 | 0.75 | 0.75 | 1 | 1.8 | 4.2 | 2 | 1.8 | 0.8 | — | — | — |
| 12 | 0.75 | 0.75 | 1 | 1.8 | 0.8 | 2 | 1.8 | 4.2 | — | — | — |
| 13 | 2.50 | 2.50 | 1 | 1.8 | 5.0 | 2 | 1.8 | 5.0 | — | — | — |
| 14 | 1.50 | 1.50 | 1 | 1.8 | 5.0 | 5 | 1.8 | 5.0 | — | — | — |
| 15 | 1.50 | 1.50 | 8 | 2.0 | 10.0 | 2 | 1.8 | 5.0 | — | — | — |
| 16 | 1.50 | 1.50 | 4 | 1.8 | 10.0 | 3 | 1.8 | 5.0 | — | — | — |
| 17 | 1.50 | 1.50 | 6 | 1.8 | 5.0 | 5 | 1.8 | 5.0 | — | — | — |
| 18 | 0.75 | 0.75 | 1 | 1.8 | 0.4 | 2 | 1.8 | 4.6 | — | — | — |
| 19 | 0.75 | 0.75 | 1 | 1.8 | 10.0 | 2 | 1.8 | 1.2 | — | — | — |
| 20 | 1.50 | 1.50 | 1 | 1.8 | 8.0 | 2 | 1.8 | 8.0 | — | — | — |
| 21 | 0.75 | 0.75 | 1 | 1.8 | 2.5 | 9 | 1.8 | 2.5 | 7 | 1.8 | 5.0 |
| 22 | 0.75 | 0.75 | 3 | 1.8 | 3.6 | 5 | 1.8 | 5.0 | — | — | — |
| 23 | 0.75 | 0.75 | 1 | 1.8 | 1.0 | 2 | 1.8 | 1.0 | — | — | — |
| 24 | 1.50 | 1.50 | 1 | 1.8 | 2.5 | 2 | 1.8 | 2.6 | 7 | 1.8 | 2.5 |
| 25 | 1.50 | 1.50 | 3 | 1.8 | 3.6 | 5 | 1.8 | 5.0 | — | — | — |

In the tale, “Coating liquid” means “Surface layer coating liquid”. “Monomer 1/Monomer 2” means “Monomer 1 having polymerizable functional group/Monomer 2 having polymerizable functional group”.

### Production Example of Electrophotographic Photosensitive Member 1

### <Support>

An aluminum cylinder having a diameter of 24 mm and a length of 257 mm was used as a support (cylindrical support).

### <Conductive Layer>

The conductive layer coating liquid 1 was dip-coated on the support to form a coating film, and the coating film was heated and cured at 150° C. for 30 minutes to form a conductive layer having a film thickness of 22 μm.

### <Undercoat Layer>

The undercoat layer coating liquid 1 was dip-coated on the above-described conductive layer to form a coating film, and the coating film was heated at 100° C. for 10 minutes and cured to form an undercoat layer having a film thickness of 1.8 μm.

### <Charge Generation Layer>

The charge generation layer coating liquid 1 was dip-coated on the above-described undercoat layer to form a coating film, and the coating film was heated and dried at a temperature of 100° C. for 10 minutes to form a charge generation layer having a film thickness of 0.20 μm.

### <Charge Transport Layer>

The charge transport layer coating liquid 1 was dip-coated on the above-described charge generation layer to form a coating film, and the coating film was heated and dried at a temperature of 120° C. for 30 minutes to form a charge transport layer having a film thickness of 21 μm.

### <Surface Layer>

The surface layer coating liquid 1 was dip-coated on the charge transport layer to form a coating film, and the coating film was heated at a temperature of 50° C. for 5 minutes. Thereafter, under a nitrogen atmosphere, the coating film was irradiated with an electron beam for 2.0 seconds while rotating the support (irradiated body) at a speed of 300 rpm under the conditions of an acceleration voltage of 65 kV and a beam current of 5.0 mA. The dose was 15 kGy. Thereafter, the temperature of the coating film was raised to 120° C. under a nitrogen atmosphere. The oxygen concentration from electron beam irradiation to the subsequent heat treatment was 10 ppm.

Next, the coating film was naturally cooled until the temperature of the coating film reached 25° C. in the air, and then subjected to heat treatment for 30 minutes under the condition that the temperature of the coating film reached 120° C., thereby forming a surface layer having a film thickness of 1.0 μm. Physical properties of the obtained electrophotographic photosensitive member are shown in Table 3.

### Production Example of Electrophotographic Photosensitive Members 2 to 25

Electrophotographic photosensitive members 2 to 25 were produced in the same manner as in production of the electrophotographic photosensitive member 1 except that the surface layer coating liquid 1 was changed as per the conditions in Table 2 in the production of the electrophotographic photosensitive member 1. Physical properties of the obtained electrophotographic photosensitive members 2 to 25 are shown in Table 3.

TABLE 3

| | | | | | | | | | PAB- | Ratio | | | Rate of |
|---|---|---|---|---|---|---|---|---|---|---|---|---|---|
| | | | PAA- | Average | | | Average | | peak | of | Half- | | particle |
| | Coat- | | peak | distance | SD | | thick- | | top | pro- | value | Circu- | in |
| EP | ing | Lamina- | top | between | between | S1/ | ness | DB/ | DB | truded | width | larity | Surface |
| No. | liquid | state | DA[nm] | CA [nm] | CA [nm] | S1 + S2 | T[nm] | DA | [nm] | portion | PAA | of PAA | [vol %) |
| 1 | 1 | Mono | 170 | 200 | 100 | 0.90 | 100 | 0.47 | 80 | 96 | 30 | 0.98 | 65% |
| 2 | 2 | Mono | 170 | 170 | 85 | 0.90 | 100 | 0.47 | 80 | 95 | 30 | 0.98 | 65% |
| 3 | 3 | Mono | 170 | 480 | 240 | 0.90 | 100 | 0.47 | 80 | 95 | 30 | 0.98 | 65% |
| 4 | 4 | Mono | 170 | 320 | 160 | 0.73 | 100 | 0.47 | 80 | 95 | 30 | 0.98 | 53% |
| 5 | 5 | Mono | 170 | 250 | 125 | 0.73 | 167 | 0.47 | 80 | 95 | 30 | 0.98 | 53% |
| 6 | 6 | Mono | 170 | 350 | 175 | 0.90 | 100 | 0.47 | 80 | 94 | 30 | 0.98 | 65% |
| 7 | 7 | Mono | 250 | 450 | 225 | 1.00 | 100 | 0.32 | 80 | 95 | 60 | 0.85 | 72% |
| 8 | 8 | Mono | 100 | 250 | 125 | 0.90 | 100 | 0.30 | 30 | 95 | 18 | 0.98 | 65% |
| 9 | 9 | Mono | 300 | 350 | 175 | 0.90 | 100 | 0.03 | 10 | 97 | 53 | 0.98 | 65% |
| 10 | 10 | Multi | 170 | 200 | 100 | 1.00 | 100 | 0.47 | 80 | 95 | 30 | 0.98 | 65% |
| 11 | 11 | Multi | 170 | 170 | 85 | 1.00 | 100 | 0.47 | 80 | 96 | 30 | 0.98 | 65% |
| 12 | 12 | Muiti | 170 | 480 | 240 | 1.00 | 100 | 0.47 | 89 | 94 | 30 | 0.98 | 65% |
| 13 | 13 | Multi | 170 | 250 | 125 | 1.00 | 333 | 0.47 | 80 | 94 | 30 | 0.98 | 53% |
| 14 | 14 | Multi | 170 | 200 | 100 | 1.00 | 200 | 0.06 | 10 | 93 | 30 | 0.98 | 65% |
| 15 | 15 | Muiti | 250 | 450 | 225 | 1.00 | 200 | 0.32 | 80 | 95 | 60 | 0.85 | 72% |
| 16 | 16 | Multi | 100 | 250 | 125 | 1.00 | 200 | 9.30 | 30 | 94 | 18 | 0.98 | 74% |
| 17 | 17 | Multi | 300 | 350 | 175 | 1.00 | 200 | 0.03 | 10 | 94 | 53 | 0.98 | 65% |
| 18 | 18 | Monc | 170 | 560 | 275 | 0.90 | 100 | 0.47 | 80 | 95 | 30 | 0.98 | 65% |
| 19 | 19 | Mono | 170 | 350 | 175 | 0.59 | 100 | 0.47 | 80 | 94 | 30 | 0.98 | 66% |
| 20 | 20 | Multi | 170 | 550 | 276 | 1.00 | 200 | 0.47 | 80 | 94 | 30 | 0.98 | 6595 |
| 21 | 21 | Mono | 500 | 560 | 165 | 0.90 | 100 | 0.16 | 80 | 94 | 88 | 0.98 | 65% |
| 22 | 22 | Mono | 30 | 55 | 165 | 0.91 | 100 | 0.33 | 10 | 94 | 5 | 0.98 | 65% |
| 23 | 23 | Mono | 170 | 600 | 300 | 0.59 | 100 | 0.47 | 80 | 80 | 30 | 0.98 | 43% |
| 24 | 24 | Multi | 500 | 550 | 165 | 1.00 | 200 | 0.16 | 80 | 95 | 88 | 0.98 | 48% |
| 25 | 25 | Multi | 30 | 550 | 165 | 1.00 | 200 | 0.33 | 10 | 94 | 5 | 0.98 | 72% |

In the table 3, “EP No.” means “Electrophotographic photosensitive member”. “Coating liquid” means “Surface layer coating liquid used for production”. “Lamina-state” means “Laminated state of cross-sectional observation”. “PAA-peak top DA[nm]” means “Particle size DA of peak top of PAA”. “Average distance between CA [nm]” means “Average value of distances between centers of protruded portions CA”. “SD between CA [nm]” means “Standard deviation of distances between centers of protruded portions CA”. “Average thickness T[nm]” means “Average film thickness”. “PAB-peak top DB[nm]” means “Particle size DB of peak top of PAB”. “Ratio of protruded portion” means “Ratio of number of protruded portions derived from particles PAA to number of protruded portions CA”. “Half-value width PAA” means “Half-value width PAA distribution”. “Circularity of PAA” means “Circularity of particles PAA”. “Rate of particle in surface [vol %]” means “Content rate of particle contained in surface layer [vol%]”. “Mono” means “Monolayer”. “Multi” means “Multilayer”.

### <Manufacturing of Intermediate Transfer Member>

### Production Example of Intermediate Transfer Member 1

### <Production of Base Layer>

A polyethylene naphthalate resin (PEN) in which carbon black as an electric resistance regulator was dispersed was stretched and blown to obtain a bottle-shaped molded body. The bottle-shaped molded body was cut using an ultrasonic cutter to form an endless belt shape. The endless belt having a thickness of 60 μm made of the PEN resin, obtained in this manner was used as a base layer of the intermediate transfer member 1.

### <Preparation of Coating Liquid for Surface Layer Formation>

In a container shielded from ultraviolet rays, 50 parts of PTFE particles (Lubron L-2: manufactured by Daikin Industries, Ltd.) having a primary particle size of 200 nm, 100 parts of an unsaturated double bond-containing acrylic copolymer (Opster Z7501: manufactured by JSR Corporation), and 25 parts of a zinc antimonate particle-containing isopropanol sol (Cellnax CX-Z210IP: manufactured by Nissan Chemical Industries, Ltd.) were mixed. The mixed liquid was dispersed and mixed by a high pressure emulsifying disperser to prepare an ultraviolet curable resin composition, and the ultraviolet curable resin composition was used as a coating liquid for surface layer formation.

### <Production of Surface Layer>

The coating liquid for surface layer formation was dip-coated on the base layer produced above in a coating environment at a temperature of 25° C. and a humidity of 60% RH. After 10 seconds from completion of coating, the coating film of the coating liquid for surface layer formation was irradiated with ultraviolet rays using an ultraviolet irradiation device (trade name: UE06/81-3, manufactured by Eye Graphics Co., Ltd., integrated light amount: 1000 mJ/cm2) in the same environment to cure the unsaturated double bond-containing acrylic copolymer. In this manner, the intermediate transfer member 1 in which the surface layer mainly composed of the cured acrylic resin having a thickness of 0.5 μm was formed on the base layer was obtained. The volume resistivity of the intermediate transfer member 1 is 1.0×10¹⁰ Ω·cm. The circumferential length was 712 mm, and the width was 248 mm.

### <Production of Intermediate Transfer Members 2 to 4>

Intermediate transfer members 2 and 3 were obtained in the same manner as in the intermediate transfer member 1 except that the surface roughness was changed by changing the blending amount of the PTFE particles contained in the coating liquid for surface layer formation as shown in Table 4 in preparation of the surface layer of the intermediate transfer member 1.

The intermediate transfer member 1 was imprinted to obtain an intermediate transfer member 4 in which grooves along a movement direction of the intermediate transfer member was formed.

Table 4 shows the values of the arithmetic mean curvature Spc of peak points of the intermediate transfer members 1 to 4.

TABLE 4

| Intermediate | | | | Arithmetic mean |
|---|---|---|---|---|
| transfer | PTFE | | | curvature Sp cof |
| member No. | particle | | Groove | peak point [1/mm] |
| 1 | 50 | parts | Absence | 5550 |
| 2 | 65 | parts | Absence | 7000 |
| 3 | 0 | parts | Absence | 33500 |
| 4 | 50 | parts | Presence | 5550 |

### Effects of Present Example

In order to show the effects of the present example, evaluation was performed under the following conditions.

In an environment of a temperature of 25° C. and a humidity of 60% RH, XEROX Vitality paper (manufactured by XEROX Corporation, basis weight: 75 g/m²) having a LETTER size was used as the transfer material S in the image forming apparatus 100. The conveying speed of the transfer material S was 300 mm/see, the peripheral speed of the intermediate transfer member 8 was 300 mm/see, and the peripheral speed of the electrophotographic photosensitive member 1 was 291 mm/sec. That is, the peripheral speed difference between the intermediate transfer member 8 and the electrophotographic photosensitive member 1 was set to 3%. In addition, as evaluation of image blurring, an image of a cyan halftone (toner applied amount: 0.2 mg/cm²) was printed out, and image blurring was confirmed. Note that the electrophotographic photosensitive members 1 in all the process cartridges of yellow, magenta, cyan, and black were the same.

In order to confirm image blurring in the latter half of the lifespan of the image forming apparatus 100, 200,000 sheets of full-color 1.0% images were subjected to a sheet passing durability test. The temperature and humidity, the type of the transfer material S, and various speeds were set to be the same as the evaluation conditions of image blurring. After 10,000 sheets of paper passed, a halftone cyan image was printed out, and image blurring was confirmed. Up to the evaluation criteria B is a practically acceptable level.

### (Evaluation Criteria)

A: No occurrence of image blurring
B: Extremely slight image blurring occurs.
C: Image blurring that can be clearly visually recognized occurs.

Table 5 shows examples in which image blurring at the initial stage and after durability (after passing 10,000 sheets of paper) was evaluated, and Table 6 shows results of comparative examples.

In examples 1 to 24, for the reasons described above, occurrence of image blurring was curbed both at the initial stage and after durability test. In comparative examples 1, 3, 4, and 6 to 10, there was no problem in initial image blurring, but after durability test, image blurring occurred due to detachment of particles on the electrophotographic photosensitive member. In addition, in comparative examples 2 and 5, since the particle size DA in the electrophotographic photosensitive member was small, a sufficient friction reducing effect was not obtained, and image blurring occurred from the beginning.

TABLE 5

| | | | Particle | | Initial | Image |
|---|---|---|---|---|---|---|
| Exam- | EP | IT | size | 2 × 1/Spc | Image | blurring |
| ple | No. | No. | DA [nm] | [nm] | blurring | after durability |
| 1 | 1 | 1 | 170 | 360 | A | A |
| 2 | 2 | 1 | 170 | 360 | A | A |
| 3 | 3 | 1 | 170 | 360 | A | A |
| 4 | 4 | 1 | 170 | 360 | A | A |
| 5 | 5 | 1 | 170 | 360 | A | A |
| 6 | 6 | 1 | 170 | 360 | A | A |
| 7 | 7 | 1 | 250 | 360 | B | B |
| 8 | 8 | 1 | 100 | 360 | A | A |
| 9 | 9 | 1 | 300 | 360 | A | A |
| 10 | 10 | 1 | 170 | 360 | A | A |
| 11 | 11 | 1 | 170 | 360 | A | A |
| 12 | 12 | 1 | 170 | 360 | A | A |
| 13 | 13 | 1 | 170 | 360 | A | A |
| 14 | 14 | 1 | 170 | 360 | A | A |
| 15 | 15 | 1 | 250 | 360 | B | B |
| 16 | 16 | 1 | 100 | 360 | A | A |
| 17 | 17 | 1 | 300 | 360 | A | A |
| 18 | 18 | 1 | 170 | 360 | B | B |
| 19 | 19 | 1 | 170 | 360 | A | B |
| 20 | 20 | 1 | 170 | 360 | B | B |
| 21 | 1 | 2 | 170 | 286 | A | A |
| 22 | 16 | 2 | 100 | 286 | A | A |
| 23 | 1 | 4 | 170 | 360 | A | A |
| 24 | 17 | 4 | 300 | 360 | A | A |

In the table, “EP No.” means “Electrophotographic photosensitive member”. “IT No.” means “Intermediate transfer member. “Particle size DA [nm]” means “<Electrophotographic photosensitive member> Particle size”. “2 × 1/Spc [nm]” means “<Intermediate transfer member> 2 × 1/Spc”.

TABLE 6

| Compar- | | | Particle | 2 × 1/ | Initial | Image |
|---|---|---|---|---|---|---|
| ative | EP | IT | size | Spc | image | blurring |
| example | No. | No. | DA [nm] | [nm] | blurring | after durability |
| 1 | 21 | 1 | 500 | 360 | B | C |
| 2 | 22 | 1 | 30 | 360 | C | C |
| 3 | 23 | 1 | 170 | 360 | B | C |
| 4 | 24 | 1 | 500 | 360 | B | C |
| 5 | 25 | 1 | 30 | 360 | C | C |
| 6 | 9 | 2 | 300 | 286 | A | C |
| 7 | 17 | 2 | 300 | 286 | A | C |
| 8 | 21 | 4 | 500 | 360 | B | C |
| 9 | 1 | 3 | 170 | 60 | A | C |
| 10 | 8 | 3 | 100 | 60 | A | C |

In the table, “EP No.” means “Electrophotographic photosensitive member”. “IT No.” means “Intermediate transfer member. “Particle size DA [nm]” means “<Electrophotographic photosensitive member> Particle size”. “2 × 1/Spc [nm]” means “<Intermediate transfer member> 2 × 1/Spc”.

As described above, according to the present invention, the effect of reducing the frictional force between the electrophotographic photosensitive member and the intermediate transfer member can be maintained even in the latter half of the lifespan of the image forming apparatus, and occurrence of image blurring can be curbed.

In the present example, a so-called drum cleaner-less system without having a primary transfer residual toner cleaning means as shown in FIG. 1 is used, but a primary transfer residual toner cleaning means may be provided. For example, the effects of the present invention can also be obtained by a so-called blade cleaning system in which a rubber blade is brought into contact with an electrophotographic photosensitive member to collect primary transfer residual toner.

Hereinafter, preferred examples of the present invention will be exemplarily described in detail with reference to the drawings. However, the dimensions, materials, shapes, relative arrangements, and the like of the components described in the following examples should be appropriately changed according to the configuration of an apparatus to which the present invention is applied and various conditions. Therefore, the scope of the present invention is not limited unless otherwise specified. Although a plurality of features are described in the examples, all of the plurality of features are not necessarily essential to the invention, and the plurality of features may be arbitrarily combined.

### (Configuration of Image Forming Apparatus)

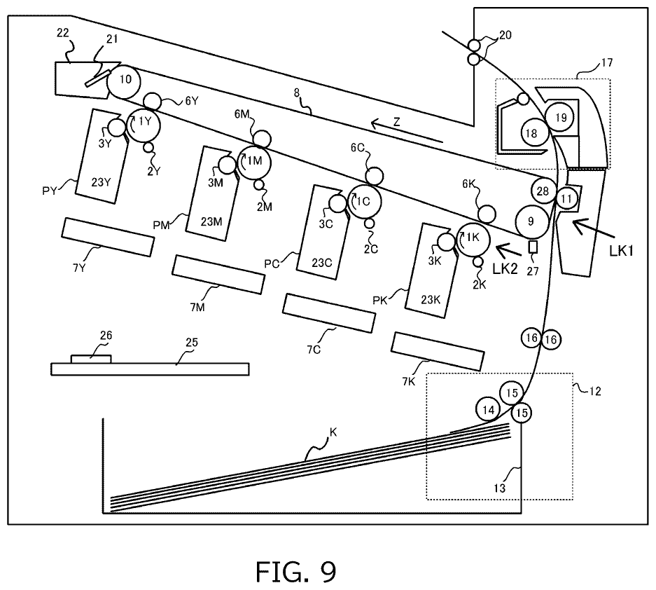

FIG. 9 is a schematic configuration diagram of an image forming apparatus equipped with process cartridges of the present example and illustrates a cross section from the front of the image forming apparatus. In the following description, letters YMCK provided at the ends of reference numerals indicate toner colors, and matters common to the four colors will be omitted. As the image forming apparatus, a laser beam printer of a legal-sized paper compatible electrophotographic process type capable of forming an image at a process speed of 210 mm/s and 600 dpi was used.

The image forming apparatus illustrated in FIG. 9 includes detachable process cartridges P. These four process cartridges P have the same structure. The difference is that an image is formed by toners of colors of toner contained in the process cartridges, that is, yellow (Y), magenta (M), cyan (C), and black (K). Hereinafter, the content common to the respective colors is denoted by subscripts representing the colors, and individual descriptions thereof will be omitted. For example, when process cartridges of respective colors are distinguished, the process cartridges are referred to as a process cartridge PY, a process cartridge PM, a process cartridge PC, and a process cartridge PK, and a process cartridge P will be simply described for description common to the respective colors.

The process cartridge P includes a toner container 23. The image forming apparatus further includes a photosensitive drum 1 as an image carrier. The image forming apparatus further includes a charging roller 2 and a developing roller 3. The photosensitive drum 1 is a cylindrical body in which a plurality of functional layers having a width (hereinafter referred to as a longitudinal length) of 255 mm and a diameter of 24 mm in a cylindrical axial direction (depth direction in FIG. 9) are formed. The configuration of the photosensitive drum 1 will be described later in detail. The axial direction of the photosensitive drum 1 is a longitudinal direction. The longitudinal direction is an axial direction common to each member such as the photosensitive drum 1, the charging roller 2, the developing roller 3, and a primary transfer roller 6, and a plurality of stretching rollers such as a driving roller 9, a tension roller 10, and a counter roller 28.

The charging roller 2 is a rubber roller having a longitudinal width of 230 mm and a diameter of 8 mm, in which conductive rubber is formed on a plated free-cutting steel shaft. The charging roller 2 is pressed against the photosensitive drum 1 with a predetermined pressure to form a charging nip, and is rotated in accordance with the rotation of the photosensitive drum.

The developing roller 3 is a rubber roller having a longitudinal width of 235 mm and a diameter of 12 mm, in which conductive rubber is formed on a plated free-cutting steel shaft. The developing roller 3 is pressed against the photosensitive drum 1 with a predetermined pressure to form a developing nip with a penetration amount of slightly less than 0.1 mm. The developing roller 3 is driven by a driving means (not illustrated) to be rotatable at a speed higher than that of the photosensitive drum.

A laser unit 7 is disposed below the process cartridge P, and performs exposure based on an image signal on the photosensitive drum 1. The photosensitive drum 1 is charged to a dark portion potential (Vd) of a predetermined negative polarity by applying a voltage of a predetermined negative polarity to the charging roller 2. The laser unit 7 emits a laser beam in an image forming portion on the basis of the image signal, the potential decreases in the exposed portion of the photosensitive drum 1, and an electrostatic latent image having a predetermined bright portion potential (Vl) is formed. By applying a predetermined negative voltage (Vdc) to the developing roller 3 and providing an appropriate potential difference between the Vd portion and the Vl portion, when the electrostatic latent image passes through the developing nip, the toner on the developing roller 3 is transferred only to the Vl portion, and the electrostatic latent image is visualized. The difference between Vdc and Vl is referred to as development contrast, and the amount of toner developed from the developing roller 3 to the photosensitive drum 1 can be controlled by this potential difference. The difference between Vd and Vdc is referred to as back contrast, and the primary transfer residual toner is collected from the photosensitive drum 1 to the developing roller 3 by this potential difference. The present example adopts setting in which the development contrast and the back contrast are 200 V by setting Vd=−550 V, Vl=−150 V, and Vdc=−350 V.

The toner used in the present example is formed by externally adding silica fine particles having an average particle size of 20 nm to toner particle having an average particle size of 6.4 μm, and is negatively charged. The average particle size is an average particle size obtained from a particle volume, which can be measured by, for example, a Coulter method.

An intermediate transfer belt unit includes an intermediate transfer belt 8 that is an endless transfer belt, and the driving roller 9, the tension roller 10, and the counter roller 28 as stretching rollers.

The intermediate transfer belt 8 is an endless belt having a longitudinal width of 250 mm and a circumferential length of 712 mm and made of two layers of resin materials in which a base layer having a thickness of 60 μm is coated with a resin surface layer having a thickness of 2 μm. The intermediate transfer belt 8 is stretched around three axes of the driving roller 9 having a diameter of 24 mm, the tension roller 10 having a diameter of 24 mm, and the counter roller 28 having a diameter of 16 mm, and stretched by the tension roller 10 with tension of a total pressure of 100 N.

The base layer of the intermediate transfer belt 8 is a seamless belt-shaped layer obtained by adding an ion conductive agent as a conductive agent to a polyethylene naphthalate resin (PEN) and a polyether ester amide (PEEA) and extruding the resulting mixture. Although the PEN and PEEA resins were used as the materials of the base layer, other materials may be used as long as the materials are thermoplastic resins, and for example, materials such as polyester, polycarbonate, polyarylate, polyether ether ketone (PEEK), an acrylonitrile-butadiene-styrene copolymer (ABS), polyphenylene sulfide (PPS), and polyvinylidene fluoride (PVdF), and mixed resins thereof may be used. As an ion conductive material as the conductive agent, an alkali metal salt was used.

The surface layer of the intermediate transfer belt 8 is an acrylic resin layer obtained by dip-coating a base layer with a curable composition in which a polyfunctional acrylic monomer, a photopolymerization initiator, and conductive metal oxide particles are dissolved and dispersed in a solvent, and irradiating the base layer with ultraviolet rays. As a method of coating the surface layer, other methods may be adopted as long as a uniform film can be formed, and spray coating, flow coating, shower coating, roll coating, spin coating, and the like may be adopted.

The primary transfer roller 6 as a primary transfer member (transfer member) is disposed inside of the intermediate transfer belt 8, that is, on the inner circumferential side of the transfer belt to face the photosensitive drum 1, and a transfer voltage is applied by a voltage applying means (not illustrated). The primary transfer roller 6 is a plated free-cutting steel shaft having a diameter of 6 mm, and the intermediate transfer belt 8 is pressed up against the photosensitive drum 1 at a contact pressure of 5 N to form a primary transfer nip. In order to stably form the primary transfer nip shape, it is desirable that the primary transfer roller 6 be disposed to be offset toward the downstream side in the rotation direction of the intermediate transfer belt with respect to the center position of the photosensitive drum 1. In this configuration, the intermediate transfer belt 8 is shifted about 2 mm downstream such that the intermediate transfer belt 8 can be stably wound around the photosensitive drum 1 with a width of about 0.8 mm.

An optical sensor 27 is disposed at each position of 100 mm on both sides from the center of the longitudinal width of the intermediate transfer belt, and is configured to detect a calibration patch, which is a test image, formed on the intermediate transfer belt 8 with the driving roller 9 as an opposing member.

The toner image formed on the photosensitive drum 1 is primarily transferred onto the intermediate transfer belt 8 by rotating each photosensitive drum in the arrow direction, rotating the intermediate transfer belt 8 in the direction of the arrow Z by an intermediate transfer belt driving means (not illustrated), and further applying a positive voltage to the primary transfer roller 6. Toner images are sequentially primarily transferred onto the intermediate transfer belt 8 from the toner image on the photosensitive drum 1Y, and are conveyed to a secondary transfer part (secondary transfer nip) formed by the secondary transfer roller 11 and the counter roller 28, which are secondary transfer members, in a state where toner images of four colors overlap.

The feeding and conveying device 12 includes a feeding roller 14 that feeds a recording material K from a feeding cassette 13 in which the recording material K is stored, and a pair of conveying rollers 15 that conveys the fed recording material K. Then, the recording material K conveyed from the feeding and conveying device 12 is conveyed to the secondary transfer part by a pair of registration rollers 16.

In order to transfer the toner image from the intermediate transfer belt 8 to the recording material K, a positive voltage is applied to the secondary transfer roller 11. As a result, the toner image on the intermediate transfer belt 8 can be secondarily transferred to the conveyed recording material K. The recording material K to which the toner image has been transferred is conveyed to a fixing device 17, and is heated and pressed by a fixing film 18 and a pressure roller 19 to fix the toner image on the surface. The fixed recording material K is ejected by the pair of ejection rollers 20.

After the toner image is transferred to the recording material K, the primary transfer residual toner remaining on the surface of the photosensitive drum 1 is electrostatically collected in a development nip portion. The primary transfer residual toner has a negative polarity, and in the charging nip, the charging roller surface potential has a negative potential higher than the drum surface potential, and thus the primary transfer residual toner remains on the drum surface. On the other hand, at the developing nip, due to the back contrast between Vd and Vdc, the toner is transferred from the photosensitive drum 1 having a high potential to the developing roller 3 having a low potential, and the primary transfer residual toner is collected. In the present example, a so-called cleaner-less system which does not include a cleaning means for removing the primary transfer residual toner on the photosensitive drum with a blade or the like is adopted.

Further, the secondary transfer residual toner is mechanically scraped off by the secondary cleaning blade 21 as a cleaning member after the intermediate transfer belt 8 rotates in the direction of the arrow Z, and is collected into a waste toner collection container 22. As the secondary cleaning blade 21, a galvanized steel plate having a thickness of 3 mm to which a urethane rubber blade having a thickness of 2 mm and 77 degrees in accordance with JIS K 6253 standards has been attached is used, and the galvanized steel plate is pressed against the tension roller 10 via the intermediate transfer belt 8 in the counter direction at a pressing force of about 0.49 N/cm in linear pressure and about 11.3 N in total pressure.

In addition, a control board 25 is a board on which an electric circuit for controlling the image forming apparatus is mounted and on which a CPU 26 as a control unit is mounted. The CPU 26 collectively controls operations of the image forming apparatus, such as control of an intermediate transfer belt drive motor which is a drive source of the intermediate transfer belt 8 related to conveyance of the recording material K, a drive source (not illustrated) of the feeding and conveying device 12, the pair of registration rollers 16, and the fixing device 17, and a drum motor (not illustrated) which is a drive source of the process cartridge P, control of various image signals related to image formation, density correction control based on a detection result of the optical sensor 27, and further control related to failure detection.

### (Photosensitive Drum)

The photosensitive drum 1 of the present invention includes a support, and a surface layer 32 including a photosensitive layer and particles provided on the support. The photosensitive drum 1 according to the present invention can be used as a cylindrical photosensitive drum in which a photosensitive layer and a surface layer 32 are formed on a cylindrical support, but a belt shape or a sheet shape is also possible.

Examples of a manufacturing method include a method in which a coating liquid for each layer described later is prepared, applied in order of desired layers, and dried. At this time, examples of a coating liquid coating method include dip coating, spray coating, inkjet coating, roll coating, die coating, blade coating, curtain coating, wire bar coating, ring coating, and the like. Among these, dip coating is preferable from the viewpoint of efficiency and productivity.

Each layer will be described below.

### <Support>

In the photosensitive drum 1 of the present invention, the support is preferably a conductive support having conductivity. Examples of the shape of the support include a cylindrical shape, a belt shape, a sheet shape, and the like. Thereamong, a cylindrical support is preferable. The surface of the support may be subjected to electrochemical treatment such as anodization, blast treatment, cutting treatment, and the like. The material of the support is preferably metal, resin, glass, or the like. Examples of the metal include aluminum, iron, nickel, copper, gold, stainless steel, alloys thereof, and the like. Thereamong, an aluminum support using aluminum is preferable. In addition, conductivity may be imparted to the resin or glass by treatment such as mixing or coating with a conductive material.

### <Conductive Layer>

In the photosensitive drum 1 of the present invention, a conductive layer may be provided on the support. By providing the conductive layer, scratches and unevenness on the surface of the support can be concealed, and reflection of light on the surface of the support can be controlled. The conductive layer preferably contains conductive particles and a resin. Examples of the material of the conductive particles include metal oxides, metals, and carbon black.

Examples of metal oxides include zinc oxide, aluminum oxide, indium oxide, silicon oxide, zirconium oxide, tin oxide, titanium oxide, magnesium oxide, antimony oxide, bismuth oxide, and the like. Examples of metals include aluminum, nickel, iron, nichrome, copper, zinc, silver, and the like.

Among these, it is preferable to use a metal oxide as the conductive particles, and in particular, it is more preferable to use titanium oxide, tin oxide, or zinc oxide.

When a metal oxide is used as the conductive particles, the surface of the metal oxide may be treated with a silane coupling agent or the like, or the metal oxide may be doped with an element such as phosphorus or aluminum or an oxide thereof. In addition, the conductive particles may have a laminated configuration in which uncoated particles such as titanium oxide, barium sulfate, and zinc oxide and the particles are coated with a metal oxide having a composition different from that of the uncoated particles. Examples of coating include metal oxides such as tin oxide. When a metal oxide is used as the conductive particles, the average primary particle size is preferably at least 1 nm and not more than 500 nm, and more preferably at least 3 nm and not more than 400 nm.

Examples of the resin include a polyester resin, a polycarbonate resin, a polyvinyl acetal resin, an acrylic resin, a silicone resin, an epoxy resin, a melamine resin, a polyurethane resin, a phenol resin, an alkyd resin, and the like.

The conductive layer may further contain a masking agent such as silicone oil, resin particles, or titanium oxide. The average film thickness of the conductive layer is preferably at least 1 μm and not more than 50 μm, and particularly preferably at least 3 μm and not more than 40 μm. The conductive layer can be formed by preparing a conductive layer coating liquid containing each of the above-described materials and a solvent, forming a coating film, and drying the coating film. Examples of the solvent used in the coating liquid include an alcohol-based solvent, a sulfoxide-based solvent, a ketone-based solvent, an ether-based solvent, an ester-based solvent, an aromatic hydrocarbon-based solvent, and the like. Examples of a dispersion method for dispersing conductive particles in the conductive layer coating liquid include methods using a paint shaker, a Sandoz mill, a ball mill, and a liquid collision type high-speed disperser.

### <Undercoat Layer>

In the photosensitive drum 1 of the present invention, an undercoat layer may be provided on the support or the conductive layer. The average film thickness of the undercoat layer is preferably at least 0.1 μm and not more than 50 μm, more preferably at least 0.2 μm and not more than 40 μm, and particularly preferably at least 0.3 μm and not more than 30 μm.

Examples of the resin of the undercoat layer include a polyacrylic acid resin, a polyvinyl alcohol resin, a polyvinyl acetal resin, a polyethylene oxide resin, a polypropylene oxide resin, an ethyl cellulose resin, a methyl cellulose resin, a polyamide resin, a polyamide acid resin, a polyurethane resin, a polyimide resin, a polyamideimide resin, a polyvinyl phenol resin, a melamine resin, a phenol resin, an epoxy resin, and an alkyd resin. The resin may have a structure in which a resin having a polymerizable functional group and a monomer having a polymerizable functional group are crosslinked.

In addition, the undercoat layer may contain an inorganic compound or an organic compound in addition to the resin.

Examples of the inorganic compound include metals, oxides, and salts.

Examples of metals include gold, silver, aluminum, and the like. Examples of oxides include zinc oxide, white lead, aluminum oxide, indium oxide, silicon oxide, zirconium oxide, tin oxide, titanium oxide, magnesium oxide, antimony oxide, bismuth oxide, indium oxide, tin oxide, zirconium oxide, and the like. Examples of salts include barium sulfate and strontium titanate.

These inorganic compounds may be present in the film in a particulate state. The number-average particle size of the particles is preferably at least 1 nm and not more than 500 nm, and more preferably at least 3 nm and not more than 400 nm.

These inorganic compounds may have a laminated configuration including core particles and a coating layer coating the particles.

The surfaces of these inorganic compounds may be treated with silicone oil, a silane compound, a silane coupling agent, other organic silicon compounds, an organic titanium compound, or the like. In addition, elements such as tin, phosphorus, aluminum, and niobium may be doped.

Examples of organic compounds include electron transport compounds and conductive polymers. Examples of conductive polymers include polythiophene, polyaniline, polyacetylene, polyphenylene, and polyethylene dioxythiophene. Examples of an electron transporting material include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. The electron transport material has a polymerizable functional group, and may be crosslinked with a resin having a functional group capable of reacting with the functional group. Examples of the polymerizable functional group include a hydroxy group, a thiol group, an amino group, a carboxyl group, a vinyl group, an acryloyl group, a methacryloyl group, an epoxy group, and the like. These organic compounds may be present in the film in a particulate state, or the surface thereof may be treated.

Various additives such as a leveling agent such as silicone oil, a plasticizer, and a thickener may be added to the undercoat layer. The undercoat layer is obtained by preparing an undercoat layer coating liquid containing the above materials, coating the coating liquid onto the support or the conductive layer, and then drying or curing the coating film. Examples of a solvent in preparing the coating liquid include an alcohol-based solvent, a ketone-based solvent, an ether-based solvent, an ester-based solvent, an aromatic hydrocarbon-based solvent, and the like. Examples of a dispersion method for dispersing particles in the coating liquid include methods using a paint shaker, a Sandoz mill, a ball mill, and a liquid collision type high-speed disperser.

### <Photosensitive Layer>

The photosensitive layer is mainly classified into (1) a laminated photosensitive layer and (2) a monolayer type photosensitive layer. (1) The laminated photosensitive layer includes a charge generation layer containing a charge generating material and a charge transport layer containing a charge transporting material. (2) The monolayer type photosensitive layer includes a photosensitive layer containing both a charge generating material and a charge transporting material.

### (1) Laminated Photosensitive Layer

The laminated photosensitive layer includes a charge generation layer and a charge transport layer.

### (1-1) Charge Generation Layer

The charge generation layer preferably contains a charge generating material and a resin.

Examples of the charge generating material include azo pigments, perylene pigments, polycyclic quinone pigments, indigo pigments, phthalocyanine pigments, and the like. Among these, azo pigments and phthalocyanine pigments are preferable. Among the phthalocyanine pigments, oxytitanium phthalocyanine pigments, chlorogallium phthalocyanine pigments, and hydroxygallium phthalocyanine pigments are preferable.

The content of the charge generating material in the charge generation layer is preferably at least 40 mass % and not more than 85 mass %, and more preferably at least 60 mass % and not more than 80 mass % with respect to the total mass of the charge generation layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, a polyvinyl chloride resin, and the like. Among these, a polyvinyl butyral resin is more preferable.

The charge generation layer may further contain additives such as an antioxidant and an ultraviolet absorber. Specific examples thereof include a hindered phenol compound, a hindered amine compound, a sulfur compound, a phosphorus compound, a benzophenone compound, and the like.

The charge generation layer can be formed by preparing a charge generation layer coating liquid containing each of the above-described materials and a solvent, forming a coating film on the undercoat layer, and drying the coating film. Examples of the solvent used in the coating liquid include an alcohol-based solvent, a sulfoxide-based solvent, a ketone-based solvent, an ether-based solvent, an ester-based solvent, an aromatic hydrocarbon-based solvent, and the like.

The film thickness of the charge generation layer is preferably at least 0.1 μm and not more than 1.5 μm, and more preferably at least 0.15 μm and not more than 1.0 μm.

### (1-2) Charge Transport Layer

The charge transport layer preferably contains a charge transporting material and a resin.

Examples of the charge transporting material include a polycyclic aromatic compound, a heterocyclic compound, a hydrazone compound, a styryl compound, an enamine compound, a benzidine compound, a triarylamine compound, a resin having a group derived from these materials, and the like. Among these, triarylamine compounds and benzidine compounds are preferable, and compounds having the following structures are suitably used.

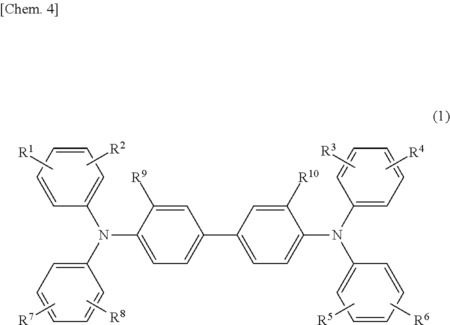

(In the formula (1), R¹ to R¹⁰ each independently represent a hydrogen atom or a methyl group.)

Examples of the structure represented by the formula (1) are shown in formulas (1-1) to (1-10). Among these, the structures represented by the formulas (1-1) to (1-6) are more preferable.

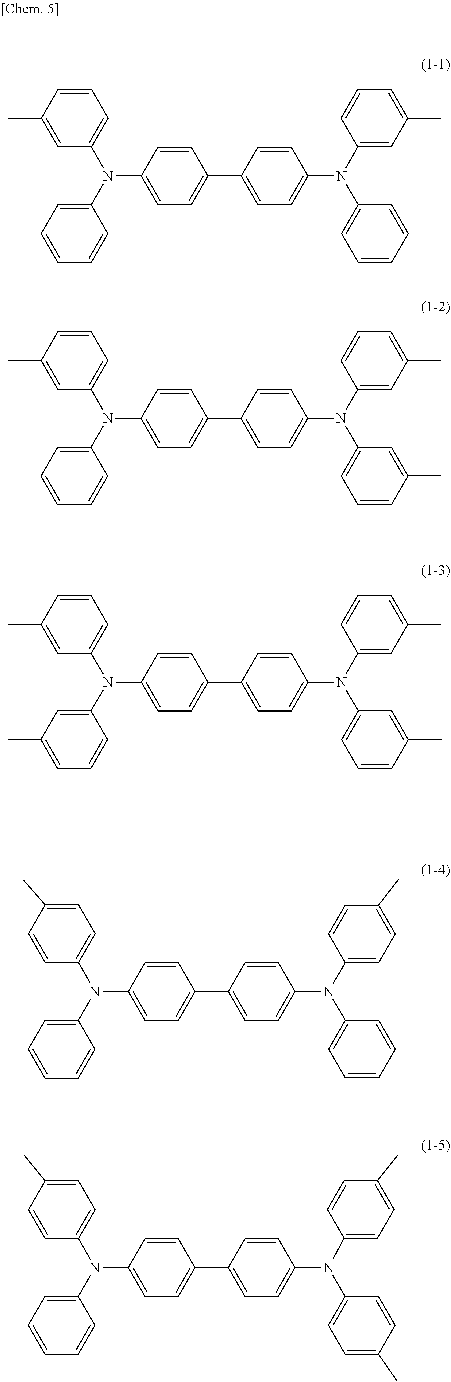

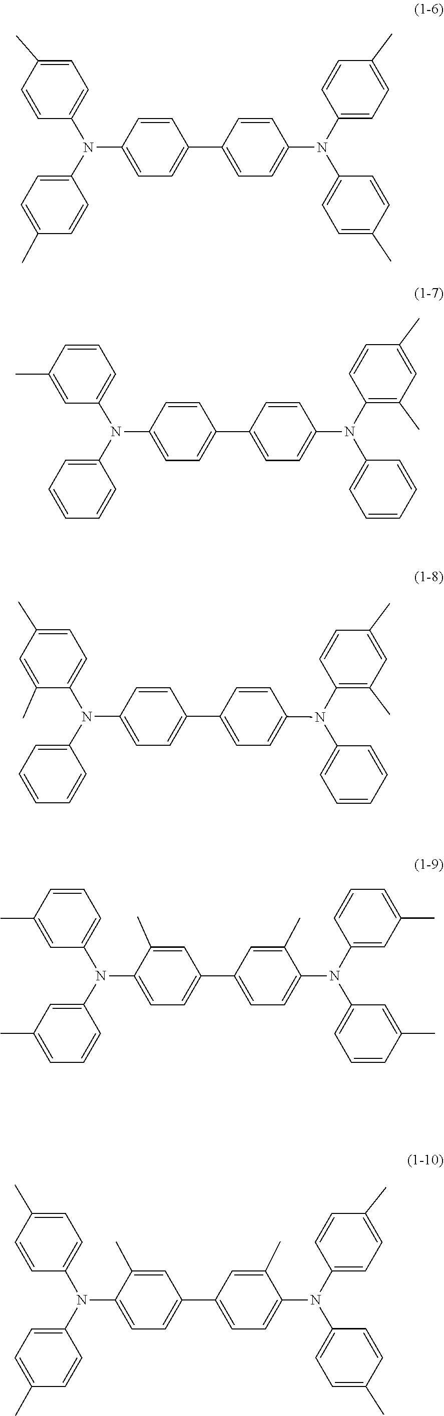

The content of the charge transporting material in the charge transport layer is preferably at least 25 mass % and not more than 70 mass %, and more preferably at least 30 mass % and not more than 55 mass % with respect to the total mass of the charge transport layer.

Examples of the resin include a polyester resin, a polycarbonate resin, an acrylic resin, a polystyrene resin, and the like. Among these, a polycarbonate resin and a polyester resin are preferable. The polyester resin is particularly preferably a polyarylate resin.

The content ratio (mass ratio) of the charge transporting material to the resin is 4:10 to 20:10 is preferable, 5:10 to 12:10 is more preferable.

In addition, the charge transport layer may contain additives such as an antioxidant, an ultraviolet absorber, a plasticizer, a leveling agent, a slipperiness imparting agent, and an abrasion resistance improver. Specific examples thereof include a hindered phenol compound, a hindered amine compound, a sulfur compound, a phosphorus compound, a benzophenone compound, a siloxane-modified resin, silicone oil, fluororesin particles, polystyrene resin particles, polyethylene resin particles, silica particles, alumina particles, boron nitride particles, and the like.

The charge transport layer can be formed by preparing a charge transport layer coating liquid containing each of the above-described materials and a solvent, forming a coating film on the charge generation layer, and drying the coating film. Examples of the solvent used in the coating liquid include an alcohol-based solvent, a ketone-based solvent, an ether-based solvent, an ester-based solvent, and an aromatic hydrocarbon-based solvent. Among these solvents, an ether-based solvent or an aromatic hydrocarbon-based solvent is preferable.

The film thickness of the charge transport layer is preferably at least 3 μm and not more than 50 μm, more preferably at least 5 μm and not more than 40 μm, and particularly preferably at least 10 μm and not more than 30 μm. As will be described later, when the charge transport layer is the surface layer 32 of the photosensitive drum 1, particles forming a protruding shape are formed on the surface of the charge transport layer. Usable particle materials, suitable protruding shapes, and the like will be described in detail in description of the surface layer 32.

### (2) Monolayer Type Photosensitive Layer

The monolayer type photosensitive layer can be formed by preparing a photosensitive layer coating liquid containing a charge generating material, a charge transporting material, a resin, and a solvent, forming a coating film on the undercoat layer, and drying the coating film. Examples of the charge generating material, the charge transporting material, and the resin are the same as those in the above “(1) Laminated Photosensitive Layer”. The film thickness of the monolayer type photosensitive layer is preferably at least 10 μm and not more than 45 μm, and more preferably at least 25 μm and not more than 35 μm.

### <Surface Layer>

The photosensitive drum 1 of the present invention includes the surface layer 32 containing particles. By setting the protruding shape caused by the contained particles within an appropriate range, the adhesion between the toner and the photosensitive drum 1 can be reduced, and the effect of improving the transfer efficiency can be obtained.

The adhesion between the toner and the photosensitive drum 1 is roughly classified into electrostatic adhesion and non-electrostatic adhesion. Since the reflection force is a main factor of the electrostatic adhesion, the electrostatic adhesion greatly depends on the charge amount of the toner. The magnitude of the reflection force is proportional to the charge amount of the toner, and is inversely proportional to the square of the distance to the surface of the photosensitive drum 1 to which the toner is to be attached. By forming a protruding shape on the surface layer 32 of the photosensitive member and securing a distance between the toner and the surface of the photosensitive drum 1, the reflection force can be reduced. That is, securing the protrusion height of the protruding shape is effective for reducing the reflection force. That is, it is effective to increase the particle size for forming protrusion and to expose the particles from the surface layer 32.

On the other hand, in order to reduce non-electrostatic adhesion, it is necessary to reduce the van der Waals force. In order to lower the van der Waals force, it is effective to geometrically reduce the contact area between the toner and the surface of the photosensitive drum 1. In order to reduce the contact area, it is effective to reduce the number of contact points between the toner and the photosensitive drum 1 and to reduce the area at the contact point between the toner and the photosensitive drum 1. In order to reduce the former, the number of contact points, it is effective to discretely form the protruding shape in a range smaller than the toner particle size. In order to reduce the latter, the contact area, it is effective to reduce the radius of curvature of the protruding shape. That is, it is effective to reduce the particle size for forming the protrusion and discretely form the protrusion in the range of the toner particle size or less.

Furthermore, in order to maintain the durability of the protruding shape, it is effective to curb exposure of particles from the surface layer 32.

In the photosensitive drum 1, the process cartridge, and the image forming apparatus using the same of the present invention, by combining an appropriate protruding shape and an appropriate image forming apparatus configuration with respect to these elements, the protruding shape can be maintained throughout durability, and an effect of improving transfer efficiency can be obtained for a long period of time. The appropriate protruding shape and the combination with the image forming apparatus configuration will be described in detail later, and the constituent material of the surface layer of the photosensitive drum 1 will be described.

The surface layer 32 of the photosensitive drum 1 of the present invention contains particles for forming a protruding shape as described above. The material of the particles is not particularly limited. Organic resin particles such as acrylic resin particles, inorganic particles such as alumina, silica, and titania, and organic-inorganic hybrid particles can be used.

In addition, for the purpose of improving the charge transport capability of the surface layer 32, conductive particles or a charge transporting material may be added to the surface layer coating liquid. As the conductive particles, a conductive pigment used for the above-described conductive layer can be used. As the charge transporting material, the charge transporting substance described above can be used. In addition, additives can also be added for the purpose of improving various functions. Examples of additives include conductive particles, an antioxidant, an ultraviolet absorber, a plasticizer, and a leveling agent.

Examples of organic resin particles include crosslinked polystyrene particles, crosslinked acrylic resin particles, phenol resin particles, melamine resin particles, polyethylene particles, polypropylene particles, acrylic resin particles, polytetrafluoroethylene particles, and silicone particles.

The acrylic resin particles contain a polymer of an acrylic acid ester or a methacrylic acid ester. Thereamong, styrene acrylic resin particles are more preferable. The polymerization degree of the acrylic resin and the styrene acrylic resin and whether the resin is thermoplastic or thermosetting are not particularly limited.

The polytetrafluoroethylene particles may be particles mainly composed of a tetrafluoroethylene resin, and may further contain a trifluoroethylene chloride resin, a hexafluoropropylene resin, a vinyl fluoride resin, a vinylidene fluoride resin, a difluoroethylene dichloride resin, or the like.

Examples of organic-inorganic hybrid particles include polymethylsilsesquioxane particles containing a siloxane bond.

As the particles of the surface layer 32 of the photosensitive drum 1 of the present invention, it is more preferable to use inorganic particles having low elasticity and being advantageous in terms of point contact with the toner.

Examples thereof include particles of magnesium oxide, zinc oxide, lead oxide, tin oxide, tantalum oxide, indium oxide, bismuth oxide, yttrium oxide, cobalt oxide, copper oxide, manganese oxide, selenium oxide, iron oxide, zirconium oxide, germanium oxide, tin oxide, titanium oxide, niobium oxide, molybdenum oxide, vanadium oxide, copper aluminum oxide, tin oxide doped with antimony ion, hydrotalcite, and the like. These particles may be used singly or in combination of two or more kinds thereof. The inorganic particles are preferably silica particles.

As the silica particles, known silica particles can be used, and either dry silica particles or wet silica particles may be used. Wet silica particles (hereinafter, also referred to as “sol-gel silica”) obtained by a sol-gel method are more preferable.

In the sol-gel silica used for the particles contained in the surface layer 32 of the photosensitive drum 1 of the present invention, the surfaces of the particles may be hydrophilic, or the surfaces of the particles may be hydrophobized.

Examples of a method for hydrophobizing treatment include a method in which a solvent is removed from a silica sol suspension, the silica sol suspension is dried, and then treated with a hydrophobizing agent, and a method in which a hydrophobizing agent is directly added to the silica sol suspension, and the silica sol suspension is treated simultaneously with drying in sol-gel methods. From the viewpoint of controlling the half-width of a particle size distribution and controlling the saturated moisture adsorption amount, a method of directly adding a hydrophobizing agent to the silica sol suspension is preferable.

By performing hydrophobizing treatment on the particles contained in the surface layer 32 of the photosensitive drum 1 of the present invention, the exposed state of the particles in the surface layer 32 can be controlled. Examples of the hydrophobizing agent include the following.

Chlorosilanes such as methyltrichlorosilane, dimethyldichlorosilane, trimethylchlorosilane, phenyltrichlorosilane, diphenyldichlorosilane, t-butyldimethylchlorosilane, and vinyltrichlorosilane;
alkoxysilanes such as tetramethoxy silane, methyltrimethoxy silane, dimethyldimethoxy silane, phenyltrimethoxy silane, diphenyldimethoxy silane, o-methylphenyltrimethoxy silane, p-methylphenyltrimethoxy silane, n-butyltrimethoxy silane, i-butyltrimethoxy silane, hexyltrimethoxy silane, octyl trimethoxy silane, decyltrimethoxy silane, dodecyl trimethoxy silane, tetraethoxy silane, methyltriethoxy silane, dimethyldiethoxysilane, phenyltriethoxysilane, diphenyldiethoxysilane, i-butyltriethoxysilane, decyltriethoxysilane, vinyltriethoxy silane, γ-methacryloxypropyltrimethoxy silane, γ-glycidoxypropyltrimethoxy silane, γ-glycidoxypropylmethyldimethoxy silane, γ-mercaptopropyltrimethoxy silane, γ-chloropropyltrimethoxy silane, γ-aminopropyltrimethoxy silane, γ-aminopropyltriethoxy silane, γ-(2-aminoethyl)aminopropyltrimethoxy silane, and γ-(2-aminoethyl)aminopropylmethyldimethoxysilane;
silazanes such as hexamethyldisilazanes, hexaethyldisilazanes, hexapypropyldisilazanes, hexabutyldisilazanes, hexopentyldisilazanes, hexahexyldisilazanes, hexacyclohexyldisilazanes, hexaphenyldisilazanes, divinyltetramethyldisilazane, and dimethyltetravinyldisilazane;
silicone oils such as dimethyl silicone oil, methyl hydrogen silicone oil, methylphenyl silicone oil, alkyl-modified silicone oil, chloroalkyl-modified silicone oil, chlorophenyl-modified silicone oil, a fatty acid-modified silicone oil, a polyether-modified silicone oil, an alkoxy-modified silicone oil, carbinol-modified silicone oil, amino-modified silicone oil, fluorine-modified silicone oil, and end-reactive silicone oil;
siloxanes such as hexamethylcyclotrisiloxane, octamethylcyclotetrasiloxane, decamethylcyclopentasiloxane, hexamethyldisiloxane, and octamethyltrisiloxane;
fatty acids and metal salts thereof include undecylic acid, lauric acid, tridecylic acid, dodecyl acid, myristic acid, palmitic acid, pentadecylic acid, stearic acid, heptadecylic acid, long chain fatty acids such as arachidonic acid, montanic acid, oleic acid, linolic acid, arachidonic acid, and the like, the fatty acid and zinc, iron, magnesium, aluminum, calcium, salts with metals, such as sodium, lithium.

Among these, alkoxysilanes, silazanes, and silicone oils are preferably used because they are easy to perform hydrophobizing treatment. These hydrophobizing agents may be used singly or in combination of two or more kinds thereof.

The Young's modulus of the particles contained in the surface layer 32 of the photosensitive drum 1 of the present invention is preferably 0.60 GPa or more. When the Young's modulus of the surface of the particles is less than 0.60 GPa, the contact area between the surface of the toner and the surface of the particles increases at the time of contact with the toner, and transferability may deteriorate.

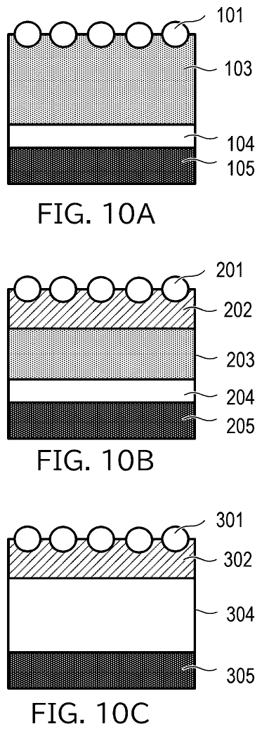

As a photosensitive drum layer configuration for obtaining the effect of the present invention, three layer configurations are conceivable. This will be described with reference to FIGS. 10A, 10B, and 10C.

Layer configuration 1: A photosensitive drum 1 having a support 105 and a photosensitive layer on the support, in which a surface layer 32 of the photosensitive drum 1 contains particles 101, the photosensitive layer has a charge generation layer 104 and a charge transport layer 103 on the charge generation layer, and the charge transport layer is the surface layer 32 (FIG. 10A).

Layer configuration 2: A photosensitive drum 1 having a support 205 and a photosensitive layer on the support, in which a surface layer 32 of the photosensitive drum 1 contains particles 201, the photosensitive layer has a charge generation layer 204 and a charge transport layer 203 on the charge generation layer, the photosensitive drum 1 further has a protective layer 202 on the photosensitive layer, and the protective layer is the surface layer 32 (FIG. 10B).

Layer configuration 3: A photosensitive drum 1 having a support 305 and a photosensitive layer on the support, in which a surface layer 32 of the photosensitive drum 1 contains particles 301, the photosensitive layer is a monolayer type photosensitive layer 304, the photosensitive drum 1 further has a protective layer 302 on the photosensitive layer, and the protective layer is the surface layer 32 (FIG. 10C).

From the viewpoint of easily controlling the arrangement of the particles of the surface layer 32, the layer configuration 1 or the layer configuration 2 is preferable for achieving both transferability and durability.

### (Method of Evaluating Photosensitive Drum)

In the photosensitive drum 1 of the present invention, setting a protruding shape caused by the contained particles within an appropriate range is an important factor for improving transfer efficiency by reducing the adhesion between the toner and the photosensitive drum 1 and maintaining performance through durability. Therefore, it is necessary to appropriately evaluate and control the particle size of particles that form a protruding shape, an exposed state in the state of the photosensitive drum, an uneven state of exposed particles, the Young's modulus of the exposed particles, and the like. Each evaluation method will be described.

### <Method of Measuring Volume-Average Particle Size of Particles>

The volume average particle size of particles is measured using Zetasizer Nano-ZS (manufactured by Malvern Instruments Ltd.). The device can measure the particle size by a dynamic light scattering method. First, a sample to be measured is diluted and adjusted such that the solid-liquid proportion of the sample reaches 0.10 mass % (±0.02 mass %), collected in a quartz cell, and placed in a measurement unit. As a dispersion medium, water or a methyl ethyl ketone/methanol mixed solvent is used when the sample is inorganic fine particles, and water is used when the sample is resin particles or an external additive for toner. The refractive index of the sample, the refractive index, the viscosity, and the temperature of the dispersion solvent are input as measurement conditions, and measurement is performed using the control software Zetasizersoftware 6.30. Dn is adopted as the number-average particle size.

The refractive index of particles is adopted from “refractive index of solid” described on page 517 of Volume II of Chemical Handbook, Basic Edition, Revised 4th Edition (Edited by The Chemical Society of Japan, Maruzen Co., Ltd.). As the refractive index of resin particles, the refractive index of the resin used for the resin particles is adopted as the refractive index incorporated in the control software. However, when there is no incorporated refractive index, values listed in the Polymer Database of the National Institute for Materials Science are used. The refractive index of an external additive for toner is calculated by taking the weight average from the refractive index of inorganic fine particles and the refractive index of the resin used for resin particles. As the refractive index, viscosity, and temperature of the dispersion solvent, numerical values incorporated in the control software are selected. In the case of a mixed solvent, the weight average of a dispersion medium to be mixed is taken.

<Method of Measuring Exposed Volume and Exposed Number of Particles from Surface Layer>

The photosensitive drum 1 of the present invention is cut into 5 mm square samples at 50 mm from each end in the longitudinal direction, three locations at the center portion, and four locations at 90 degrees each in the circumferential direction, for a total of 12 locations. The photosensitive layer of the sample is coated with platinum using an evaporation device for 30 seconds.

In the FIB-SEM (NVision40, manufactured by Carl Zeiss), the following cutting is performed on each sample.
Beam type: Gallium ion beam
Acceleration voltage: 1 kV
Size: length: 3 μm, width: 3 μm, depth: 3 μm
Processing step length: 10 nm
Number of steps: 300 times

Further, at each step, SEM observation is performed with an accelerating voltage of 5 kV, a focal length WD of 5 mm, and a field of view of 30,000 times.

All images captured with the FIB-SEM are converted to three-dimensional images in image processing and analysis software (“ExfactVR 2.1” manufactured by Japan Visual Science Co., Ltd.) via an interface. The number of particles exposed from the surface layer 32 of the photosensitive drum 1 is measured from the three-dimensional images, and the proportion of the number of exposed particles to the total number of particles contained in the surface layer 32 is calculated. Furthermore, the derived three-dimensional images are compared with an image of the particles exposed from the surface layer 32 cut by the FIB-SEM, a cross-sectional image of the particles cut at the center of gravity is input via an interface into an image processing and analyzing device (“LUZEX AP” manufactured by Nireco Corporation), and the particles in the cross-sectional image is binarized.

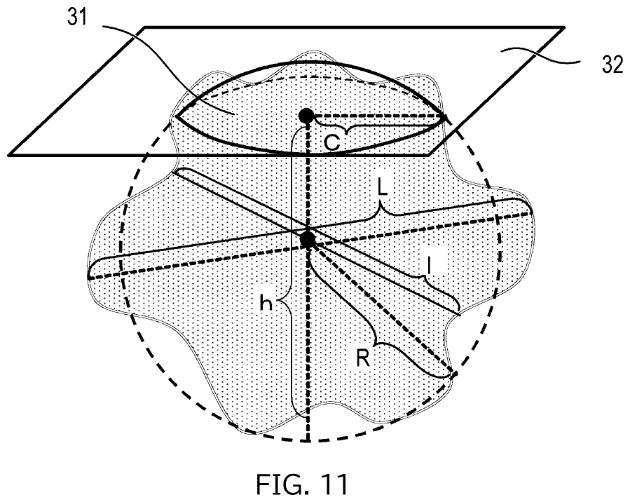

As shown in the conceptual diagram of FIG. 11, a particle 31 exposed from the surface layer 32 with the surface layer 32 as a cross section was approximated to a spherical particle of a virtual true sphere in which ¼ of the sum of the major axis L and the minor axis 1 of the particle was set to the radius R of the particle. The center of gravity of the cross section of the particle 31 exposed from the surface layer 32 coincides with the center of gravity of the spherical particle of the virtual true sphere. For the particle 31 exposed from the surface layer 32, the surface layer 32 where the resin portion is exposed has substantially no undulation, and calculation is performed by approximating to a smooth surface. The depth of a portion where the particle 31 contained in the surface layer 32 of the photosensitive drum 1 of the present invention is embedded from the surface layer 32 of the resin portion was defined as h.

In addition, the virtual true sphere was approximated to a circle having a radius C of the particle when the bottom surface of the portion exposed from the surface layer 32 of the resin portion was viewed from above. (FIG. 11 is a conceptual diagram.)

The volume V1 of the particle is calculated from the formula of the volume of the sphere by the following formula (a).

$$V 1 = 4 π {R}^{3} / 3 \qquad formula ( a )$$

The volume V2 of the buried portion of the particle is calculated from the formula of the volume of the spherical crown by the following formula (b).

$$V 2 = π h ( 3 {C}^{2} + {h}^{2} ) / 6 \qquad formula ( b )$$

The volume V3 of the exposed portion of the particle is calculated by the following formula (c) by taking a difference between V1 and V2.

$$V 3 = V 2 - V 3 = 4 π {R}^{3} / 3 \sim π h ( 3 {C}^{2} + {h}^{2} ) / 6 \qquad formula ( c )$$

V1, V2, and V3 are calculated for the particles present in the three-dimensional images, and the proportion of the volume of the exposed portions of the particles partially exposed from the surface layer 32 is calculated by dividing the sum of V3 of all the particles present by the sum of V1 of all the particles.

### <Method of Measuring Coverage Ratio of Particles and Coefficient of Variation in Surface Layer>

In the photosensitive drum 1 according to the present invention, when the surface layer 32 is viewed from above, S1/(S1+S2) can be calculated as follows, where S1 is the total area of the exposed portions of the particles.

For the particles of the surface layer 32, a 30,000× magnification photographic image of the surface layer 32 of the photosensitive drum 1 taken using a scanning electron microscope (SEM) (“S-4800” manufactured by JEOL Ltd.) is captured by a scanner, and the particles in the photographic image are binarized using an image processing and analysis device (“LUZEX AP” manufactured by Nireco Corporation). The area of an exposed portion of particles on the photosensitive drum 1 in one field of view is defined as S1, the total area of the particles other than the exposed portion is defined as S2, and the coverage rate S1/(S1+S2) (%) is calculated. The above-described coverage ratio is calculated for a total of 10 fields of view, and the average value of the obtained coverage ratios is taken as the coverage ratio of the particles in the surface layer 32 of the photosensitive member.

### <Method of Measuring Young's Modulus of Exposed Particles in Surface Layer>

As an evaluation machine, an SPM probe station (“NanoNaviReal” manufactured by Hitachi High-Tech Science Corporation) equipped with a scanning probe microscope (“S-image” manufactured by Hitachi High-Tech Science Corporation) incorporating a heater was used. Prior to measurement, the evaluation machine was calibrated under conditions of an allowable range of 2.920±0.119 GPa (Young's modulus) using PMMA (polymethyl methacrylate) particles as a standard substance. The Young's modulus of PMMA measured by the calibrated evaluation machine was 3.01 GPa.

The particles in the surface layer 32 were measured by SPM, and the average value of 10 measurement results for each particle was taken as the Young's modulus of the particle. Furthermore, the average value of the Young's moduli of 10 particles was defined as the Young's modulus of the exposed particles in the surface layer 32 of the photosensitive member in the present invention.

### <Measurement of Film Thickness of Each Layer>

The film thickness of each layer of the photosensitive drum 1 was obtained by a method using an eddy current type film thickness meter (Fischerscope, manufactured by Fischer Instruments) or a method of converting the specific gravity from the mass per unit area, excluding the charge generation layer. The film thickness of the charge generation layer was measured by converting the density value of the photosensitive member using a calibration curve obtained in advance from density values measured by pressing a spectral densitometer (trade name: X-Rite504/508, manufactured by X-Rite) against the surface of the photosensitive member and film thickness measurement values obtained by cross-sectional SEM image observation.

### EXAMPLES

### (Manufacture of Photosensitive Drum)

A manufacturing example of the photosensitive drum 1 in the present invention will be described in detail.

The type, manufacturer, number-average particle size, volume-average particle size, and (volume-average particle size)/(number-average particle size) of the particles contained in the surface layer 32 of the photosensitive drum 1 are shown in Table 7. Table 7. Details of Particles Contained in Surface Layer

TABLE 7

| | | | Number- | Volume- | (Volume- |
|---|---|---|---|---|---|
| | | | average | average | average)/ |
| | Particle type | | particle size | particle size | (Number- |
| Particle | (trade name) | Manufacturer | (nm) | (nm) | average) |
| 1 | KE-P10 | NIPPON SHOKUBAI CO. | 110 | 124 | 1.1 |
| 2 | KE-P30 | NIPPON SHOKUBAI CO. | 275 | 310 | 1.1 |
| 3 | KE-P50 | NIPPON SHOKUBAI CO. | 480 | 550 | 1.1 |
| 4 | QSG-30 | Shin-Etsu Silicone Co. | 24 | 37 | 1.5 |
| 5 | QSG-80 | Shin-Etsu Silicone Co. | 60 | 79 | 1.3 |
| 6 | QSG-170 | Shin-Etsu Silicone Co. | 150 | 192 | 1.3 |
| 7 | Microdispers-200 | Techno Chemical Co. | 250 | 300 | 1.2 |

### <Production of Surface-Treated Particles 1>

Methanol: 10 parts by mass
Particle 1 (described in Table 7): 5 parts by mass
   were added and dispersed at room temperature for 30 minutes using a US homogenizer. Next, 0.25 parts by mass of n-propyltrimethoxysilane (manufactured by Shin-Etsu Chemical Co., Ltd.) as a reactive surface treatment agent and 10 parts by mass of toluene were added, and the mixture was stirred at room temperature for 60 minutes. The solvent was removed with an evaporator, and then the resultant product was heated at 140° C. for 60 minutes to produce surface-treated particle 1 surface-treated with the reactive surface treatment agent. The volume-average particle size was 136 nm, and the number-average particle size was 124 nm.

### Production Example of Electrophotographic Photosensitive Member 1

### [Preparation of Support]

An aluminum cylinder (JIS-A3003, aluminum alloy) having a diameter of 20 mm and a length of 257.5 mm was used as a support (conductive support).

### Preparation Example of Conductive Layer Coating Liquid 1

Anatase type titanium dioxide
   (Average primary particle size 150 nm, niobium content 0.20 wt %): 100 parts by mass
Pure water: 1000 parts by mass
   were dispersed to obtain a 1 L aqueous suspension and the aqueous suspension was heated to 60° C.

A titanium-niobic acid solution obtained by mixing a niobium solution obtained by dissolving 3 parts by mass of niobium pentachloride (NbCl₅) in 100 mL of 11.4 mol/L hydrochloric acid and 600 mL of a titanium sulfate solution containing 33.7 parts by mass of Ti, and a 10.7 mol/L sodium hydroxide solution were simultaneously added dropwise over 3 hours such that the pH of the suspension becomes 2 to 3. After completion of dropwise addition, the suspension was filtered, washed, and dried at 110° C. for 8 hours.

The dried product was subjected to a heat treatment at 800° C. for 1 hour in the air atmosphere to obtain powder of metal oxide particles 1 having a core material containing titanium oxide and a coating layer containing titanium oxide doped with niobium.

Next,
Phenol resin
   (trade name: Plyophen J-325, manufactured by DIC Corporation, resin solid content: 60%, density after curing: 1.3 g/cm²): 50 parts by mass
1-methoxy-2 propanol: 35 parts by mass
Metal oxide particles 1: 75 parts by mass
Glass beads (average particle size: 1.0 mm): 120 parts by mass
   were mixed, and resulting mixture was placed in a vertical Sandoz mill and subjected to dispersion treatment for 4 hours under the conditions of a dispersion temperature of 23±3° C. and a rotation speed of 1500 rpm (peripheral speed: 5.5 m/s) to obtain a metal oxide particle dispersion 1. The glass beads were removed from the metal oxide particle dispersion 1 with a mesh, and
Silicone oil (trade name: SH28 PAINT ADDITIVE, manufactured by Dow Corning Toray Co., Ltd.): 0.01 parts by mass
Silicone resin particles (trade name: Tospearl 120, manufactured by Momentive Performance Materials, average particle size: 2 μm, density: 1.3 g/cm²): 10 parts by mass
   were added, the resulting mixture was stirred, and filtered under pressure using a PTFE filter paper (trade name: PF060, Advantec Toyo Kaisha, Ltd.) to prepare a conductive layer coating liquid 1.

[Preparation Example of Conductive Layer 1] The conductive layer coating liquid 1 was dip-coated on the support and heated at 140° C. for 1 hour to form a conductive layer 1 having a film thickness of 20 μm.

### Preparation Example of Undercoat Layer Coating Liquid 1

Rutyl type titanium oxide particles (average primary particle size: 50 nm, manufactured by Tayca Corporation): 100 parts by mass
Phenol resin (trade name: Plyophen J-325, manufactured by DIC Corporation, resin solid content: 60 mass %): 132 parts by mass
Toluene: 500 parts by mass
Vinyltrimethoxysilane (trade name: KBM-1003, manufactured by Shin-Etsu Chemical Co., Ltd.): 5 parts by mass
Glass beads (diameter 0.8 mm): 450 parts by mass
   were mixed and stirred for 8 hours. Thereafter, toluene was distilled off by distillation under reduced pressure and dried at 120° C. for 3 hours to obtain rutile type titanium oxide particles 1 surface-treated with vinyltrimethoxysilane.
Surface-treated rutile titanium oxide particles: 18 parts by mass
N-methoxymethylated nylon (trade name: TORESIN EF-30T, manufactured by Nagase ChemteX Corporation): 4.5 parts by mass
Copolymerized nylon resin (trade name: Amilan CM8000, manufactured by Toray Industries, Inc.): 1.5 parts by mass
Methanol: 90 parts by mass
1-butanol: 60 parts by mass
Acetone: 15 parts by mass
Glass beads (average particle size: 1.0 mm): 120 parts by mass
   were mixed, and the mixture was subjected to dispersion treatment with a vertical Sandoz mill for 5 hours to prepare an undercoat layer coating liquid 1.

### Preparation Example of Undercoat Layer 1

The undercoat layer coating liquid 1 was dip-coated on the conductive layer 1, and heated at 170° C. for 30 minutes to form an undercoat layer 1 having a film thickness of 1.0 μm.

### Preparation Example of Charge Generation Layer 1

Hydroxygallium phthalocyanine (in a chart obtained by CuKα characteristic X-ray diffraction, peaks are observed at positions of 7.5° and) 28.4°: 10 parts by mass
Polyvinyl butyral resin (trade name: S-LEC BX-1, manufactured by Sekisui Chemical Co., Ltd.): 5 parts by mass
Cyclohexanone: 200 parts by mass
Glass beads: 200 parts by mass
   were dispersed using a sand mill device for 6 hours. 150 parts by mass of cyclohexanone and 350 parts by mass of ethyl acetate were further added thereto and diluted to obtain a charge generation layer coating liquid 1. The obtained charge generation layer coating liquid 1 was dip-coated on the undercoat layer 1, and dried at 95° C. for 10 minutes to form a charge generation layer 1 having a film thickness of 0.20 μm.

### Preparation Example of Charge Transport Layer 1

Next, the following materials were prepared.
A charge transporting material (hole transporting material) represented by the structural formula (1-1): 5 parts by mass
A charge transporting material (hole transporting material) represented by the structural formula (1-3): 5 parts by mass
Polycarbonate (trade name: Iupilon Z400, manufactured by Mitsubishi Engineering-Plastics Corporation): 10 parts by mass
0.02 parts of a polycarbonate resin having a copolymerization unit of the following structural formula (C-1) and the following structural formula (C-2) (x/y=0.95/0.05: viscosity average molecular weight=20,000)

These substances were dissolved in a mixed solvent of 60 parts by mass of toluene/3 parts by mass of methyl benzoate/15 parts by mass of tetrahydrofuran to prepare a charge transport layer coating liquid 1. This charge transport layer coating liquid 1 was dip-coated on the charge generation layer 1 to form a coating film, and the coating film was dried at a drying temperature of 40° C. for 5 minutes to form a charge transport layer 1 having a film thickness of 15 μm.

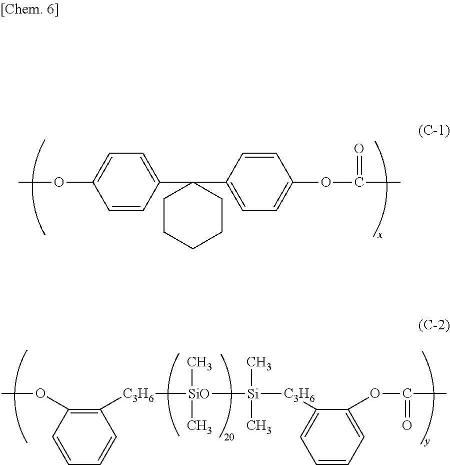

### Preparation Example 1 of Surface Layer Containing Particles

Next, the following materials were prepared.
Particle 1 (described in Table 7): 1.2 parts by mass
Siloxane-modified acrylic compound (trade name: SYMAC US270, manufactured by Toagosei Co., Ltd.): 0.1 parts by mass
Cyclohexane: 30 parts by mass
1-propanol: 70 parts by mass
   were mixed and stirred to prepare a surface layer coating liquid 1.

This surface layer coating liquid was dip-coated on the charge transport layer 1 to form a coating film, and the obtained coating film was dried at 100° C. for 20 minutes to obtain an electrophotographic photosensitive member 1. The film thickness [μm] of the charge transport layer of the electrophotographic photosensitive member 1, the volume-average particle size [nm] of the particles contained in the surface layer 32, the number ratio [number %] of particles exposed from the surface layer 32, the volume ratio [volume %] of the particles exposed from the surface layer 32, the coverage ratio S1/(S1+S2) and the coefficient of variation by the particles exposed from the surface layer, and the Young's modulus [GPa] of the surface of the particles exposed from the surface layer 32 were measured. The results are shown in Table 9.

### Manufacturing Examples of Electrophotographic Photosensitive Members 2 to 34

Electrophotographic photosensitive members 2 to 34 were produced in the same manner as in the electrophotographic photosensitive member 1 except that, in manufacturing examples of the electrophotographic photosensitive member 1, the temperature at which the charge transport layer coating liquid 1 was dip-coated onto the charge generation layer 1 to form a coating film and then dried in the production example of the charge transport layer 1, the types and amounts of particles added contained in the surface layer 32, and the amounts of cyclohexane and 1-propanol added were changed as shown in Table 8. Physical properties measured in the electrophotographic photosensitive members 2 to 34 are shown in Table 9.

Table 8. Details of Formulation of Electrophotographic Photosensitive Members 1 to 34

TABLE 8

| | | | Charge | | | | |
|---|---|---|---|---|---|---|---|
| | | | trans- | | | | |
| | | | port | | | | |
| | | | layer | | | | |
| | Particle | | Tem- | Dispersant | | | |
| | | A- | per- | | A- | | A- |
| EP | | mount | ature | Type | mount | Type | mount |
| No. | Type | added | [° C.] | 1 | added | 2 | added |
| 1 | Particle 1 | 1.2 | 40 | 1-Propanol | 70 | Cyclohexane | 30 |
| 2 | ST | 1.2 | 40 | 1-Propanol | 50 | Cyclo- | 50 |
| | particle 1 | | | | | hexanone | |
| 3 | ST | 1.2 | 40 | 1-Propanol | 55 | Cyclo- | 45 |
| | particle 1 | | | | | hexanone | |
| 4 | ST | 1.2 | 40 | 1-Propanol | 60 | Cyclo- | 40 |
| | particle 1 | | | | | hexanone | |
| 5 | ST | 1.2 | 40 | 1-Propanol | 65 | Cyclo- | 35 |
| | particle 1 | | | | | hexanone | |
| 6 | ST | 1.2 | 40 | 1-Propanol | 80 | Cyclo- | 20 |
| | particle 1 | | | | | hexanone | |
| 7 | ST | 1.2 | 40 | 1-Propanol | 90 | Cyclo- | 10 |
| | particle 1 | | | | | hexanone | |
| 8 | ST | 1.2 | 40 | 1-Propanol | 95 | Cyclo- | 5 |
| | particle 1 | | | | | hexanone | |
| 9 | Particle 1 | 1.2 | 40 | 1-Propanol | 50 | Cyclohexane | 50 |
| 10 | Particle 1 | 1.2 | 40 | 1-Propanol | 60 | Cyclohexane | 40 |
| 11 | Particle 1 | 1.2 | 40 | 1-Propanol | 70 | Cyclohexane | 30 |
| 12 | Particle 1 | 1.2 | 40 | 1-Propanol | 80 | Cyclohexane | 20 |
| 13 | Particle 1 | 1.2 | 40 | 1-Propanol | 90 | Cyclohexane | 10 |
| 14 | Particle 1 | 1.2 | 37 | 1-Propanol | 60 | Cyclohexane | 40 |
| 15 | Particle 1 | 1.2 | 45 | 1-Propanol | 80 | Cyclohexane | 20 |
| 16 | Particle 1 | 1.2 | 35 | 1-Propanol | 90 | Cyclohexane | 10 |
| 17 | Particle 1 | 1.2 | 47 | 1-Propanol | 90 | Cyclohexane | 10 |
| 18 | Particle 1 | 1.2 | 35 | 1-Propanol | 60 | Cyclohexane | 40 |
| 19 | Particle 1 | 1.2 | 47 | 1-Propanol | 60 | Cyclohexane | 40 |
| 20 | Particle 1 | 1.2 | 35 | 1-Propanol | 80 | Cyclohexane | 20 |
| 21 | Particle 1 | 1.2 | 47 | 1-Propanol | 80 | Cyclohexane | 20 |
| 22 | Particle 1 | 0.27 | 40 | 1-Propanol | 70 | Cyclohexane | 30 |
| 23 | Particle 1 | 0.3 | 40 | 1-Propanol | 70 | Cyclohexane | 30 |
| 24 | Particle 1 | 0.36 | 40 | 1-Propanol | 70 | Cyclohexane | 30 |
| 25 | Particle 1 | 0.6 | 40 | 1-Propanol | 70 | Cyclohexane | 30 |
| 26 | Particle 1 | 0.9 | 40 | 1-Propanol | 70 | Cyclohexane | 30 |
| 27 | Particle 1 | 1.02 | 40 | 1-Propanol | 70 | Cyclohexane | 30 |
| 28 | Particle 1 | 2.1 | 40 | 1-Propanol | 70 | Cyclohexane | 30 |
| 29 | Particle 1 | 2.4 | 40 | 1-Propanol | 70 | Cyclohexane | 30 |
| 30 | Particle 1 | 3.06 | 40 | 1-Propanol | 70 | Cyclohexane | 30 |
| 31 | Particle 2 | 1.8 | 40 | 1-Propanol | 77 | Cyclohexane | 23 |
| 32 | Particle 6 | 1.5 | 40 | 1-Propanol | 78 | Cyclohexane | 22 |
| 33 | Particle 5 | 0.6 | 40 | 1-Propanol | 77 | Cyclohexane | 23 |
| 34 | Particle 7 | 1.2 | 40 | 1-Propanol | 78 | Cyclohexane | 22 |

In the table, “EP No.” means “Electrophotographic photosensitive member”. “Amount added” in “Particle” means “Amount added (parts by mass)”. “Temperature” means “Drying temperature”. “ST particle” means “Surface-treated particle”.

Table 9. Physical Properties of Electrophotographic Photosensitive Members 1 to 34

TABLE 9

| | Film | Volume- | Number | Volume | | Coefficient | |
|---|---|---|---|---|---|---|---|
| | thick- | average | ratio | ratio | S1/ | of | Young's |
| EP | ness | particle | [number | [volume | (S1 + | variation | modulus |
| No. | [μm] | size[nm] | %] | %] | S2) | [%] | [GPa] |
| 1 | 15 | 110.0 | 97 | 55 | 0.37 | 10 | 80 |
| 2 | 15 | 124.0 | 97 | 55 | 0.25 | 10 | 80 |
| 3 | 15 | 124.0 | 97 | 30 | 0.32 | 10 | 80 |
| 4 | 15 | 124.0 | 97 | 35 | 0.34 | 10 | 80 |
| 5 | 15 | 124.0 | 97 | 38 | 0.35 | 10 | 80 |
| 6 | 15 | 124.0 | 97 | 70 | 0.40 | 10 | 80 |
| 7 | 15 | 124.0 | 97 | 75 | 0.45 | 10 | 80 |
| 8 | 15 | 124.0 | 97 | 80 | 0.50 | 10 | 80 |
| 9 | 15 | 110.0 | 80 | 50 | 0.25 | 30 | 80 |
| 10 | 15 | 110.0 | 82 | 50 | 0.30 | 27 | 80 |
| 11 | 15 | 110.0 | 85 | 50 | 0.30 | 24 | 80 |
| 12 | 15 | 110.0 | 88 | 50 | 0.32 | 15 | 80 |
| 13 | 15 | 110.0 | 93 | 50 | 0.35 | 12 | 80 |
| 14 | 15 | 110.0 | 90 | 42 | 0.40 | 13 | 80 |
| 15 | 15 | 110.0 | 90 | 70 | 0.45 | 13 | 80 |
| 16 | 15 | 110.0 | 90 | 32 | 0.30 | 13 | 80 |
| 17 | 15 | 110.0 | 90 | 78 | 0.45 | 13 | 80 |
| 18 | 15 | 110.0 | 82 | 32 | 0.25 | 27 | 80 |
| 19 | 15 | 110.0 | 82 | 78 | 0.40 | 27 | 80 |
| 20 | 15 | 110.0 | 88 | 32 | 0.27 | 15 | 80 |
| 21 | 15 | 110.0 | 88 | 78 | 0.42 | 15 | 80 |
| 22 | 15 | 110.0 | 97 | 50 | 0.10 | 10 | 80 |
| 23 | 15 | 110.0 | 97 | 50 | 0.13 | 10 | 80 |
| 24 | 15 | 110.0 | 97 | 50 | 0.15 | 10 | 80 |
| 25 | 15 | 110.0 | 97 | 50 | 0.20 | 10 | 80 |
| 26 | 15 | 110.0 | 97 | 50 | 0.25 | 10 | 80 |
| 27 | 15 | 110.0 | 97 | 50 | 0.60 | 10 | 80 |
| 28 | 15 | 110.0 | 97 | 50 | 0.70 | 10 | 80 |
| 29 | 15 | 110.0 | 97 | 50 | 0.80 | 10 | 80 |
| 30 | 15 | 110.0 | 97 | 50 | 0.85 | 10 | 80 |
| 31 | 15 | 310.0 | 82 | 51 | 0.25 | 27 | 80 |
| 32 | 15 | 192.0 | 85 | 60 | 0.35 | 24 | 80 |
| 33 | 15 | 79.0 | 88 | 70 | 0.34 | 15 | 80 |
| 34 | 15 | 250.0 | 88 | 53 | 0.35 | 15 | 0.5 |

In the table, “EP No.” means “Electrophotographic photosensitive member”. “Film thickness [μm]” means “Film thickness of charge transport layer”. “Volume average particle size[nm]” means “Volume-average particle size of particles contained in surface layer”. “Number ratio [number %]” means “Number ratio of particle exposed from surface layer [number %]” “Volume ratio [volume %]” means “Volume ratio of particle exposed from surface layer [volume %]”. “S1/(S1 + S2)” means “Coverage ratio S1/(S1 + S2) by particles”. “Coefficient of variation [%]” means “Coefficient of variation in coverage ratio by particles”. “Young's modulus [GPa]” means “Young's modulus of particle surface”.

### Manufacturing Example of Electrophotographic Photosensitive Member 35

Production was performed in a similar manner to the production example of the charge transport layer 1 except that, in the production example of the electrophotographic photosensitive member 1, the charge transport layer coating liquid 35 was dip-coated on the charge generation layer 35 to form a coating film, and the coating film was dried at a drying temperature of 120° C. for 5 minutes to produce the charge transport layer 35 having a film thickness of 15 μm.

[Production Example 2 of Surface Layer Containing Particles] Next, the following materials were prepared.
Particle 1 (described in Table 7): 1.2 parts by mass
A charge transporting material (hole transporting material) represented by the structural formula (2-1): 0.1 parts by mass
A charge transporting material (hole transporting material) represented by the structural formula (3-1): 0.2 parts by mass
Siloxane-modified acrylic compound (trade name: SYMAC US270, manufactured by Toagosei Co., Ltd.): 0.1 parts by mass
Cyclohexane: 30 parts by mass
1-propanol: 70 parts by mass
   were mixed and stirred to prepare a surface layer coating liquid 2.

The surface layer coating liquid 2 was dip-coated on the charge transport layer 1 to form a coating film, and the obtained coating film was dried at 40° C. for 5 minutes.

Thereafter, under a nitrogen atmosphere, the coating film was irradiated with an electron beam for 1.6 seconds while rotating the support (irradiated body) at a speed of 300 rpm under the conditions of an acceleration voltage of 70 kV and a beam current of 5.0 mA. The dose at the outermost surface layer position was 15 kGy. Thereafter, the temperature was raised from 25° C. to 100° C. over 20 seconds in a nitrogen atmosphere to perform first heating, thereby forming a surface layer 32 having a film thickness of 1.0 μm. The oxygen concentration from electron beam irradiation to subsequent heat treatment was 10 ppm or less. Next, the coating film was naturally cooled until the temperature of the coating film reached 25° C. in the air, and second heat treatment for 20 minutes was performed under the condition that the temperature of the coating film was 100° C. In this way, an electrophotographic photosensitive member 37 was manufactured. The film thickness [μm] of the charge transport layer of the electrophotographic photosensitive member 37, the film thickness [μm] of the surface layer 32, the volume-average particle size [nm] of the particles contained in the surface layer 32, the number ratio [number %] of particles exposed from the surface layer 32, the volume ratio [volume %] of the particles exposed from the surface layer 32, the coverage ratio S1/(S1+S2) by the particles exposed from the surface layer 32, and the Young's modulus [GPa] of the surface of the particles exposed from the surface layer 32 were measured. The results are shown in Table 11.

### Manufacturing Examples 36 to 68 of Electrophotographic Photosensitive Member

Electrophotographic photosensitive members 36 to 68 were produced in the same manner as the electrophotographic photosensitive member 35 except that, in the production example of the electrophotographic photosensitive member 35, the temperature at which the charge transport layer coating liquid 35 was dip-coated onto the charge generation layer 35 to form a coating film and then dried in the production example of the charge transport layer 35, and the types and amounts of particles added contained in the surface layer 32, and the amount of cyclohexane and 1-propanol added in production example 2 of the surface layer 32 containing the particles were changed as shown in Table 10. Physical properties measured in the electrophotographic photosensitive members 36 to 68 are shown in Table 11.

Table 10. Details of Formulation of Electrophotographic Photosensitive Members 35 to 68

TABLE 10

| | | | Charge | | | | |
|---|---|---|---|---|---|---|---|
| | | | trans- | | | | |
| | | | port | | | | |
| | | | layer | | | | |
| | Particle | | Tem- | Dispersant | | | |
| | | A- | per- | | A- | | A- |
| EP | | mount | ature | Type | mount | Type | mount |
| No. | Type | added | [° C.] | 1 | added | 2 | added |
| 35 | Particle 1 | 1.2 | 120 | 1-Propanol | 70 | Cyclohexane | 30 |
| 36 | ST | 1.2 | 120 | 1-Propanol | 50 | Cyclo- | 50 |
| | particle 1 | | | | | hexanone | |
| 37 | ST | 1.2 | 120 | 1-Propanol | 55 | Cyclo- | 45 |
| | particle 1 | | | | | hexanone | |
| 38 | ST | 1.2 | 120 | 1-Propanol | 60 | Cyclo- | 40 |
| | particle 1 | | | | | hexanone | |
| 39 | ST | 1.2 | 120 | 1-Propanol | 65 | Cyclo- | 35 |
| | particle 1 | | | | | hexanone | |
| 40 | ST | 1.2 | 120 | 1-Propanol | 80 | Cyclo- | 20 |
| | particle 1 | | | | | hexanone | |
| 41 | ST | 1.2 | 120 | 1-Propanol | 90 | Cyclo- | 10 |
| | particle 1 | | | | | hexanone | |
| 42 | ST | 1.2 | 120 | 1-Propanol | 95 | Cyclo- | 5 |
| | particle 1 | | | | | hexanone | |
| 43 | Particie 1 | 1.2 | 120 | 1-Propanol | 50 | Cyclohexane | 50 |
| 44 | Particle 1 | 1.2 | 120 | 1-Propanol | 60 | Cyclohexane | 40 |
| 45 | Particle 1 | 1.2 | 120 | 1-Propanol | 70 | Cyclohexane | 30 |
| 46 | Particle 1 | 1.2 | 120 | 1 .-Propanol | 80 | Cyclohexane | 20 |
| 47 | Particle 1 | 1.2 | 120 | 1-Propanol | 90 | Cyclohexane | 10 |
| 48 | Particle 1 | 1.2 | 120 | 1-Propanol | 60 | Cyclohexane | 40 |
| 49 | Particle 1 | 1.2 | 120 | 1-Propanol | 80 | Cyclohexane | 20 |
| 50 | Particle 1 | 1.2 | 120 | 1-Propanol | 90 | Cyclohexane | 10 |
| 51 | Particle 1 | 1.2 | 120 | 1-Propanol | 90 | Cyclohexane | 10 |
| 52 | Particle 1 | 1.2 | 120 | 1-Propanol | 60 | Cyclohexane | 40 |
| 53 | Particie 1 | 1.2 | 120 | 1-Propanol | 60 | Cyclohexane | 40 |
| 54 | Particle 1 | 1.2 | 120 | 1-Propanol | 80 | Cyclohexane | 20 |
| 55 | Particle 1 | 1.2 | 120 | 1-Propanol | 80 | Cyclohexane | 20 |
| 56 | Particle 1 | 0.27 | 120 | 1-Propanol | 70 | Cyclohexane | 30 |
| 57 | Particle 1 | 0.3 | 120 | 1-Propanol | 70 | Cyclohexane | 30 |
| 58 | Particle 1 | 0.36 | 120 | 1-Propanol | 70 | Cyclohexane | 30 |
| 59 | Particle 1 | 0.6 | 120 | 1-Propanol | 70 | Cyclohexane | 30 |
| 60 | Particle 1 | 0.9 | 120 | 1-Propanol | 70 | Cyclohexane | 30 |
| 61 | Particle 1 | 1.02 | 120 | 1-Propanol | 70 | Cyclohexane | 30 |
| 62 | Particle 1 | 2.1 | 120 | 1-Propanol | 70 | Cyclohexane | 30 |
| 63 | Particle 1 | 2.4 | 120 | 1-Propanol | 70 | Cyclohexane | 30 |
| 64 | Particle 1 | 3.3 | 120 | 1-Propanol | 70 | Cyclohexane | 30 |
| 65 | Particle 2 | 1.8 | 120 | 1-Propanol | 77 | Cyclohexane | 23 |
| 66 | Particle 6 | 1.5 | 120 | 1-Propanol | 78 | Cyclohexane | 22 |
| 67 | Particle 5 | 0.6 | 120 | 1-Propanol | 77 | Cyclohexane | 23 |
| 68 | Particle 1 | 1.2 | 120 | 1-Propanol | 78 | Cyclohexane | 22 |

In the table, “EP No.” means “Electrophotographic photosensitive member”. “Amount added” in “Particle” means “Amount added (parts by mass)”. “Temperature” means “Drying temperature”. “ST particle” means “Surface-treated particle”.

Table 11. Physical Properties of Electrophotographic Photosensitive Members 35 to 68

TABLE 11

| | Film | Film | | Number | Volume | | Coef- | |
|---|---|---|---|---|---|---|---|---|
| | thick- | thick- | Volume- | ratio | ratio | | ficient | |
| | ness | ness | average | [num- | [vol- | S1/ | of | Young's |
| EP | A | B | particle | ber | ume | (S1 + | variation | modulus |
| No. | [μm] | [μm] | size[nm] | %] | %] | S2) | [%] | [GPa] |
| 35 | 15 | 1 | 110.0 | 97 | 55 | 0.37 | 10 | 80 |
| 36 | 15 | 1 | 124.0 | 97 | 55 | 0.25 | 10 | 80 |
| 37 | 15 | 1 | 124.0 | 97 | 30 | 0.32 | 10 | 80 |
| 38 | 15 | 1 | 124.0 | 97 | 35 | 0.34 | 10 | 80 |
| 39 | 15 | 1 | 124.0 | 97 | 38 | 0.35 | 10 | 80 |
| 40 | 15 | 1 | 124.0 | 97 | 70 | 0.40 | 10 | 80 |
| 41 | 15 | 1 | 124.0 | 97 | 75 | 0.45 | 10 | 80 |
| 42 | 15 | 1 | 124.0 | 97 | 80 | 0.50 | 10 | 80 |
| 43 | 15 | 1 | 110.0 | 80 | 50 | 0.25 | 30 | 80 |
| 44 | 15 | 1 | 110.0 | 82 | 50 | 0.30 | 27 | 80 |
| 45 | 15 | 1 | 110.0 | 85 | 50 | 0.30 | 24 | 80 |
| 46 | 15 | 1 | 110.0 | 88 | 50 | 0.32 | 15 | 80 |
| 47 | 15 | 1 | 110.0 | 93 | 50 | 0.35 | 12 | 80 |
| 48 | 15 | 1 | 110.0 | 90 | 42 | 0.40 | 13 | 80 |
| 49 | 15 | 1 | 110.0 | 90 | 70 | 0.45 | 13 | 80 |
| 50 | 15 | 1 | 110.0 | 90 | 32 | 0.30 | 13 | 80 |
| 51 | 15 | 1 | 110.0 | 90 | 78 | 0.45 | 13 | 80 |
| 52 | 15 | 1 | 110.0 | 82 | 32 | 0.25 | 27 | 80 |
| 53 | 15 | 1 | 110.0 | 82 | 78 | 0.40 | 27 | 80 |
| 54 | 15 | 1 | 110.0 | 88 | 32 | 0.27 | 15 | 80 |
| 55 | 15 | 1 | 110.0 | 88 | 78 | 0.42 | 15 | 80 |
| 56 | 15 | 1 | 110.0 | 97 | 50 | 0.10 | 10 | 80 |
| 57 | 15 | 1 | 110.0 | 97 | 50 | 0.13 | 10 | 80 |
| 58 | 15 | 1 | 110.0 | 97 | 50 | 0.15 | 10 | 80 |
| 59 | 15 | 1 | 110.0 | 97 | 50 | 0.20 | 10 | 80 |
| 60 | 15 | 1 | 110.0 | 97 | 50 | 0.25 | 10 | 80 |
| 61 | 15 | 1 | 110.0 | 97 | 50 | 0.60 | 10 | 80 |
| 62 | 15 | 1 | 110.0 | 97 | 50 | 0.70 | 10 | 80 |
| 63 | 15 | 1 | 110.0 | 97 | 50 | 0.80 | 10 | 80 |
| 64 | 15 | 1 | 110.0 | 97 | 50 | 0.85 | 10 | 80 |
| 65 | 15 | 1 | 310.0 | 82 | 51 | 0.25 | 27 | 80 |
| 66 | 15 | 1 | 192.0 | 85 | 60 | 0.35 | 24 | 80 |
| 67 | 15 | 1 | 79.0 | 88 | 70 | 0.34 | 15 | 80 |
| 68 | 15 | 1 | 250.0 | 88 | 53 | 0.35 | 15 | 0.5 |

In the table, “EP No.” means “Electrophotographic photosensitive member”. “Film thickness A [μm]” means “Film thickness of charge transport layer”. “Film thickness B [μm]” means “Film thickness of surface layer”. “Volume average particle size[nm]” means “Volume-average particle size of particles contained in surface layer”. “Number ratio [number %]” means “Number ratio of particle exposed from surface layer [number %]” “Volume ratio [volume %]” means “Volume ratio of particle exposed from surface layer [volume %]”. “S1/(S1 + S2)” means “Coverage ratio S1/(S1 + S2) by particles”. “Coefficient of variation [%]” means “Coefficient of variation in coverage ratio by particles”. “Young's modulus [GPa]” means “Young's modulus of particle surface”.

### Manufacturing Examples 69 to 82 of Electrophotographic Photosensitive Member

Electrophotographic photosensitive members 69 to 82 was produced in the same manner as in the electrophotographic photosensitive member 1 except that, in the production example of the electrophotographic photosensitive member 1, the temperature at which the charge transport layer coating liquid 1 was dip-coated onto the charge generation layer 1 to form a coating film and then dried in the production example of the charge transport layer 1, the types and amounts of particles added contained in the surface layer 32, and the amount of cyclohexane and 1-propanol added were changed as shown in Table 12. Physical properties measured in the electrophotographic photosensitive members 69 to 82 are shown in Table 13.

Table 12. Details of Formulation of Electrophotographic Photosensitive Members 69 to 82

TABLE 12

| | | | Charge | | | | |
|---|---|---|---|---|---|---|---|
| | | | trans- | | | | |
| | | | port | | | | |
| | | | layer | | | | |
| | Particle | | Tem- | Dispersant | | | |
| | | A- | per- | | A- | | A- |
| EP | | mount | ature | Type | mount | Type | mount |
| No. | Type | added | [° C.] | 1 | added | 2 | added |
| 69 | Particle 3 | 1.2 | 40 | 1-Propanol | 78 | Cyclohexane | 22 |
| 70 | Particle 4 | 1.2 | 40 | 1~Propanol | 78 | Cyclohexane | 22 |
| 71 | Particle 1 | 1.2 | 40 | 1-Propanol | 90 | Cyclohexane | 10 |
| 72 | Particle 1 | 1.2 | 40 | 1-Propanol | 90 | Cyclohexane | 10 |
| 73 | Particle 1 | 1.2 | 40 | 1-Propanol | 90 | Cyclohexane | 10 |
| 74 | Particle 1 | 1.2 | 40 | 1-Propanol | 90 | Cyclohexane | 10 |
| 75 | ST | 1.2 | 40 | 1-Propanol | 97.5 | Cyclohexane | 2.5 |
| | particle 1 | | | | | | |
| 76 | ST | 1.2 | 40 | 1-Propanol | 70 | Cyclohexane | 30 |
| | particle 1 | | | | | | |
| 77 | Particle 1 | 1.2 | 50 | 1-Propanol | 70 | Cyclo- | 30 |
| | | | | | | hexanone | |
| 78 | Particle 1 | 1.2 | 32 | 1-Propanol | 70 | Cyclo- | 30 |
| | | | | | | hexanone | |
| 79 | Particle 1 | 1.2 | 50 | 1-Propanol | 40 | Cyclo- | 60 |
| | | | | | | hexanone | |
| 80 | Particle 1 | 1.2 | 32 | 1-Propanol | 40 | Cyclo- | 60 |
| | | | | | | hexanone | |
| 81 | Particle 1 | 1.2 | 50 | 1-Propanol | 70 | Cyclo- | 30 |
| | | | | | | hexanone | |
| 82 | Particle 1 | 1.2 | 32 | 1-Propanol | 70 | Cyclo- | 30 |
| | | | | | | hexanone | |

In the table, “EP No.” means “Electrophotographic photosensitive member”.
“Amount added” in “Particle” means “Amount added (parts by mass)”. “Temperature”
means “Drying temperature”. “ST particle” means “Surface-treated particle”.

Table 13. Physical Properties of Electrophotographic Photosensitive Members 69 to 82

TABLE 13

| | Film | Volume- | Number | Volume | | Coefficient |
|---|---|---|---|---|---|---|
| | thick- | average | ratio | ratio | S1/ | of |
| EP | ness | particle | [number | [volume | (S1 + | variation |
| No. | [μm] | size[nm] | %] | %] | S2) | [%] |
| 69 | 15 | 550 | 95 | 25 | 0.32 | 80 |
| 70 | 15 | 37 | 95 | 85 | 0.33 | 80 |
| 71 | 15 | 100 | 90 | 95 | 0.33 | 80 |
| 72 | 15 | 100 | 78 | 50 | 0.34 | 80 |
| 73 | 15 | 100 | 78 | 83 | 0.34 | 80 |
| 74 | 15 | 100 | 83 | 85 | 0.33 | 80 |
| 75 | 15 | 124 | 97 | 83 | 0.35 | 80 |
| 76 | 15 | 124 | 97 | 28 | 0.35 | 80 |
| 77 | 15 | 124 | 82 | 83 | 0.35 | 80 |
| 78 | 15 | 124 | 82 | 28 | 0.35 | 80 |
| 79 | 15 | 124 | 88 | 83 | 0.35 | 80 |
| 80 | 15 | 124 | 88 | 28 | 0.35 | 80 |
| 81 | 15 | 124 | 90 | 83 | 0.35 | 80 |
| 82 | 15 | 124 | 90 | 28 | 0.35 | 80 |

In the table, “EP No.” means “Electrophotographic photosensitive member”. “Film thickness [μm]” means “Film thickness of charge transport layer”. “Volume average particle size[nm]” means “Volume-average particle size of particles contained in surface layer”. “Number ratio [number %]” means “Number ratio of particle exposed from surface layer [number %]” “Volume ratio [volume %]” means “Volume ratio of particle exposed from surface layer [volume %]”. “S1/(S1 + S2)” means “Coverage ratio S1/(S1 + S2) by particles”. “Young's modulus [GPa]” means “Young's modulus of particle surface”.

### Manufacturing Examples 83 to 96 of Electrophotographic Photosensitive Member

Electrophotographic photosensitive members 83 to 96 were produced in the same manner as the electrophotographic photosensitive member 35 except that, in the production example of the electrophotographic photosensitive member 35, the temperature at which the charge transport layer coating liquid 37 was dip-coated onto the charge generation layer 37 to form a coating film and then dried, and the types and amounts of particles added contained in the surface layer 32, and the amount of cyclohexane and 1-propanol added in production example 2 of the surface layer 32 containing the particles were changed as shown in Table 14. Physical properties measured in the electrophotographic photosensitive members 83 to 96 are shown in Table 15.

### Manufacturing Example 97 of Electrophotographic Photosensitive Member

An electrophotographic photosensitive member 24 was produced in the same manner as the electrophotographic photosensitive member 1 except that the drying temperature and the drying time in production example 1 of the charge transport layer 1 were changed to 130° C. and 20 minutes in the manufacturing example of the electrophotographic photosensitive member 1. Physical properties measured in the electrophotographic photosensitive member 97 are shown in Table 15.

### Manufacturing Example 98 of Electrophotographic Photosensitive Member

An electrophotographic photosensitive member 98 was produced in the same manner as the electrophotographic photosensitive member 35 except that the particles 1 were not added in [production example 2 of surface layer containing particles] in the manufacturing example of the electrophotographic photosensitive member 35. Physical properties measured in the electrophotographic photosensitive member 98 are shown in Table 15.

Table 14. Details of Formulation of Electrophotographic Photosensitive Members 83 to 98

TABLE 14

| | | | Charge | | | | |
|---|---|---|---|---|---|---|---|
| | | | trans- | | | | |
| | | | port | | | | |
| | | | layer | | | | |
| | Particle | | Tem- | Dispersant | | | |
| | | A- | per- | | A- | | A- |
| EP | | mount | ature | Type | mount | Type | mount |
| No. | Type | added | [° C.] | 1 | added | 2 | added |
| 83 | Particle 3 | 1.2 | 120 | 1 . Propanol | 78 | Cyclohexane | 22 |
| 84 | Particle 4 | 1.2 | 120 | 1-Propanol | 78 | Cyclohexane | 22 |
| 85 | Particle 1 | 1.2 | 120 | 1-Propanol | 90 | Cyclohexane | 10 |
| 86 | Particle 1 | 1.2 | 120 | 1-Propanol | 90 | Cyclohexane | 10 |
| 87 | Particle 1 | 1.2 | 120 | 1-Propanol | 90 | Cyclohexane | 10 |
| 88 | Particle 1 | 1.2 | 120 | 1-Propanol | 90 | Cyclohexane | 10 |
| 89 | ST | 1.2 | 120 | 1-Propanol | 70 | Cyclohexane | 30 |
| | particle 1 | | | | | | |
| 90 | ST | 1.2 | 120 | 1-Propanol | 70 | Cyclo- | 30 |
| | particle 1 | | | | | hexanone | |
| 91 | Particle 1 | 1.2 | 120 | 1-Propanol | 70 | Cyclo- | 30 |
| | | | | | | hexanone | |
| 92 | Particle 1 | 1.2 | 120 | 1-Propanol | 70 | Cyclo- | 30 |
| | | | | | | hexanone | |
| 93 | Particle 1 | 1.2 | 120 | 1-Propanol | 40 | Cyclo- | 60 |
| | | | | | | hexanone | |
| 94 | Particle 1 | 1.2 | 120 | 1-Propanol | 40 | Cyclo- | 60 |
| | | | | | | hexanone | |
| 95 | Particle 1 | 1.2 | 120 | 1-Propanol | 70 | Cyclo- | 30 |
| | | | | | | hexanone | |
| 96 | Particle 1 | 1.2 | 120 | 1 · Propanol | 70 | Cyclo- | 30 |
| | | | | | | hexanone | |
| 97 | — | — | 130 | 1-Propanol | 70 | Cyclohexane | 30 |
| 98 | — | — | 120 | 1-Propanol | 70 | Cyclohexane | 30 |

In the table, “EP No.” means “Electrophotographic photosensitive member”.
“Amount added” in “Particle” means “Amount added (parts by mass)”. “Temperature”
means “Drying temperature”. “ST particle” means “Surface-treated particle”.

Table 15. Physical Properties of Electrophotographic Photosensitive Members 83 to 98

TABLE 15

| | Film | Film | Volume- | Number | Volume | | Coefficient | |
|---|---|---|---|---|---|---|---|---|
| | thick- | thick- | average | ratio | ratio | S1/ | of | Young's |
| EP | ness A | ness B | particle | [number | [volume | (S1 + | variation | modulus |
| No. | [μm] | [μm] | size[nm] | %] | %] | S2) | [%] | [GPa] |
| 83 | 15 | 1 | 550 | 95 | 25 | 0.32 | Not measured | 80 |
| 84 | 15 | 1 | 37 | 95 | 85 | 0.6 | Not measured | 80 |
| 85 | 15 | 1 | 100 | 90 | 95 | 0.55 | Not measured | 80 |
| 86 | 15 | 1 | 100 | 78 | 50 | 0.24 | Not measured | 80 |
| 87 | 15 | 1 | 100 | 78 | 83 | 0.39 | Not measured | 80 |
| 88 | 15 | 1 | 100 | 83 | 85 | 0.45 | Not measured | 80 |
| 89 | 15 | 1 | 124 | 97 | 83 | 0.52 | Not measured | 80 |
| 90 | 15 | 1 | 124 | 97 | 28 | 0.31 | Not measured | 80 |
| 91 | 15 | 1 | 124 | 82 | 83 | 0.47 | Not measured | 80 |
| 92 | 15 | 1 | 124 | 82 | 28 | 0.23 | Not measured | 80 |
| 93 | 15 | 1 | 124 | 88 | 83 | 0.44 | Not measured | 80 |
| 94 | 15 | 1 | 124 | 88 | 28 | 0.22 | Not measured | 80 |
| 95 | 15 | 1 | 124 | 90 | 83 | 0.45 | Not measured | 80 |
| 96 | 15 | 1 | 124 | 90 | 28 | 0.28 | Not measured | 80 |
| 97 | 15 | 0 | — | 0 | 0 | — | Not measured | — |
| 98 | 15 | 1 | — | 0 | 0 | — | Not measured | — |

In the table, “EP No.” means “Electrophotographic photosensitive member”. “Film thickness A [μm]” means “Film thickness of charge transport layer”. “Film thickness B [μm]” means “Film thickness of surface layer”. “Volume average particle size[nm]” means “Volume-average particle size of particles contained in surface layer”. “Number ratio [number %]” means “Number ratio of particle exposed from surface layer [number %]” “Volume ratio [volume %]” means “Volume ratio of particle exposed from surface layer [volume %]”. “S1/(S1 + S2)” means “Coverage ratio S1/(S1 + S2) by particles”. “Coefficient of variation [%]” means “Coefficient of variation in coverage ratio by particles”. “Young's modulus [GPa]” means “Young's modulus of particle surface”.

### (Configuration of Image Forming Apparatus)

In the image forming apparatus shown in FIG. 9, an image forming apparatus 1, an image forming apparatus 2, and an image forming apparatus 3 having different longitudinal widths of a roller on which the intermediate transfer belt 8 is stretched are prepared. The longitudinal widths of various members and rollers are shown in Table 16. Since the image forming apparatus of the present embodiment is compatible with legal-sized paper, images can be formed on paper up to 216 mm wide, and the longitudinal width of the primary transfer roller 6 is 216 mm or more in any of the image forming apparatuses 1, 2, and 3. Similarly, since it is necessary to reliably perform secondary transfer with respect to the paper width also in the counter roller 28, the longitudinal width is set to 216 mm or more in any of the image forming apparatuses 1, 2, and 3. The tension roller 10 also has a width close to the width of the intermediate transfer belt in order to stably tension and stretch the belt over the entire width of the belt.

On the other hand, as the width of the driving roller 9 decreases with respect to the intermediate transfer belt 8, a deviation force acts in a direction of returning the deviation when belt deviation occurs in the longitudinal direction, which is advantageous for belt damage, and thus the driving roller 9 has a relationship in which the longitudinal width is the smallest among the three stretching rollers.

In the image forming apparatus 1, the primary transfer roller width and the minimum width of the roller that stretches the intermediate transfer belt 8 has a relationship of

primary transfer roller width<minimum width of stretching roller.

In the image forming apparatuses 2 and 3, a relationship of

primary transfer roller width>minimum width of the stretching roller
is established. In the image forming apparatus 2, the minimum width of the stretching roller is larger than 216 mm, which is the width in which an image can be formed, and is equal to the width of the charging roller. Furthermore, in the image forming apparatus 3, the minimum width of the stretching roller is set to be smaller than 216 mm which is the width in which an image can be formed.

Table 16. Configuration of Image Forming Apparatuses 1 to 3

TABLE 16

| | Photo- | | Develo- | Intermediate | Driving | Tension | Counter | Primary |
|---|---|---|---|---|---|---|---|---|
| Image | sensitive | Charging | ping | transfer | roller | roller | roller | transfer |
| forming | drum 1 | roller 2 | roller 3 | belt 8 | 9 | 10 | 28 | roller |
| apparatus | [mm] | [mm] | [mm] | [mm] | [mm] | [mm] | [mm] | 6 [mm] |
| 1 | 255 | 230 | 235 | 250 | 230 | 245 | 238 | 220 |
| 2 | 255 | 230 | 235 | 250 | 230 | 245 | 238 | 234 |
| 3 | 255 | 230 | 235 | 250 | 206 | 245 | 238 | 220 |

### (Evaluation Method)

The effects of the present embodiment were confirmed under the following conditions. In the image forming apparatus shown in FIG. 9, the electrophotographic photosensitive members 1 to 98 were attached, and durability tests were performed in which an image was actually formed on a large number of recording materials to check transfer performance at the initial stage of durability and after durability, and presence or absence of a durability problem.

### <Transfer Performance Evaluation Method>

Under an environment of a temperature of 25° C. and a humidity of 50%, a black image was formed on the entire area in the process cartridge PK, and the transfer residual toner on the photosensitive drum after passing through the primary transfer nip was taped using a transparent polyester adhesive tape to acquire. The adhesive tape was attached onto paper, the density was measured with an X-Rite color reflection densitometer (X-rite 500 Series manufactured by X-rite), and the toner amount of the transfer residual toner was quantitatively ascertained as a density. Incidentally, the density corresponding to the amount of pure toner was acquired by subtracting the density of the toner on the paper with only the adhesive tape attached, and density measurement was performed at five positions uniformly in the longitudinal width direction to obtain an average value. On the basis of the density of the transfer residual toner, the transfer performance was ranked according to the following evaluation criteria.

### [Evaluation Criteria]

A: Transfer residual density is less than 0.20
B: Transfer residual density is 0.20 or more and less than 0.50
C: Transfer residual density is 0.50 or more and less than 1.0
D: Transfer residual density is 1.0 or more

### <Durability Method>

Under an environment of a temperature of 25° C. and a humidity of 50%, 2000 sheets of text images having a print percentage of 1% were fed in a day for each color process cartridge, and sheet passing durability test was performed up to 50,000 sheets. In the sheet passing durability test, A4 size GF-C081 (manufactured by Canon Inc.) was used as a recording material. The sheet passing durability was evaluated by combining the configurations of the image forming apparatuses 1, 2, and 3 and the respective photosensitive drum configurations.

After the durability test, the transfer performance was evaluated in the same manner as in the initial stage, and durability change in the transfer performance was checked. In addition, for the purpose of detecting an image defect due to partial damage of the photosensitive drum 1, an image of a black halftone (toner applied amount: 0.2 mg/cm²) was printed out, and uniformity of the image, presence or absence of a partial defect, and the like were checked. Furthermore, the surface layer 32 of the photosensitive drum 1 was observed at a magnification of 30,000 times using a scanning electron microscope (SEM) (“S-4800” manufactured by JEOL Ltd.), and the presence or absence of occurrence of partial damage of a protruding shape or holes due to detachment of particles was checked.

### [Evaluation Criteria]

A: No halftone image defect, no photosensitive drum defect
B: No halftone image defect, occurrence of change in protruding shape
C: No halftone image defect, hole generation due to particle detachment
D: Presence of halftone image defect

### (Evaluation Results)

Tables 11 to 14 show the relationship between evaluation results of initial transferability, post-durability transferability, and damage to the photosensitive drum 1 after durability when the electrophotographic photosensitive members 1 to 98 are durable in combination with the image forming apparatuses 1 to 3, and the physical properties of the photosensitive drum.

### <Improvement in Transfer Performance by Particle-Containing Effect>

The transfer residue was rank D even in the initial stage in the electrophotographic photosensitive members 97 and 98 containing no particles, whereas, in the other electrophotographic photosensitive members, there was a rank difference due to the formulation of the photosensitive drum 1 and the physical properties of the obtained surface, but an effect of improving the transfer residue to rank C or higher was obtained both in the initial stage and after durability in the electrophotographic photosensitive members 1 to 68.

### <Improvement in Transfer Performance by Effect of Volume-Average Particle Size>

In the electrophotographic photosensitive members 69 and 83 using the particles 3 having a large particle size and having a volume-average particle size of 550 nm, the transfer residue was rank D even in the initial stage, and the transferability was not improved.

In the electrophotographic photosensitive members 70 and 84 using the particles 4 having a small particle size and having a volume-average particle size of 37 nm, the transfer residue was rank D even in the initial stage, and the transferability was not improved.

In the electrophotographic photosensitive members 1 to 68 using the particles 1, 2, 5, and 6 and the surface-treated particle 1, an effect of improving transfer performance was confirmed, and it was confirmed that a range excluding 37 nm or less and 550 nm or more as a volume-average particle size is suitable for improving transfer performance. More preferably, the volume-average particle size is at least 50 nm and not more than 350 nm.

### <Achievement of Both Transfer Performance and Durability by Volume Ratio of Exposed Particles>

In the electrophotographic photosensitive members 69, 76, 78, 80, 82, 83, 90, 92, 94, and 96 in which the exposure ratio was low and less than 30 vol % with respect to the proportion of the volume of the exposed particles to the volume of the particles contained in the surface layer 32, the transfer residue was rank D even in the initial stage, and the transferability was not improved.

On the other hand, in the electrophotographic photosensitive members 71, 73, 74, 75, 77, 79, 81, 85, 87, 88, 89, 91, 93, and 95 having a high exposure ratio exceeding 80 vol %, transferability after durability is rank D, and there is a problem in durability.

Therefore, in the range in which the proportion of the number of exposed particle to the number of all particles in the surface layer is 80 number % or more, confirmed in the present embodiment, it was confirmed that the range in which the proportion of the volume of exposed particles to the volume of all particles is 30 to 80 vol % is suitable from the viewpoint of both improvement in transferability and durability performance.

### <Improvement in Transfer Performance by Particle Coverage Ratio S1/(S1+S2)>

In the electrophotographic photosensitive members 22, 23, 56, and 57 in which the coverage ratio S1/(S1+S2) of the particles in the surface layer was low and lower than 0.13, the transfer residue was rank C even at the initial stage, and the effect of improving transferability was insignificant.

On the other hand, in the electrophotographic photosensitive members 30 and 64 having a high coverage ratio S1/(S1+S2) of 0.85, the initial transfer residue was also rank C, and the effect of improving the transferability was insignificant.

Therefore, it was confirmed that the coverage ratio S1/(S1+S2) of the particles in the surface layer is more preferably in a range excluding 0.13 or less and 0.85 or more as in the following formula (A).

$$0.13 < S 1 / ( S 1 + S 2 ) < 0.85 \qquad Formula ( A )$$

More preferably, the following formula (B) is satisfied.

$$0.15 \leq S 1 / ( S 1 + S 2 ) \leq 0.8 \qquad Formula ( B )$$

### <Achievement of Both Transfer Performance and Durability by Coefficient of Variation in Coverage Ratio>

In the electrophotographic photosensitive members 18, 19, 31, 52, 53, and 65 in which the coefficient of variation in the coverage ratio of the particles contained in the surface layer 32 was high and 27% or more, the transfer residue at the initial stage or after durability was rank C, and the effect of improving transferability throughout durability was insignificant. Therefore, it was confirmed that the coefficient of variation in the coverage ratio of the particles contained in the surface layer 32 is more preferably less than 26%.

### <Improvement in Transfer Performance by Young's Modulus of Particle Surface>

In the electrophotographic photosensitive members 34 and 68 using the particles 7, the transfer residue was rank C even at the initial stage, and the effect of improving transferability was insignificant. It is considered that the Young's modulus of the surface of exposed particles was 0.5 GPa, which was lower than those of the electrophotographic photosensitive members of other examples, and the effect of reducing the contact area with the toner was limited. Therefore, it was confirmed that the Young's modulus of the particle surface is more preferably more than 0.5 GPa.

### <Maintenance of Durability by Configuration of Image Forming Apparatus>

In the configuration of the image forming apparatus 1, although changes in some protruding shapes were observed in the electrophotographic photosensitive members 1 to 68, no image defect occurred, and appropriate image quality could be obtained even after durability.

On the other hand, in the electrophotographic photosensitive members 70, 71, 73, 74, 75, 77, 79, 81, 84, 85, 87, 88, 89, 91, 93, and 95 in which the exposure ratio was high and exceeded 80 vol %, a state in which particles were detached after durability was observed.

In addition, in the electrophotographic photosensitive members 7, 8, 17, 19, 21, 41, 42, 51, 53, and 55 in which image defects did not occur but the exposure ratio was high and 70 vol % or more, deformation of a protruding shape was observed, and it was confirmed that the volume ratio of exposure to the total particle volume was 80 vol % or less, more preferably 70 vol % or less from the viewpoint of image quality after durability and damage on the surface of the photosensitive drum.

Also in the configuration of the image forming apparatus 2, a state in which particles are detached was observed in the electrophotographic photosensitive members 70, 71, 73, 74, 75, 77, 79, 81, 84, 85, 87, 88, 89, 91, 93, and 95 and the electrophotographic photosensitive members 7, 8, 17, 19, 21, 41, 42, 51, 53, and 55 having a high exposed volume ratio.

The location where damage occurred was the end portions of the charging roller 2 and the driving roller 9, and was 115 mm from the longitudinal center, where detachment was noticeable.

In the configuration of the image forming apparatus 3, image defects due to vertical streak-shaped density unevenness occurred in the electrophotographic photosensitive members 70, 71, 73, 74, 75, 77, 79, 81, 84, 85, 87, 88, 89, 91, 93, and 95 and the electrophotographic photosensitive members 7, 8, 17, 19, 21, 41, 42, 51, 53, and 55 having a high exposed volume ratio.

The image defect occurrence position was the end portion of the driving roller 9, and was 103 mm from the longitudinal center, and detachment was noticeable even on the surface of the photosensitive drum. The vertical streak-shaped density unevenness is considered to have led to unevenness in image density as a result of partial deterioration in transfer performance due to detachment of particles at a position corresponding to the end portion of the driving roller 9.

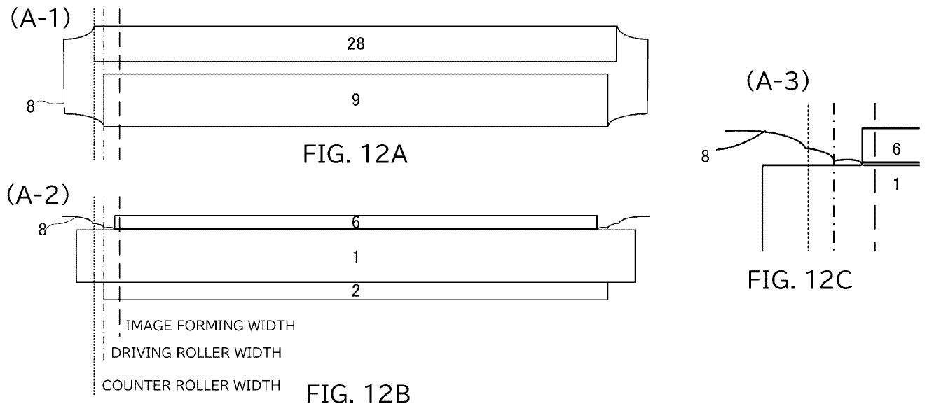

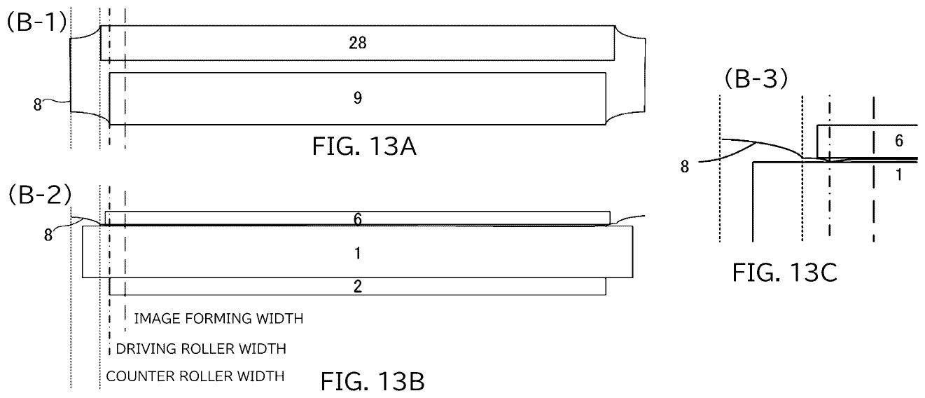

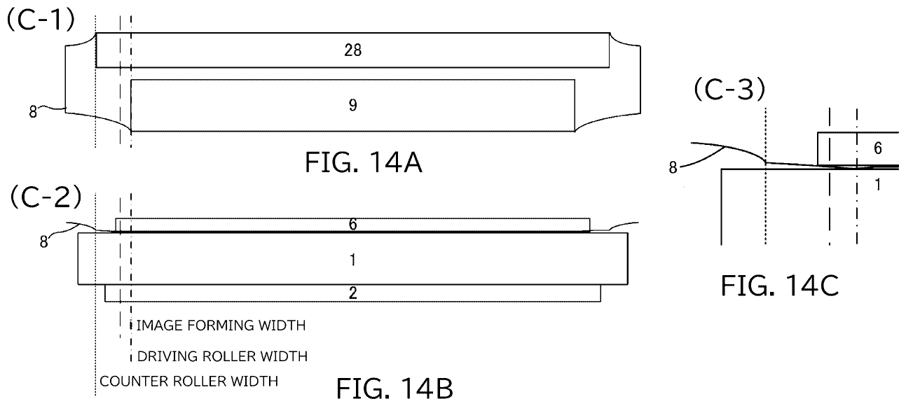

FIGS. 12A to 12C, 13A to 13C, and 14A to 14C are conceptual diagrams illustrating stretched and deformed states of the intermediate transfer belt 8. In FIGS. 12A to 12C, state (A-1) to (A-3) of the image forming apparatus 1 are described. In FIGS. 13A to 13C, state (B-1) to (B-3) of the image forming apparatus 2 are described. In FIGS. 14A to 14C, state (C-1) to (C-3) of the image forming apparatus 3 are described. FIGS. 12A (state (A-1)), 13A (state (B-1)), and 14A (state (C-1)) illustrate stretched and deformed states of the intermediate transfer belt 8 with respect to the counter roller 28 and the driving roller 9 as viewed from the right side of FIG. 9 (from the direction of arrow LK1). Since the longitudinal width of the intermediate transfer belt 8 is longer than the longitudinal width of each stretching roller, and as a result of the belt being pulled in the left direction of FIG. 9 by the tension roller 10, the belt is stretched while being deformed as illustrated in FIGS. 12A (state (A-1)), 13A (state (B-1)), and 14A (state (C-1)) at the end portion of each stretching roller. If the intermediate transfer belt 8 is left in this state for a long time, the intermediate transfer belt 8 contracts, curling in a state where the belt is deformed occurs, and a step due to the curling is formed.

FIGS. 12B (state (A-2)), 13B (state (B-2)), and 14B (state (C-2)) illustrate a state in which the intermediate transfer belt 8 is wound around the photosensitive drum 1 at the primary transfer nip portion as viewed from the right side of FIG. 9 (from the direction of arrow LK2). In each figure, it can be seen that the magnitude relationship of the lengths in the longitudinal direction of the primary transfer roller 6, the photosensitive drum 1, and the charging roller 2 is as shown in Table 16.

In FIGS. 12C (state (A-3)), 13C (state (B-3)), and 14C (state (C-3)), an end portion of the primary transfer roller 6 in FIGS. 12B (state (A-2)), 13B (state (B-2)), and 14B (state (C-2)) are illustrated in an enlarged manner. Further, the cross section of the intermediate transfer belt 8 at the timing when the phase at which curling at the longitudinal end portion of the driving roller 9 is formed reaches the primary transfer nip portion is illustrated.

When a printing operation is performed in this state, as shown in FIGS. 12B (state (A-2)), 13B (state (B-2)), and 14B (state (C-2)) and FIGS. 12C (state (A-3)), 13C (state (B-3)), and 14C (state (C-3)), the intermediate transfer belt 8 passes through the primary transfer nip with the curl shape. In addition, the curl step is eliminated in the process of continuing the printing operation, but since it takes time for the step to disappear, the intermediate transfer belt 8 repeatedly passes through the primary transfer nip.

In the configurations of the image forming apparatuses 2 and 3 illustrated in FIGS. 13B (state (B-2)), 14B (state (C-2)), 13C (state (B-3)), and 14C (state (C-3)), a curl step due to the driving roller 9 exists inside of the longitudinal width of the primary transfer roller 6. Therefore, when passing through the primary transfer nip, the curl step strongly rubs the surface of the photosensitive drum 1. It is considered that as a result of repeated rubbing through durability, detachment of particles in the surface layer and occurrence of vertical streak-shaped density unevenness were caused.

On the other hand, in the configuration of the image forming apparatus 1 illustrated in FIGS. 12B (state (A-2)) and 12C (state (A-3)), since the curl step is outside of the primary transfer roller 6, the curl step does not rub the surface of the photosensitive drum 1 when passing through the primary transfer nip.

As described above, it was confirmed that a configuration in which the width of the transfer member is less than the stretching roller width is suitable in the image forming apparatus that can be combined with the process cartridge using the photosensitive drum 1 containing particles in the surface layer.

The effects of the present invention can be obtained as long as the width of the transfer member is less than the width of at least one of the stretching rollers included in the plurality of stretching rollers (driving roller 9, tension roller 10, counter roller 28, and the like). For example, in the configuration of the image forming apparatus 2 illustrated in FIG. 13, the width of the transfer roller 6 is less than that of the counter roller 28 but greater than that of the driving roller 9. Even with such a configuration, for example, as shown in Table 17, an image with less image defects than that in the case of using the image forming apparatus 3 shown in FIG. 14 is obtained (examples 7, 8, 17, 19, and 21). This is considered to be because in the image forming apparatus 2, the relationship of image forming width<driving roller 9 is satisfied.

Furthermore, in the image forming apparatus 1 illustrated in FIG. 12, the width of the transfer member is less than the width of either the driving roller 9 or the counter roller 28. According to such a configuration, as shown in Table 17, a more preferable effect can be obtained (examples 7, 8, 17, 19, 21).

In the present example, a so-called drum cleaner-less system without having a primary transfer residual toner cleaning means as illustrated in FIG. 9 is used, but a primary transfer residual toner cleaning means may be provided. For example, the effects of the present invention can also be obtained by a so-called blade cleaning system in which a rubber blade is brought into contact with the photosensitive drum 1 to collect primary transfer residual toner.

Further, in the present example, the metal shaft is used as the primary transfer member, but as long as the primary transfer nip is formed by bringing the intermediate transfer belt 8 into contact with the photosensitive drum 1, the same effect can be obtained by using other members. Specifically, the effects of the present invention can also be obtained in a configuration in which the intermediate transfer belt 8 is pushed up and brought into contact with the photosensitive drum 1 by using a rubber roller, a resin roller, a fiber brush, a pad, or the like as the primary transfer member.

In the present example, only the layer configuration using the laminated photosensitive layer shown in FIGS. 10A and 10B has been described. As described above, in the layer configuration using the monolayer type photosensitive layer shown in FIG. 10C, the degree of difficulty in controlling arrangement of particles is high, but the same effect can be obtained even in the monolayer type photosensitive layer when the arrangement is controlled within the range defined in the present invention.

Table 17 to Table 20. Evaluation Results of Image Forming Apparatus Using Photosensitive Drum 1

TABLE 17

| | | | | | | | physical properties | | | | | |
|---|---|---|---|---|---|---|---|---|---|---|---|---|
| | | | Trans- | | | | | | | | Coeffi- | |
| | | | ferability | | | | Volume- | Number | Volume | | cient | |
| | | Initial | after | | | | average | ratio | ratio | | of | Young's |
| Exam- | EP | transfe- | dura- | Damage | | | particle | [number | [volume | S1/ | variation | modulus |
| ple | No. | rability | bility | IF1 | IF2 | IF3 | size[nm] | %] | %] | (S1 + S2) | [%] | [GPa] |
| 1 | 1 | A | A | A | A | A | 110 | 97 | 65 | 0.37 | 10 | 80 |
| 2 | 2 | A | A | A | A | A | 124 | 97 | 55 | 0.25 | 10 | 80 |
| 3 | 3 | A | A | A | A | A | 124 | 97 | 30 | 0.32 | 10 | 80 |
| 4 | 4 | A | A | A | A | A | 124 | 97 | 35 | 0.34 | 10 | 80 |
| 5 | 5 | A | A | A | A | A | 124 | 97 | 38 | 0.35 | 10 | 80 |
| 6 | 6 | A | B | A | A | A | 124 | 97 | 70 | 0.40 | 10 | 80 |
| 7 | 7 | A | C | B | C | D | 124 | 97 | 75 | 0.45 | 10 | 80 |
| 8 | 8 | A | C | B | C | D | 124 | 97 | 80 | 0.50 | 10 | 80 |
| 9 | 9 | A | A | A | A | A | 110 | 80 | 50 | 0.25 | 30 | 80 |
| 10 | 10 | A | A | A | A | A | 110 | 82 | 50 | 0.30 | 27 | 80 |
| 11 | 11 | B | B | A | A | A | 110 | 85 | 50 | 0.30 | 24 | 80 |
| 12 | 12 | B | B | A | A | A | 110 | 88 | 50 | 0.32 | 15 | 80 |
| 13 | 13 | A | A | A | A | A | 110 | 93 | 50 | 0.35 | 12 | 80 |
| 14 | 14 | A | A | A | A | A | 110 | 90 | 42 | 0.40 | 13 | 80 |
| 15 | 15 | A | B | A | A | A | 110 | 90 | 70 | 0.46 | 13 | 80 |
| 16 | 16 | B | A | A | A | A | 110 | 90 | 32 | 0.30 | 13 | 80 |
| 17 | 17 | A | C | B | C | D | 110 | 90 | 78 | 0.45 | 13 | 80 |
| 18 | 18 | C | C | A | A | A | 110 | 82 | 32 | 0.25 | 27 | 80 |
| 19 | 19 | A | C | B | C | D | 110 | 82 | 78 | 0.40 | 27 | 80 |
| 20 | 20 | B | B | A | A | A | 110 | 88 | 32 | 0.27 | 15 | 80 |
| 21 | 21 | B | C | B | C | D | 110 | 88 | 78 | 0.42 | 15 | 80 |
| 22 | 22 | C | C | A | A | A | 110 | 97 | 50 | 0.10 | 10 | 80 |
| 23 | 23 | C | C | A | A | A | 110 | 97 | 50 | 0.13 | 10 | 80 |
| 24 | 24 | C | C | A | A | A | 110 | 97 | 50 | 0.15 | 10 | 80 |
| 25 | 25 | B | B | A | A | A | 110 | 97 | 50 | 0.20 | 10 | 80 |

In the table 17, “EP No.” means “Electrophotographic photosensitive member”. “Damage” means “Image defects after durability, damage of protruded shape”. “IF 1 to 3” means “Image forming apparatus 1 to 3”. “Physical properties” means “Photosensitive drum physical properties”. “Volume-average particle size[nm]” means “Volume-average particle size of particles contained in surface layer”. “Number ratio [number %]” means “Number ratio of particle exposed from surface layer [number %]”. “Volume ratio [volume %]” means “Volume ratio of particle exposed from surface layer [volume %]”. “S1/(S1 + S2)” means “Coverage ratio S1/(S1 + S2) by particles”. “Coefficient of variation [%]” means “Coefficient of variation in coverage ratio by particles”. “Young's modulus [GPa]” means “Young's modulus of particle surface”.
“N/M” means “Not measured”.

TABLE 18

| | | | | | | | physical properties | | | | | |
|---|---|---|---|---|---|---|---|---|---|---|---|---|
| | | | Trans- | | | | | | | | Coeffi- | |
| | | | ferability | | | | Volume- | Number | Volume | | cient | |
| | | Initial | after | | | | average | ratio | ratio | | of | Young's |
| Exam- | EP | transfe- | dura- | Damage | | | particle | [number | [volume | S1/ | variation | modulus |
| ple | No. | rability | bility | IF1 | IF2 | IF3 | size[mm] | %] | %] | (S1 + S2) | [%] | [GPa] |
| 26 | 26 | A | A | A | A | A | 110 | 97 | 50 | 0.25 | 10 | 80 |
| 27 | 27 | A | A | A | A | A | 110 | 97 | 50 | 0.60 | 10 | 80 |
| 28 | 28 | B | S | A | A | A | 110 | 97 | 50 | 0.70 | 10 | 80 |
| 29 | 29 | B | B | A | A | A | 110 | 97 | 50 | 0.80 | 10 | 80 |
| 30 | 30 | C | C | A | A | A | 110 | 97 | 50 | 0.85 | 10 | 80 |
| 31 | 31 | C | C | A | A | A | 310 | 82 | 51 | 0.25 | 27 | 80 |
| 32 | 32 | A | B | A | A | A | 192 | 85 | 60 | 0.35 | 24 | 80 |
| 33 | 33 | A | B | A | A | A | 79 | 88 | 70 | 0.34 | 15 | 80 |
| 34 | 34 | C | C | B | B | B | 250 | 88 | 53 | 0.35 | 15 | 0.5 |
| 35 | 35 | A | A | A | A | A | 110 | 97 | 55 | 0.37 | 10 | 80 |
| 36 | 36 | A | A | A | A | A | 124 | 97 | 55 | 0.25 | 10 | 80 |
| 37 | 37 | A | A | A | A | A | 124 | 97 | 30 | 0.32 | 10 | 80 |
| 38 | 38 | A | A | A | A | A | 124 | 97 | 35 | 0.34 | 10 | 80 |
| 39 | 39 | A | A | A | A | A | 124 | 97 | 38 | 0.35 | 10 | 80 |
| 40 | 40 | A | B | A | A | A | 124 | 97 | 70 | 0.40 | 10 | 80 |
| 41 | 41 | A | B | B | C | D | 124 | 97 | 75 | 0.45 | 10 | 80 |
| 42 | 42 | A | C | B | C | D | 124 | 97 | 80 | 0.50 | 10 | 80 |
| 43 | 43 | A | A | A | A | A | 110 | 80 | 50 | 0.25 | 30 | 80 |
| 44 | 44 | A | A | A | A | A | 110 | 82 | 50 | 0.30 | 27 | 80 |
| 45 | 45 | B | B | A | A | A | 110 | 85 | 50 | 0.30 | 24 | 80 |
| 46 | 46 | B | B | A | A | A | 110 | 88 | 50 | 0.32 | 15 | 80 |
| 47 | 47 | A | A | A | A | A | 110 | 93 | 50 | 0.35 | 12 | 80 |
| 48 | 48 | A | A | A | A | A | 110 | 90 | 42 | 0.40 | 13 | 80 |
| 49 | 49 | A | B | A | A | A | 110 | 90 | 70 | 0.45 | 13 | 80 |
| 50 | 50 | B | A | A | A | A | 110 | 90 | 32 | 0.3 | 13 | 80 |

In the table 18, “EP No.” means “Electrophotographic photosensitive member”. “Damage” means “Image defects after durability, damage of protruded shape”. “IF 1 to 3” means “Image forming apparatus 1 to 3”. “Physical properties” means “Photosensitive drum physical properties”. “Volume-average particle size[nm]” means “Volume-average particle size of particles contained in surface layer”. “Number ratio [number %]” means “Number ratio of particle exposed from surface layer [number %]”. “Volume ratio [volume %]” means “Volume ratio of particle exposed from surface layer [volume %]”. “S1/(S1 + S2)” means “Coverage ratio S1/(S1 + S2) by particles”. “Coefficient of variation [%]” means “Coefficient of variation in coverage ratio by particles”. “Young's modulus [GPa]” means “Young's modulus of particle surface”.

TABLE 19

| Exam- | | | | | | | | | | | | |
|---|---|---|---|---|---|---|---|---|---|---|---|---|
| ple | | | | | | | physical properties | | | | | |
| (E)/ | | | Trans- | | | | | | | | Coeffi- | |
| Compar- | | | ferability | | | | Volume- | Number | Volume | | cient | |
| ative | | Initial | after | | | | average | ratio | ratio | | of | Young's |
| example | EP | transfe- | dura- | Damage | | | particle | [number | [volume | S1/ | variation | modulus |
| (CE) | No. | rability | bility | IF1 | IF2 | IF3 | size[mm] | %] | %] | (S1 + S2) | [%] | [GPa] |
| E 51 | 51 | A | B | B | C | D | 110 | 90 | 78 | 0.45 | 13 | 80 |
| E 52 | 52 | C | C | A | A | A | 110 | 82 | 32 | 0.25 | 27 | 80 |
| E 53 | 53 | A | C | B | C | D | 110 | 82 | 78 | 0.40 | 27 | 80 |
| E 54 | 54 | B | B | A | A | A | 110 | 88 | 32 | 0.27 | 15 | 80 |
| E 55 | 55 | B | C | B | C | D | 110 | 88 | 78 | 0.42 | 15 | 80 |
| E 56 | 56 | C | C | A | A | A | 110 | 97 | 50 | 0.10 | 10 | 80 |
| E 57 | 57 | C | C | A | A | A | 110 | 97 | 50 | 0.13 | 10 | 80 |
| E 58 | 58 | C | C | A | A | A | 110 | 97 | 50 | 0.15 | 10 | 80 |
| E 59 | 59 | B | B | A | A | A | 110 | 97 | 50 | 0.20 | 10 | 80 |
| E 60 | 60 | A | A | A | A | A | 110 | 97 | 50 | 0.25 | 10 | 80 |
| E 61 | 31 | A | A | A | A | A | 110 | 97 | 50 | 0.60 | 10 | 80 |
| E 62 | 62 | B | B | A | A | A | 110 | 97 | 50 | 0.70 | 10 | 80 |
| E 63 | 63 | B | B | A | A | A | 110 | 97 | 50 | 0.80 | 10 | 80 |
| E 64 | 54 | C | C | A | A | A | 110 | 97 | 50 | 0.85 | 10 | 80 |
| E 65 | 65 | C | C | A | A | A | 310 | 82 | 51 | 0.25 | 27 | 80 |
| E 66 | 66 | A | B | A | A | A | 192 | 85 | 60 | 0.35 | 24 | 80 |
| E 67 | 67 | A | B | A | A | A | 79 | 88 | 70 | 0.34 | 15 | 80 |
| E 68 | 68 | C | C | B | B | B | 250 | 88 | 53 | 0.35 | 3.5 | 0.5 |
| CE 1 | 69 | D | D | A | A | A | 550 | 95 | 25 | 0.32 | N/M | 80 |
| CE 2 | 70 | D | D | C | C | D | 37 | 95 | 85 | 0.33 | N/M | 80 |
| CE 3 | 71 | A | D | C | C | D | 100 | 90 | 95 | 0.33 | N/M | 80 |
| CE 4 | 72 | A | D | A | A | A | 100 | 78 | 50 | 0.34 | N/M | 80 |
| CE 5 | 73 | A | D | C | C | D | 100 | 78 | 83 | 0.34 | N/M | 80 |
| CE 6 | 74 | A | D | C | C | D | 100 | 83 | 85 | 0.33 | N/M | 80 |
| CE 7 | 75 | A | D | C | C | D | 124 | 97 | 83 | 0.35 | N/M | 80 |
| CE 8 | 76 | D | D | A | A | A | 124 | 97 | 28 | 0.35 | N/M | 80 |
| CE 9 | 77 | A | D | C | C | D | 124 | 82 | 83 | 0.35 | N/M | 80 |
| CE 10 | 78 | D | D | A | A | A | 124 | 82 | 28 | 0.35 | N/M | 80 |

In the table 19, “EP No.” means “Electrophotographic photosensitive member”. “Damage” means “Image defects after durability, damage of protruded shape”. “IF 1 to 3” means “Image forming apparatus 1 to 3”. “Physical properties” means “Photosensitive drum physical properties”. “Volume-average particle size[nm]” means “Volume-average particle size of particles contained in surface layer”. “Number ratio [number %]” means “Number ratio of particle exposed from surface layer [number %]”. “Volume ratio [volume %]” means “Volume ratio of particle exposed from surface layer [volume %]”. “S1/(S1 + S2)” means “Coverage ratio S1/(S1 + S2) by particles”. “Coefficient of variation [%]” means “Coefficient of variation in coverage ratio by particles”. “Young's modulus [GPa]” means “Young's modulus of particle surface”.
“N/M” means “Not measured”.

TABLE 20

| Exam- | | | | | | | | | | | | |
|---|---|---|---|---|---|---|---|---|---|---|---|---|
| ple | | | | | | | physical properties | | | | | |
| (E)/ | | | Trans- | | | | | | | | Coeffi- | |
| Compar- | | | ferability | | | | Volume- | Number | Volume | | cient | |
| ative | | Initial | after | | | | average | ratio | ratio | | of | Young's |
| example | EP | transfe- | dura- | Damage | | | particle | [number | [volume | S1/ | variation | modulus |
| (CE) | No. | rability | bility | IF1 | IF2 | IF3 | size[mm] | %] | %] | (S1 + S2) | [%] | [GPa] |
| CE 11 | 79 | A | D | C | C | D | 124 | 88 | 83 | 0.35 | N/M | 80 |
| CE 12 | 80 | D | D | A | A | A | 124 | 88 | 28 | 0.35 | N/M | 80 |
| CE 13 | 81 | A | D | C | C | D | 124 | 90 | 83 | 0.35 | N/M | 80 |
| CE 14 | 82 | D | D | A | A | A | 124 | 90 | 28 | 0.35 | N/M | 80 |
| CE 15 | 83 | D | D | C | C | D | 550 | 95 | 25 | 0.32 | N/M | 80 |
| CE 16 | 84 | D | D | C | C | D | 37 | 95 | 85 | 0.60 | N/M | 80 |
| CE 17 | 85 | A | D | C | C | D | 100 | 90 | 95 | 0.55 | N/M | 80 |
| CE 18 | 86 | A | D | A | A | A | 100 | 78 | 50 | 0.24 | N/M | 80 |
| CE 19 | 87 | A | D | C | C | D | 100 | 78 | 83 | 0.39 | N/M | 80 |
| CE 20 | 88 | A | D | C | C | D | 100 | 83 | 85 | 0.45 | N/M | 80 |
| CE 21 | 89 | A | D | C | C | D | 124 | 97 | 83 | 0.52 | N/M | 80 |
| CE 22 | 90 | D | D | A | A | A | 124 | 97 | 28 | 0.31 | N/M | 80 |
| CE 23 | 91 | A | D | C | C | D | 124 | 82 | 83 | 0.47 | N/M | 80 |
| CE 24 | 92 | D | D | A | A | A | 124 | 82 | 28 | 0.23 | N/M | 80 |
| CE 25 | 93 | A | D | C | C | D | 124 | 88 | 83 | 0.44 | N/M | 80 |
| CE 26 | 94 | A | D | A | A | A | 124 | 88 | 28 | 0.22 | N/M | 80 |
| CE 27 | 95 | A | D | C | C | D | 124 | 90 | 83 | 0.45 | N/M | 80 |
| CE 28 | 96 | D | D | A | A | A | 124 | 90 | 28 | 0.28 | N/M | 80 |
| CE 29 | 97 | D | D | — | — | — | — | 0 | 0 | — | — | — |
| CE 30 | 98 | 0 | D | — | — | — | — | 0 | 0 | — | — | — |

In the table 20, “EP No.” means “Electrophotographic photosensitive member”. “Damage” means “Image defects after durability, damage of protruded shape”. “IF 1 to 3” means “Image forming apparatus 1 to 3”. “Physical properties” means “Photosensitive drum physical properties”. “Volume-average particle size[nm]” means “Volume-average particle size of particles contained in surface layer”. “Number ratio [number %]” means “Number ratio of particle exposed from surface layer [number %]”. “Volume ratio [volume %]” means “Volume ratio of particle exposed from surface layer [volume %]”. “S1/(S1 + S2)” means “Coverage ratio S1/(S1 + S2) by particles”. “Coefficient of variation [%]” means “Coefficient of variation in coverage ratio by particles”. “Young's modulus [GPa]” means “Young's modulus of particle surface”.
“N/M” means “Not measured”.

Although the present invention has been described with reference to the exemplary embodiments, it is to be understood that the present invention is not limited to these disclosed exemplary embodiments. The scope of each claim described below should be construed as the broadest to encompass all variations and equivalent structures and functions.

According to the present invention, it is possible to curb occurrence of image defects by curbing an increase in frictional force between an electrophotographic photosensitive member and an intermediate transfer member of an image forming apparatus.

According to the present invention, it is possible to achieve both improvement in transfer efficiency and curbing of shape change in the surface of the photosensitive drum through long-term use.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An image forming apparatus comprising:
a photosensitive drum; and
an intermediate transfer member configured to have a surface onto which a toner on the photosensitive drum is transferred at a contact portion in contact with the photosensitive drum, and convey the toner to transfer the toner to a transfer material,
wherein
the photosensitive drum has a surface layer containing a particle and a binder resin,
S1/(S1+S2) is at least 0.70 and not more than 1.00 when an area occupied by the particle is denoted by S1 and an area occupied by other than the particle is denoted by S2 on a surface of the surface layer,
there are a plurality of peaks in a particle size distribution based on the number of particles contained in the surface layer,
among peaks having a particle size of 20 nm or more at peak tops in the particle size distribution among the plurality of peaks, a peak having the maximum frequency of peak tops is defined as a first peak, and a peak having the second highest frequency of peak tops is defined as a second peak, and
when a particle size of a peak top having a larger particle size value of the peak top in comparison between the first peak and the second peak is denoted by DA,
when an arithmetic mean curvature of peak points in a surface roughness shape of a surface of the intermediate transfer member facing the photosensitive drum in the contact portion is denoted by Spc,
80 nm≤DA≤2×(1/Spc)
is satisfied.

2. The image forming apparatus according to claim 1, wherein, when the surface layer is viewed from above, an average value of distances between centers of gravity of protruded portions derived from particles having the particle size in a range of DA±20 nm is at least 150 nm and not more than 500 nm, and
a standard deviation of the distances between the centers of gravity of the protruded portions is 250 nm or less.

3. An image forming apparatus comprising:
a photosensitive drum; and
an intermediate transfer member configured to have a surface onto which a toner on the photosensitive drum is transferred at a contact portion in contact with the photosensitive drum, and convey the toner to transfer the toner to a transfer material,
wherein
the photosensitive drum has a surface layer containing a particle and a binder resin,
there are a plurality of peaks in a particle size distribution based on the number of particles contained in the surface layer,
among peaks having a particle size of 20 nm or more at peak tops in the particle size distribution among the plurality of peaks, a peak having the maximum frequency of peak tops is defined as a first peak, and a peak having the second highest frequency of peak tops is defined as a second peak, and
when a particle size of a peak top having a larger particle size value of the peak top in comparison between the first peak and the second peak is denoted by DA,
when the surface layer is viewed from above, an average value of distances between centers of gravity of protruded portions derived from particles having the particle size in a range of DA±20 nm is at least 150 nm and not more than 500 nm,
a standard deviation of the distances between the centers of gravity of the protruded portions is 250 nm or less, and
when an arithmetic mean curvature of peak points in a surface roughness shape of a surface of the intermediate transfer member facing the photosensitive drum in the contact portion is denoted by Spc,
80 nm≤DA≤2×(1/Spc)
is satisfied.

4. The image forming apparatus according to claim 1, wherein, when an average film thickness of the surface layer at a portion of the surface layer that does not contain particles having the particle size in the range of DA±20 nm is denoted by T in a cross section of the surface layer,
DA>T
is satisfied.

5. The image forming apparatus according to claim 4, wherein a peak top particle size DB having a smaller peak top particle size value in comparison between the first peak and the second peak satisfies
DB<T

6. The image forming apparatus according to claim 5, wherein, in the surface layer,
DB/DA>1/10
is satisfied.

7. The image forming apparatus according to claim 1, wherein, among the number of protruded portions present on the surface of the surface layer,
a proportion of the number of protruded portions derived from particles having the particle size in the range of DA±20 nm is 90 number % or more.

8. The image forming apparatus according to claim 1, wherein a half-value width of a peak having a larger particle size value at a peak top in comparison between the first peak and the second peak is 50 nm or less.

9. The image forming apparatus according to claim 1, wherein a circularity of particles having the particle size in the range of DA±20 nm is 0.950 or more.

10. The image forming apparatus according to claim 1, wherein a groove shape is formed on the surface of the intermediate transfer member in a direction along a moving direction of the intermediate transfer member, and
the surface of the intermediate transfer member facing the photosensitive drum is a surface excluding the groove shape.

11. The image forming apparatus according to claim 1, wherein the intermediate transfer member has a surface layer and a base layer,
wherein the surface layer of the intermediate transfer member contains an acrylic resin.

12. The image forming apparatus according to claim 1, comprising a means configured to provide a peripheral speed difference between a peripheral speed of the photosensitive drum and a peripheral speed of the intermediate transfer member.

13. The image forming apparatus according to claim 1, wherein an arithmetic mean curvature Spc of peak points in the surface roughness shape of the surface of the intermediate transfer member facing the photosensitive drum is 7,000 [1/mm] or less.

14. The image forming apparatus according to any one of claim 1, wherein a proportion of a volume of the particle to a total volume of the surface layer is 40 vol % to 90 vol %.

15. A process cartridge attachable to an image forming apparatus having an intermediate transfer member, the process cartridge comprising:
a photosensitive drum having a surface layer containing a particle and a binder resin,
S1/(S1+S2) is at least 0.70 and not more than 1.00 when an area occupied by the particle is denoted by S1 and an area occupied by other than the particle is denoted by S2 on a surface of the surface layer,
there are a plurality of peaks in a particle size distribution based on the number of particles contained in the surface layer,
among peaks having a particle size of 20 nm or more at peak tops in the particle size distribution among the plurality of peaks, a peak having the maximum frequency of peak tops is defined as a first peak, and a peak having the second highest frequency of peak tops is defined as a second peak, and
when a particle size of a peak top having a larger particle size value of the peak top in comparison between the first peak and the second peak is denoted by DA,
80 nm≤DA
is satisfied,
the intermediate transfer member of the image forming apparatus is an intermediate transfer member configured to have a surface onto which a toner on the photosensitive drum is transferred at a contact portion in contact with the photosensitive drum, and convey the toner to transfer the toner to a transfer material,
when an arithmetic mean curvature of peak points in a surface roughness shape of a surface of the intermediate transfer member facing the photosensitive drum in the contact portion is denoted by Spc,
DA≤2×(1/Spc)
is satisfied.

16. The process cartridge according to claim 15, wherein an average value of distances between centers of gravity of protruded portions derived from particles having the particle size in the range of DA±20 nm is at least 150 nm and not more than 500 nm when the surface layer is viewed from above, and
a standard deviation of the distances between the centers of gravity of the protruded portions is 250 nm or less.

17. A process cartridge attachable to an image forming apparatus having an intermediate transfer member, the process cartridge comprising:
a photosensitive drum having a surface layer containing a particle and a binder resin,
wherein there are a plurality of peaks in a particle size distribution based on the number of particles contained in the surface layer,
among peaks having a particle size of 20 nm or more at peak tops in the particle size distribution among the plurality of peaks, a peak having the maximum frequency of peak tops is defined as a first peak, and a peak having the second highest frequency of peak tops is defined as a second peak, and
when a particle size of a peak top having a larger particle size value of the peak top in comparison between the first peak and the second peak is denoted by DA,
80 nm≤DA
is satisfied,
an average value of distances between centers of gravity of protruded portions derived from particles having the particle size in the range of DA±20 nm is at least 150 nm and not more than 500 nm when the surface layer is viewed from above, and
a standard deviation of the distances between the centers of gravity of the protruded portions is 250 nm or less, and
the intermediate transfer member of the image forming apparatus is an intermediate transfer member configured to have a surface onto which a toner on the photosensitive drum is transferred at a contact portion in contact with the photosensitive drum, and convey the toner to transfer the toner to a transfer material, and
when an arithmetic mean curvature of peak points in a surface roughness shape of a surface of the intermediate transfer member facing the photosensitive drum in the contact portion is denoted by Spc,
DA≤2×(1/Spc)
is satisfied.

18. The process cartridge according to claim 15, wherein, when an average film thickness of the surface layer at a portion of the surface layer that does not contain particles having the particle size in the range of DA±20 nm is denoted by T in a cross section of the surface layer,
DA>T
is satisfied.

19. The process cartridge according to claim 18, wherein a peak top particle size DB having a smaller particle size value at a peak top in comparison between the first peak and the second peak satisfies
DB<T.

20. The process cartridge according to claim 19, wherein, in the surface layer,
DB/DA>1/10
is satisfied.

21. The process cartridge according to claim 15, wherein, among the number of protruded portions present on the surface of the surface layer,
a proportion of the number of protruded portions derived from particles having the particle size in the range of DA±20 nm is 90 number % or more.

22. The process cartridge according to claim 15, wherein a half-value width of a peak having a larger particle size value at a peak top in comparison between the first peak and the second peak is 50 nm or less.

23. The process cartridge according to claim 15, wherein a circularity of particles having the particle size in the range of DA±20 nm is 0.950 or more.

24. The process cartridge according to claim 15, wherein,
in the image forming apparatus to which the process cartridge is attachable,
a groove shape is formed on a surface of the intermediate transfer member in a direction along a moving direction of the intermediate transfer member, and
the surface of the intermediate transfer member facing the photosensitive drum is a surface excluding the groove shape.

25. The process cartridge according to claim 15, wherein,
in the image forming apparatus to which the process cartridge is attachable,
the intermediate transfer member has a surface layer and a base layer,
wherein the surface layer of the intermediate transfer member contains an acrylic resin.

26. The process cartridge according to claim 15, wherein,
the image forming apparatus to which the process cartridge is attachable comprises
a means configured to provide a peripheral speed difference between a peripheral speed of the photosensitive drum and a peripheral speed of the intermediate transfer member.

27. The process cartridge according to claim 15, wherein,
the image forming apparatus to which the process cartridge is attachable,
an arithmetic mean curvature Spc of peak points in a surface roughness shape of the surface of the intermediate transfer member facing the photosensitive drum is 7000 [1/mm] or less.

28. The process cartridge according to any one of claim 15, wherein a proportion of a volume of the particle to a total volume of the surface layer is 40 vol % to 90 vol %.

29. An image forming apparatus comprising:
an endless transfer belt stretched by a plurality of stretching rollers; and
a transfer member disposed on an inner peripheral side of the transfer belt,
wherein a process cartridge is attachable to the image forming apparatus,
wherein a width of the transfer member in an axial direction of the plurality of stretching rollers is less than a width of at least one of the plurality of stretching rollers,
the process cartridge has a photosensitive drum having a surface layer carrying a toner image,
the photosensitive drum contains a particle partially exposed from the surface layer of the photosensitive drum,
wherein a volume-average particle size of the particle is more than 37 nm and less than 550 nm,
80 number % or more of particles contained in a cross section of the surface layer are partially exposed from the surface layer, and a total volume of the exposed portion is at least 30 vol % and not more than 80 vol % with respect to a total volume of the contained particles, and
a width of the surface layer of the photosensitive drum is formed in a region wider than a width of the transfer member in the axial direction.

30. The image forming apparatus according to claim 29, wherein the volume-average particle size of the particle is at least 50 nm and not more than 350 nm.

31. The image forming apparatus according to claim 29, wherein, in the process cartridge, when the surface layer is viewed from above, S1/(S1+S2) satisfies formula (A) below when a total area of exposed portions of the particle partially exposed from the surface layer is denoted by S1, and a total area of portions other than the exposed portions of the particle partially exposed from the surface layer is denoted by S2
$$0.13 < S 1 / ( S 1 + S 2 ) < 0.85 . \qquad Formula ( A )$$

32. The image forming apparatus according to claim 31, wherein S1/(S1+S2) satisfies formula (B) below
$$0.15 \leq S 1 / ( S 1 + S 2 ) \leq 0.8 . \qquad Formula ( B )$$

33. The image forming apparatus according to claim 31, wherein, in the process cartridge, a coefficient of variation of S1/(S1+S2) is less than 26% when a total area of exposed portions of the particle is denoted by S1 and a total area of portions other than the exposed portions of the particle is denoted by S2 when the surface layer is viewed from above.

34. The image forming apparatus according to claim 29, wherein, in the process cartridge, a Young's modulus of the particle is 0.60 GPa or more.

35. The image forming apparatus according to claim 29, wherein a width of the transfer member in the axial direction of the plurality of stretching rollers is less than a width of any of the stretching rollers included in the plurality of stretching rollers.

36. The image forming apparatus according to claim 29, wherein a width of the transfer belt is greater than a width of the plurality of stretching rollers.

37. The image forming apparatus according to claim 29, wherein an image forming width of the transfer belt is less than a width of a driving roller included in the plurality of stretching rollers in the axial direction of the plurality of stretching rollers.

38. A process cartridge attachable to an image forming apparatus having an endless transfer belt stretched by a plurality of stretching rollers and a transfer member disposed on an inner circumferential side of the transfer belt, wherein, in the image forming apparatus, a width of the transfer member in an axial direction of the plurality of stretching rollers is less than a width of at least one of the plurality of stretching rollers,
wherein the process cartridge has a photosensitive drum having a surface layer carrying a toner image,
wherein the photosensitive drum has a particle partially exposed from the surface layer,
wherein a volume-average particle size of the particle is more than 37 nm and less than 550 nm,
80 number % or more of particles contained in a cross section of the surface layer are partially exposed from the surface layer, and a total volume of the exposed portion is at least 30 vol % and not more than 80 vol % with respect to a total volume of the contained particles, and
a width of the surface layer of the photosensitive drum is formed in a region wider than the width of the transfer member in the axial direction.

39. The process cartridge according to claim 38, wherein the volume-average particle size of the particle is at least 50 nm and not more than 350 nm.

40. The process cartridge according to claim 38, wherein, when the surface layer of the photosensitive drum is viewed from above, S1/(S1+S2) satisfies formula (A) below when a total area of exposed portions of the particle partially exposed from the surface layer is denoted by S1, and a total area of portions other than the exposed portions of the particle partially exposed from the surface layer is denoted by S2.
$$0.13 < S 1 / ( S 1 + S 2 ) < 0.85 . \qquad Formula ( A )$$

41. The process cartridge according to claim 40, wherein S1/(S1+S2) satisfies the formula (B) below
$$0.15 \leq S 1 / ( S 1 + S 2 ) \leq 0.8 . \qquad Formula ( B )$$

42. The process cartridge according to claim 40, wherein a coefficient of variation of S1/(S1+S2) is less than 26% when a total area of exposed portions of the particle is denoted by S1 and a total area of portions other than the exposed portions of the particle is denoted by S2 when the surface layer of the photosensitive drum is viewed from above.

43. The process cartridge according to claim 38, wherein a Young's modulus of the particle of the photosensitive drum is 0.60 GPa or more.

44. An image forming apparatus to which the process cartridge according to claim 38 is attachable, wherein a width of the transfer member in the axial direction of the plurality of stretching rollers is less than a width of any of the stretching rollers included in the plurality of stretching rollers.

45. An image forming apparatus to which the process cartridge according to claim 38 is attachable, wherein a width of the transfer belt is greater than a width of the plurality of stretching rollers.

46. An image forming apparatus to which the process cartridge according to claim 38 is attachable, wherein an image forming width of the transfer belt is less than a width of a driving roller included in the plurality of stretching rollers in the axial direction of the plurality of stretching rollers.
